(19) United States
(12) Patent Application Publication
(10) Pub. No.: US 2026/0204575 A1
(43) Pub. Date: Jul. 16, 2026

(54) COMPOSITION FOR ALL-SOLID-STATE SECONDARY BATTERY, SHEET FOR ALL-SOLID-STATE SECONDARY BATTERY, AND ALL-SOLID-STATE SECONDARY BATTERY

(71) Applicant: FUJIFILM Corporation, Tokyo (JP)

(72) Inventors: Ikuo KINOSHITA, Kanagawa (JP); Koji YASUDA, Kanagawa (JP); Yuzo NAGATA, Kanagawa (JP)

(73) Assignee: FUJIFILM Corporation, Tokyo (JP)

(21) Appl. No.: 19/557,080

(22) Filed: Mar. 4, 2026

Related U.S. Application Data
(63) Continuation of application No. PCT/JP2024/034523, filed on Sep. 26, 2024.

(30) Foreign Application Priority Data
Sep. 27, 2023 (JP) 2023-165475

(51) Int. Cl. H01M 4/62; H01M 4/02; H01M 4/134; H01M 4/38; H01M 10/0525; H01M 10/0562

(52) U.S. Cl. CPC H01M 4/62; H01M 4/134; H01M 4/386; H01M 4/622; H01M 10/0525; H01M 10/0562; H01M 2004/021; H01M 2300/0068

(57) ABSTRACT

Provided are a composition for an all-solid-state secondary battery, containing an inorganic solid electrolyte SE, an active material AC, a dispersion medium D, and a polymer A dissolved in the dispersion medium D, in which Aa calculated by the following expression 1 satisfies 1≤Aa≤100; and a sheet for an all-solid-state secondary battery and an all-solid-state secondary battery using the composition for an all-solid-state secondary battery.

$$Aa = {( adsorption rate of polymer A to active material AC )}^{2} \times [ ( ( content of polymer A / total solid content amount ) / ( molecular weight of polymer A ) ) / {( total specific surface area of active material AC )}^{3 / 2} \times {10}^{10} \qquad Expression 1$$

In the expression 1, the total specific surface area of the active material AC is a value calculated from a specific surface area of the active material AC×a content of the active material AC/the total solid content amount.

### CROSS-REFERENCE TO RELATED APPLICATIONS

This application is a Continuation of PCT International Application No. PCT/JP2024/034523 filed on Sep. 26, 2024, which claims priority under 35 U.S.C. § 119 (a) to Japanese Patent Application No. 2023-165475 filed in Japan on Sep. 27, 2023. Each of the above applications is hereby expressly incorporated by reference, in its entirety, into the present application.

### BACKGROUND OF THE INVENTION

### 1. Field of the Invention

The present invention relates to a composition for an all-solid-state secondary battery, a sheet for an all-solid-state secondary battery, and an all-solid-state secondary battery.

### 2. Description of the Related Art

In an all-solid-state secondary battery, all of a negative electrode, an electrolyte, and a positive electrode consist of solid, and the all-solid-state secondary battery can greatly improve safety and reliability, which are said to be problems to be solved in a battery in which an organic electrolytic solution is used. It is also said to be capable of extending battery life. Furthermore, the all-solid-state secondary battery can be provided with a structure in which the electrodes and the electrolyte are directly arranged in series. As a result, it is possible to increase an energy density to be high as compared with the secondary battery in which an organic electrolytic solution is used, and thus the application to electric vehicles, large-sized storage batteries, and the like is expected.

A constituent layer (a solid electrolyte layer, a negative electrode active material layer, a positive electrode active material layer, or the like) in the all-solid-state secondary battery is usually formed as a layer consisting of solid particles using a material in which solid particles such as an inorganic solid electrolyte, an active material, and a conductive auxiliary agent are dispersed in a dispersion medium. However, in a case where the solid particles are locally aggregated and exist (are unevenly distributed) in a non-uniform state in the constituent layer, current concentration and/or ion concentration occurs locally in the inorganic solid electrolyte and/or the active material during charging and discharging, and the inorganic solid electrolyte and/or the active material is likely to be deteriorated. As a result, battery performance (also referred to as battery characteristics) such as life characteristics, output, and rate characteristics (charging and discharging characteristics) is deteriorated. Therefore, in the related art, a technique of improving dispersibility of the solid particles in the material forming the constituent layer has been studied.

Examples of a method of improving the dispersibility of the solid particles include a method of increasing a content of the dispersion medium (a method of reducing a concentration of solid contents), and a method of increasing a dispersion time (a mixing time). However, these methods have disadvantages on manufacture, such as an increase in a time for drying the material forming the constituent layer after coating, an increase in environmental load, and an increase in manufacturing cost. In recent years, since research and development of practical electric vehicles and the like have been rapidly progressing, in the manufacturing of the all-solid-state secondary battery, studies on a material having a high concentration of solid contents such as solid particles have also been advanced to overcome the above-described disadvantages. For example, WO2022/202902A discloses “electrode composition containing an inorganic solid electrolyte SE having an ionic conductivity of a metal belonging to Group 1 or Group 2 in the periodic table, an active material AC, a conductive auxiliary agent CA, a polymer binder (B), and a dispersion medium D, in which the polymer binder (B) includes a polymer binder (B1) which is dissolved in the dispersion medium D, and the polymer binder (B1), the inorganic solid electrolyte SE, the active material AC, and the conductive auxiliary agent CA satisfy the following conditions (1) to (4)”.
“(1) a weight-average molecular weight of a polymer constituting the polymer binder (B1) is 100,000 to 2,000,000;
(2) a value of a polarity element of surface energy of the polymer constituting the polymer binder (B1) is 0.5 mJ/m² or more;
(3) a content of the polymer binder (B1) in the total solid content is 1.5% by mass or less; and
(4) a total of products of a specific surface area and a mass fraction of each of the inorganic solid electrolyte SE, the active material AC, and the conductive auxiliary agent CA is 5.0 to 15.0 m²/g”

### SUMMARY OF THE INVENTION

The above-described electrode composition disclosed in WO2022/202902A has excellent dispersion characteristics (initial dispersibility and dispersion stability) and coating suitability (surface properties and adhesiveness) even in a case where the concentration of solid contents is increased. However, in WO2022/202902A, in a case where the concentration of solid contents is increased, the improvement of the dispersibility is not studied, and the shortening of the preparation time is not studied.

An object of the present invention is to provide a composition for an all-solid-state secondary battery, which can be prepared in a short time while suppressing occurrence of aggregates even in a case where a concentration of solid contents is increased, and which preferably contributes to improvement of battery performance. Another object of the present invention is to provide a sheet for an all-solid-state secondary battery and an all-solid-state secondary battery, using the composition for an all-solid-state secondary battery.

As a result of various studies on the material forming the constituent layer, the present inventors have found that, in a case where a polymer dissolved in the dispersion medium is used in combination with the solid particles, and a polymer which is adsorbed to or can be adsorbed to the active material or the inorganic solid electrolyte among polymers present in the material is focused on, as a value Aa or a value Ab calculated by an expression 1 or an expression 2, which will be described later, is within a specific range, the occurrence of aggregates can be suppressed even in a case where the concentration of solid contents is increased, and the solid particles can be dispersed in a short time without aggregating the solid particles. In addition, it has been found that, since the material forming the constituent layer has excellent dispersibility of the solid particles, the all-solid-state secondary battery including the layer formed of the material can achieve high battery performance.

The present invention has been completed by further repeating studies on the basis of the above-described finding.

That is, the above-described object has been achieved by the following method.

<1> A composition for an all-solid-state secondary battery, comprising:
an inorganic solid electrolyte SE having an ionic conductivity of a metal belonging to Group 1 or Group 2 in the periodic table;
an active material AC;
a dispersion medium D; and
a polymer A dissolved in the dispersion medium D,
in which Aa calculated by the following expression 1 satisfies 1≤Aa≤100,

Aa=(an adsorption rate of the polymer A to the active material AC)²×[((the content of the polymer A/the total solid content amount)/(the molecular weight of the polymer A))/(a total specific surface area of the active material AC)^{3/2}]×10¹⁰, the expression 1:
in the expression 1, the total specific surface area of the active material AC is a value calculated from a specific surface area of the active material AC×a content of the active material AC/the total solid content amount.

<2> The composition for an all-solid-state secondary battery according to <1>,
in which Aa calculated by the expression 1 satisfies 2≤Aa≤30.

<3> The composition for an all-solid-state secondary battery according to <1> or <2>,
in which Ab calculated by the following expression 2 satisfies 2≤Ab≤500,

Ab=(an adsorption rate of the polymer A to the inorganic solid electrolyte SE)²×[((a content of the polymer A/a total solid content amount)/(a molecular weight of the polymer A))/(a total specific surface area of the inorganic solid electrolyte SE)^{3/2}]×10¹⁰, the expression 2:
in the expression 2, the total specific surface area of the inorganic solid electrolyte SE is a value calculated from a specific surface area of the inorganic solid electrolyte SE×a content of the inorganic solid electrolyte SE/the total solid content amount.

<4> The composition for an all-solid-state secondary battery according to <3>,
in which Ab calculated by the expression 2 satisfies 2≤Ab≤300.

<5> The composition for an all-solid-state secondary battery according to <3> or <4>,

Ac=[Aa×(the content of the active material AC/the total solid content amount)]+[Ab×(the content of the inorganic solid electrolyte SE/the total solid content amount)]. the expression 3:

<6> The composition for an all-solid-state secondary battery according to any one of <1> to <5>,
in which a weight-average molecular weight of the polymer A is 2.0×10⁴ or less.

<7> The composition for an all-solid-state secondary battery according to any one of <1> to <6>,
in which the active material AC contains Si, and
Aa calculated by the expression 1 satisfies 2≤Aa≤15.

<8> A composition for an all-solid-state secondary battery, comprising:
an inorganic solid electrolyte SE having an ionic conductivity of a metal belonging to Group 1 or Group 2 in the periodic table;
a dispersion medium D; and
a polymer A dissolved in the dispersion medium D,
in which Ab calculated by the following expression 2 satisfies 2≤Ab≤500,

Ab=(an adsorption rate of the polymer A to the inorganic solid electrolyte SE)²×[((a content of the polymer A/the total solid content amount)/(a molecular weight of the polymer A))/(a total specific surface area of the inorganic solid electrolyte SE)^{3/2}]×10¹⁰, the expression 2:
in the expression 2, the total specific surface area of the inorganic solid electrolyte SE is a value calculated from a specific surface area of the inorganic solid electrolyte SE×a content of the inorganic solid electrolyte SE/the total solid content amount.

<9> The composition for an all-solid-state secondary battery according to <8>,
in which Ab calculated by the expression 2 satisfies 2≤Ab≤300.

<10> The composition for an all-solid-state secondary battery according to <8> or <9>,
in which the composition for an all-solid-state secondary battery further contains an active material AC, and
Aa calculated by the following expression 1 satisfies 1≤Aa≤100,

Aa=(an adsorption rate of the polymer A to the active material AC)²×[((the content of the polymer A/the total solid content amount)/(the molecular weight of the polymer A))/(a total specific surface area of the active material AC)^{3/2}]×10¹⁰, the expression 1:
in the expression 1, the total specific surface area of the active material AC is a value calculated from a specific surface area of the active material AC×a content of the active material AC/the total solid content amount.

<11> The composition for an all-solid-state secondary battery according to <10>,
in which Aa calculated by the expression 1 satisfies 2≤Aa≤30.

<12> The composition for an all-solid-state secondary battery according to <10> or <11>,
in which Ac calculated by the following expression 3 satisfies 3≤Ac≤100,

Ac=[Aa×(the content of the active material AC/the total solid content amount)]+[Ab×(the content of the inorganic solid electrolyte SE/the total solid content amount)]. the expression 3:

<13> The composition for an all-solid-state secondary battery according to any one of <8> to <12>,
in which a weight-average molecular weight of the polymer A is 2.0×10⁴ or less.

<14> The composition for an all-solid-state secondary battery according to any one of <10> to <13>,
in which the active material AC contains Si, and
Aa calculated by the expression 1 satisfies 2≤Aa≤15.

<15> A sheet for an all-solid-state secondary battery, comprising:
a layer formed of the composition for an all-solid-state secondary battery according to any one of <1> to <14>.

<16> An all-solid-state secondary battery comprising, in the following order:
a positive electrode active material layer;
a solid electrolyte layer; and
a negative electrode active material layer,
in which at least one of the positive electrode active material layer, the solid electrolyte layer, or the negative electrode active material layer is a layer formed of the composition for an all-solid-state secondary battery according to any one of <1> to <14>.

According to the present invention, it is possible to provide a composition for an all-solid-state secondary battery, which can be prepared in a short time while suppressing occurrence of aggregates even in a case where a concentration of solid contents is increased, and which preferably contributes to improvement of battery performance. In addition, according to the present invention, it is possible to provide a sheet for an all-solid-state secondary battery and an all-solid-state secondary battery, using the composition for an all-solid-state secondary battery.

The above-described and other features and advantages of the present invention will become more apparent from the following description, appropriately referring to the accompanying drawing.

### BRIEF DESCRIPTION OF THE DRAWINGS

FIG. 1 is a vertical cross-sectional view schematically showing an all-solid-state secondary battery according to a preferred embodiment of the present invention.

FIG. 2 is a vertical cross-sectional view schematically showing a coin-type all-solid-state secondary battery produced in Examples.

FIG. 3 is a graph in which Aa values and Ab values in compositions for an all-solid-state secondary battery according to Examples 1 to 5 are plotted in coordinates in which a horizontal axis is Aa calculated by the expression 1 and a vertical axis is Ab calculated by the expression 2.

FIG. 4 is a graph in which Aa values and Ab values in compositions for an all-solid-state secondary battery according to Examples 6 to 9 are plotted in coordinates in which a horizontal axis is Aa calculated by the expression 1 and a vertical axis is Ab calculated by the expression 2.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. On the other hand, in a case where a numerical range expressed using “to” is described by setting a plurality of numerical ranges, the upper limit value and the lower limit value forming the numerical range are not limited to a specific numerical range before and after “to” in a specific combination of upper limit value and lower limit value, and the upper limit value and the lower limit value of each numerical range can be appropriately combined. In the present invention, a numerical range represented by using “to” means a range including numerical values described before and after “to” as a lower limit value and an upper limit value.

In the present invention, an expression of a compound (for example, in a case where a compound is represented by an expression with “compound” added to the end) refers to not only the compound itself but also a salt or an ion thereof. In addition, the expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same applies to a compound which is not specified regarding whether to be substituted or unsubstituted. Preferred examples of the substituent include substituents Z described later.

In the present invention, in a case where a plurality of substituents or the like represented by a specific reference numeral are present or a plurality of substituents or the like are simultaneously defined, the respective substituents or the like may be the same or different from each other. In addition, unless specified otherwise, in a case where a plurality of substituents or the like are adjacent to each other, the substituents may be linked or fused to each other to form a ring.

In the present invention, the term “polymer” means a polymer and is synonymous with a so-called macromolecular compound.

In the present invention, the main chain of the polymer and the polymer chain refers to all molecular chains constituting the polymer which is a linear molecular chain that can be regarded as branched chains or pendant groups with respect to the main chain. Although it depends on a weight-average molecular weight of a molecular chain regarded as the branched chain or the pendant chain, the longest chain among the molecular chains constituting the polymer is typically the main chain. However, the main chain does not include a terminal group included in the terminal of the polymer. On the other hand, a side chain of the polymer refers to a molecular chain other than the main chain, and includes a short molecular chain and a long molecular chain (graft chain). Examples of the terminal group include a hydrogen atom, an alkyl group, an aryl group, a hydroxy group, and a residue of a polymerization initiator.

In the present invention, the composition for an all-solid-state secondary battery is a composition for forming an active material layer or a solid electrolyte layer, which is a constituent layer of the all-solid-state secondary battery, the composition including an electrode composition which contains an inorganic solid electrolyte, an active material, a polymer, and a dispersion medium, and is used as a material (active material layer-forming material) for forming an active material layer of the all-solid-state secondary battery, and being used as an inorganic solid electrolyte-containing composition which contains an inorganic solid electrolyte, a polymer, and a dispersion medium, and is used as a material (solid electrolyte layer-forming material) for forming a solid electrolyte layer of the all-solid-state secondary battery. The inorganic solid electrolyte-containing composition is a concept including an electrode composition which may contain an active material as appropriate.

In addition, in the present invention, the electrode composition includes a positive electrode composition containing a positive electrode active material and used as a material for forming a positive electrode active material layer, and a negative electrode composition containing a negative electrode active material and used as a material for forming a negative electrode active material layer.

Furthermore, in the present invention, any one or both of the positive electrode active material layer and the negative electrode active material layer may be simply referred to as an active material layer or an electrode active material layer; and any one or both of the positive electrode active material and the negative electrode active material may be simply referred to as an active material or an electrode active material.

[Composition for all-Solid-State Secondary Battery]

In a case where the composition for an all-solid-state secondary battery according to the embodiment of the present invention is an electrode composition (hereinafter, may be referred to as an electrode composition according to the embodiment of the present invention), the composition contains an inorganic solid electrolyte SE having an ionic conductivity of a metal belonging to Group 1 or Group 2 in the periodic table, an active material AC, a dispersion medium D, and a polymer A dissolved in the dispersion medium D, in which at least one of Aa calculated by the following expression 1 or Ab calculated by the following expression 2 is in the following range. From the viewpoint of further improving dispersibility of solid particles, in the electrode composition according to the embodiment of the present invention, it is preferable that Aa calculated by the expression 1 is in the following range, and it is more preferable that both Aa calculated by the expression 1 and Ab calculated by the expression 2 are in the following ranges.

In a case where the composition for an all-solid-state secondary battery according to the embodiment of the present invention is an inorganic solid electrolyte-containing composition (hereinafter, may be referred to as an inorganic solid electrolyte-containing composition according to the embodiment of the present invention), the composition contains an inorganic solid electrolyte SE having an ionic conductivity of a metal belonging to Group 1 or Group 2 in the periodic table, a dispersion medium D, and a polymer A dissolved in the dispersion medium D, in which Ab calculated by the expression 2 is in the following range. In a case where the inorganic solid electrolyte-containing composition according to the embodiment of the present invention further contains an active material AC, from the viewpoint of further improving dispersibility of solid particles, it is preferable that Aa calculated by the expression 1 is also in the following range.

As described above, the composition for an all-solid-state secondary battery according to the embodiment of the present invention includes two aspects of an aspect (first aspect) satisfying Aa calculated by the expression 1 and an aspect (second aspect) satisfying Ab calculated by the expression 2, regardless of whether the composition contains the active material AC.

$$Aa = {( adsorption rate of polymer A to active material AC )}^{2} \times [ ( ( content of polymer A / total solid content amount ) / ( molecular weight of polymer A ) ) / {( total specific surface area of active material AC )}^{3 / 2} \times {10}^{10} \qquad [ Expression 1 ]$$

In the expression 1, the total specific surface area of the active material AC is a value calculated from Specific surface area of active material AC×Content of active material AC/Total solid content amount.

Range in which Aa calculated by the expression 1 is satisfied: 1 to 100

$$Ab = {( Adsorption rate of polymer A to inorganic solid electrolyte SE )}^{2} \times [ ( ( Content of polymer A / Total solid content amount ) / ( Molecular weight of polymer A ) ) / {( Total specific surface area of inorganic solid electrolyte SE )}^{3 / 2} ] \times {10}^{10} \qquad [ Expression 2 ]$$

In the expression 2, the total specific surface area of the inorganic solid electrolyte SE is a value calculated from Specific surface area of inorganic solid electrolyte SE×Content of inorganic solid electrolyte SE/Total solid content amount.

Range in which Ab calculated by the expression 2 is satisfied: 2 to 500 The composition for an all-solid-state secondary battery according to the embodiment of the present invention, having the above-described configuration, can disperse solid particles in the dispersion medium D while suppressing occurrence of aggregates even in a case where a concentration of solid contents of the solid particles is increased (the composition is thickened), and can disperse the solid particles in the dispersion medium D without aggregating the solid particles even in a case where a preparation time (dispersion mixing time) is shortened. That is, the present invention can prepare a composition for an all-solid-state secondary battery having a high concentration of solid contents while suppressing occurrence of aggregates in a short time. As a result, by using the composition for an all-solid-state secondary battery according to the embodiment of the present invention as a constituent layer-forming material, a constituent layer in which local aggregation of the solid particles and uneven distribution (local existence state) of the solid particles are suppressed can be formed, and by incorporating this constituent layer, an all-solid-state secondary battery having excellent battery performance can be realized.

As a result of intensive studies on the dispersibility of the composition for an all-solid-state secondary battery, the present inventors have found that the polymer A which is dissolved in the dispersion medium D and can function as a dispersant may be able to realize high dispersibility of the inorganic solid electrolyte SE, the active material AC, and the like by adjusting the proportion (number of molecules) of the polymer A which is in coexistence with the inorganic solid electrolyte SE and the active material AC in the composition and is adsorbed to the inorganic solid electrolyte SE or the active material AC. As a result of further studies and experiments based on this idea, the present inventors have found, through a large number of experiments and trial and error, that, as shown in Examples described later, in a case where the inorganic solid electrolyte SE, the polymer A, and the active material AC are combined such that the value Aa calculated by the expression 1 or the value Ab calculated by the expression 2 is within a predetermined range, the inorganic solid electrolyte SE and the active material AC can be dispersed in the dispersion medium D while suppressing the occurrence of aggregation even in a case where the concentration of solid contents is increased and even in a case where the preparation time is shortened, and have completed the present invention.

The reason why the above-described excellent effect of the present invention is exhibited is not yet clear, but is considered as follows.

In a case where the composition for an all-solid-state secondary battery satisfies Aa or Ab calculated by the expression 1 or the expression 2, the proportion (number of molecules) of the polymer A which is present in the composition and can be adsorbed to the active material AC or the inorganic solid electrolyte SE is in a suitable range, and thus the polymer A dissolved in the dispersion medium D effectively functions as a dispersant for the active material AC or the inorganic solid electrolyte SE. Accordingly, the active material AC, the inorganic solid electrolyte SE, and the polymer A are uniformly distributed in the dispersion medium D, and the active material AC or the inorganic solid electrolyte SE can be highly dispersed in the dispersion medium D. As a result, it is considered that, even in a case where a content of the active material AC or the inorganic solid electrolyte SE is increased (without increasing an amount of the dispersion medium D used) or even in a case where a mixing time (preparation time) is shortened, the active material AC or the inorganic solid electrolyte SE can be dispersed in the dispersion medium D while suppressing aggregation of the active material AC or the inorganic solid electrolyte SE. In a case where the composition for an all-solid-state secondary battery according to the embodiment of the present invention, having excellent dispersibility, is used, the constituent layer is formed while maintaining the excellent dispersibility of the composition for an all-solid-state secondary battery, so that the active material AC or the inorganic solid electrolyte SE is present in the obtained constituent layer while suppressing local aggregation and uneven distribution. As a result, it is considered that, in a case where the constituent layer is incorporated, an all-solid-state secondary battery exhibiting excellent battery performance can be realized.

As described above, it is considered that the polymer A functions as a dispersant in the composition for an all-solid-state secondary battery in a state of being dissolved in the dispersion medium D, and is adsorbed to the active material AC or the inorganic solid electrolyte SE, or is interposed between the solid particles to disperse the active material AC or the inorganic solid electrolyte SE in the dispersion medium D. On the other hand, it is considered that the polymer A preferably functions as a binder which is adsorbed to the active material AC or the inorganic solid electrolyte SE in the constituent layer and binds the active material AC or the inorganic solid electrolyte SE to each other. Here, the adsorption of the polymer A to the active material AC or the inorganic solid electrolyte SE is not particularly limited, and includes not only physical adsorption but also chemical adsorption (adsorption by chemical bond formation, adsorption by electron transfer, and the like).

In addition, the polymer A may also function as a binder which binds a collector and the solid particles.

In the present invention, the polymer A has a characteristic (solubility) of being dissolved in the dispersion medium D contained in the composition for an all-solid-state secondary battery according to the embodiment of the present invention, and the polymer A in the composition for an all-solid-state secondary battery is preferably present in a state of being dissolved in the dispersion medium D in the composition for an all-solid-state secondary battery, depending on the solubility, the content, and the like. In a case where the polymer A is dissolved, a function of dispersing the solid particles in the dispersion medium D is stably exhibited, and the dispersion state of the solid particles in the composition for an all-solid-state secondary battery can be further improved.

In the present invention, the polymer A dissolved in the dispersion medium D is not limited to an aspect in which all the polymers A are dissolved in the dispersion medium D; and for example, a part of the polymer A may be present in an insoluble form in the composition for an all-solid-state secondary battery as long as the following solubility in the dispersion medium D is 80% by mass or more.

A measuring method of the solubility is as follows. That is, a specified amount of the polymer A as a measurement target is weighed in a glass bottle, 100 g of a dispersion medium which is the same kind as the dispersion medium D contained in the composition for an all-solid-state secondary battery is added thereto, and stirring is carried out at a temperature of 25° C. on a mix rotor at a rotation speed of 80 rpm for 24 hours. After stirring for 24 hours, the mixed solution obtained in this way is subjected to a transmittance measurement under the following conditions. The test (transmittance measurement) is carried out by changing the amount of the polymer A dissolved (the above-described specified amount), and the upper limit concentration X (% by mass) at which the transmittance is 99.8% is defined as the solubility of the polymer A in the above-described dispersion medium.

### <Transmittance Measurement Conditions>

Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

In the present invention, the solubility of the polymer Ain the dispersion medium D can be appropriately imparted by the structure, the formulation (the type and the content of the constitutional component), the weight-average molecular weight of the polymer A, and the combination with the dispersion medium D.

In the first aspect of the composition for an all-solid-state secondary battery according to the embodiment of the present invention, Aa calculated by the following expression 1 satisfies 1≤Aa≤100. The first aspect is usually an electrode composition, and in a case where Aa is within the range, the dispersibility of the solid particles, particularly the active material AC, is improved, and even in a case where the concentration is increased or the preparation time is shortened, the solid particles can be dispersed in the dispersion medium D while suppressing the occurrence of aggregation.

$$Aa = {( adsorption rate of polymer A to active material AC )}^{2} \times [ ( ( content of polymer A / total solid content amount ) / ( molecular weight of polymer A ) ) / {( total specific surface area of active material AC )}^{3 / 2} \times {10}^{10} \qquad [ Expression 1 ]$$

In the expression 1, the total specific surface area of the active material AC is a value calculated from Specific surface area of active material AC×Content of active material AC/Total solid content amount.

In the expression 1, (Content of polymer A/Total solid content amount)/(Molecular weight of polymer A) is a parameter related to the present number (number of moles) of the polymer A, and (Total specific surface area of active material AC)^{3/2} is a parameter related to a surface area of the active material AC. That is, [((Content of polymer A/Total solid content amount)/(Molecular weight of polymer A))/(Total specific surface area of active material AC)^{3/2}] represents the present number of polymer A per unit specific surface area of the active material AC. On the other hand, (Adsorption rate of polymer A to active material AC)² represents the proportion of the polymer A adsorbed to the active material AC.

As described above, the expression 1 is an experimentally found calculation expression weighted by the adsorption rate of the polymer A for functioning as a dispersant (the proportion of the polymer A adsorbed to the active material AC), and represents the number of molecules of the polymer A which is adsorbed to or can be adsorbed to the active material AC per unit total specific surface area of the active material AC.

In the present invention, the adsorption rate (%) of the polymer A to the active material AC is a value measured using the active material AC and the dispersion medium D contained in the composition for an all-solid-state secondary battery, and is an indicator indicating a degree to which the polymer A is adsorbed to the active material AC in the dispersion medium D. Here, the adsorption of the polymer A to the active material AC includes not only physical adsorption but also chemical adsorption as described above.

The adsorption rate A_{AC} (%) of the polymer A to the active material AC is measured by a method described in Examples later. Here, in a case where the composition for an all-solid-state secondary battery contains a plurality of types of the active materials AC, the adsorption rate is defined as an adsorption rate to the active material AC having the same formulation as the active material formulation (type and content) in the composition for an all-solid-state secondary battery. In addition, in a case where the composition for an all-solid-state secondary battery contains a plurality of types of the dispersion media D, the adsorption rate is measured using a dispersion medium D having the same formulation as the dispersion medium (type and content) in the composition for an all-solid-state secondary battery. In a case where the composition for an all-solid-state secondary battery contains a plurality of types of the polymers A, the adsorption rate of the polymer A may be measured for each polymer A, but is usually measured using a polymer A having the same formulation (type and content) as the polymer A of the composition for an all-solid-state secondary battery.

In the present invention, the adsorption rate A_{AC} of the polymer A to the active material AC can be appropriately set by the type of the polymer A, the formulation (type and content of the constitutional components), the type or the content of a functional group of the polymer A, and the like.

The specific surface area of the active material AC is a value measured by the following method.

In the present invention, the specific surface area means a BET specific surface area which is a value calculated according to the BET (one point) method by the nitrogen adsorption method. Specifically, the value is measured under the following conditions using the following measuring device.

A specific surface area/micropore distribution measuring device: BELSORP MINI (product name, manufactured by MicrotracBEL Corp.) is used for performing a measurement according to the gas adsorption method (nitrogen gas). 0.3 g of each component is packed in a sample tube having an inner diameter of 3.6 mm, and nitrogen is allowed to flow at 80° C. for 6 hours to dry the sample, which is used for the measurement. The measurement is performed under the following measurement conditions.

In the present invention, the specific surface area of the inorganic solid electrolyte SE and the conductive auxiliary agent is also a value measured in the same manner as the specific surface area of the active material AC described above.

### —Measurement Conditions—

Measurement temperature: −196° C.
Purge gas: helium gas (He)
Adsorbing gas: nitrogen gas (N₂)
Inner diameter of sample tube: 3.6 mm

Aa is calculated according to the expression 1 using the value calculated as described above and the content in the composition for an all-solid-state secondary battery.

In the present invention, Aa calculated by the expression 1 is in a range of 1 to 100. In a case where Aa is within the range, the dispersibility of the solid particles, particularly the active material AC, is improved, and even in a case where the concentration is increased or the preparation time is shortened, the solid particles can be dispersed in the dispersion medium D while suppressing the occurrence of aggregation. From the viewpoint of achieving more advanced dispersion of the solid particles, particularly the active material AC, Aa is preferably in a range of 1.5 to 50, more preferably in a range of 2 to 30, and still more preferably in a range of 3 to 30.

Regarding Aa, more specifically, in a case where the active material AC is a negative electrode active material, particularly, in a case where the active material AC contains Si, Aa is more preferably in a range of 1.5 to 20, still more preferably in a range of 2 to 15, and particularly preferably in a range of 3 to 15. On the other hand, in a case where the active material AC is a positive electrode active material, Aa is preferably in a range of 2 to 50, more preferably in a range of 2 to 30, and still more preferably in a range of 3 to 30.

In the composition for an all-solid-state secondary battery according to the first aspect of the present invention, Ab calculated by the following expression 2 preferably satisfies 2≤Ab≤500. In a case where Ab is within the above-described range, the dispersibility of the inorganic solid electrolyte SE can be further improved in addition to the dispersibility of the active material AC, the dispersibility of the solid particles including the active material AC and the inorganic solid electrolyte SE can be improved, and even in a case where the concentration is increased or the preparation time is shortened, the solid particles can be dispersed in the dispersion medium D while suppressing the occurrence of aggregation.

$$Ab = {( Adsorption rate of polymer A to inorganic solid electrolyte SE )}^{2} \times [ ( ( Content of polymer A / Total solid content amount ) / ( Molecular weight of polymer A ) ) / {( Total specific surface area of inorganic solid electrolyte SE )}^{3 / 2} ] \times {10}^{10} \qquad [ Expression 2 ]$$

In the expression 2, the total specific surface area of the inorganic solid electrolyte SE is a value calculated from Specific surface area of inorganic solid electrolyte SE×Content of inorganic solid electrolyte SE/Total solid content amount.

In the expression 2, (Content of polymer A/Total solid content amount)/(Molecular weight of polymer A) is a parameter related to the present number (number of moles) of the polymer A, and (Total specific surface area of inorganic solid electrolyte SE)^{3/2} is a parameter related to a surface area of the inorganic solid electrolyte SE. That is, [((Content of polymer A/Total solid content amount)/(Molecular weight of polymer A))/(Total specific surface area of inorganic solid electrolyte SE)^{3/2}] represents the present number of polymer A per unit specific surface area of the inorganic solid electrolyte SE. On the other hand, (Adsorption rate of polymer A to inorganic solid electrolyte SE)² represents the proportion of the polymer A adsorbed to the inorganic solid electrolyte SE.

As described above, the expression 2 is an experimentally found calculation expression weighted by the adsorption rate of the polymer A for functioning as a dispersant (the proportion of the polymer A adsorbed to the inorganic solid electrolyte SE), and represents the number of molecules of the polymer A which is adsorbed to or can be adsorbed to the inorganic solid electrolyte SE per unit total specific surface area of the inorganic solid electrolyte SE.

In the present invention, the adsorption rate (%) of the polymer A to the inorganic solid electrolyte SE is a value measured using the inorganic solid electrolyte SE and the dispersion medium D contained in the composition for an all-solid-state secondary battery, and is an indicator indicating a degree to which the polymer A is adsorbed to the inorganic solid electrolyte SE in the dispersion medium D. Here, the adsorption of the polymer A to the inorganic solid electrolyte SE includes not only physical adsorption but also chemical adsorption as described above.

The adsorption rate A_{SE} (%) of the polymer A to the inorganic solid electrolyte SE is measured by a method described in Examples later. Here, in a case where the composition for an all-solid-state secondary battery contains a plurality of types of the inorganic solid electrolyte SE, the adsorption rate is defined as an adsorption rate to the inorganic solid electrolyte SE having the same formulation as the active material formulation (type and content) in the composition for an all-solid-state secondary battery. In addition, in a case where the composition for an all-solid-state secondary battery contains a plurality of types of the dispersion media D, the adsorption rate is measured using a dispersion medium D having the same formulation as the dispersion medium (type and content) in the composition for an all-solid-state secondary battery. In a case where the composition for an all-solid-state secondary battery contains a plurality of types of the polymers A, the adsorption rate of the polymer A may be measured for each polymer A, but is usually measured using a polymer A having the same formulation (type and content) as the polymer A of the composition for an all-solid-state secondary battery.

In the present invention, the adsorption rate A_{SE} of the polymer A to the inorganic solid electrolyte SE can be appropriately set by the type of the polymer A, the formulation (type and content of the constitutional components), the type or the content of a functional group of the polymer A, and the like.

Ab is calculated according to the expression 2 using the value calculated as described above and the content in the composition for an all-solid-state secondary battery.

In the composition for an all-solid-state secondary battery according to the first aspect of the present invention, Ab calculated by the expression 2 is preferably in a range of 2 to 500, and from the viewpoint of achieving more advanced dispersion of the solid particles, particularly the inorganic solid electrolyte SE, Ab is more preferably in a range of 2 to 300, still more preferably in a range of 3 to 250, and particularly preferably in a range of 5 to 200. Regarding Aa, more specifically, in a case where the inorganic solid electrolyte SE is a sulfide-based inorganic solid electrolyte, Ab is more preferably in a range of 2 to 300, still more preferably in a range of 4 to 200, and particularly preferably in a range of 8 to 170. On the other hand, in a case where the inorganic solid electrolyte SE is an oxide-based inorganic solid electrolyte, Ab is more preferably in a range of 2 to 300, still more preferably in a range of 3 to 250, and particularly preferably in a range of 5 to 200.

In the composition for an all-solid-state secondary battery according to the first aspect of the present invention, Ac calculated by the following expression 3 preferably satisfies 3≤Ac≤100. In a case where Ac is within the above-described range, the dispersibility of the active material AC and the inorganic solid electrolyte SE can be improved in a balanced manner, and even in a case where the concentration is increased or the preparation time is shortened, the active material AC and the inorganic solid electrolyte SE can be highly dispersed in the dispersion medium D while suppressing the occurrence of aggregation.

$$Ac = [ Aa \times ( Content of active material AC / Total solid content amount ) ] + [ Ab \times ( Content of inorganic solid electrolyte SE / Total solid content amount ) ] \qquad [ Expression 3 ]$$

The expression 3 is a experimentally found calculation expression which is a sum of products of Aa and Ab with the mass fraction, and can improve the dispersibility of the active material AC by Aa and the dispersibility of the inorganic solid electrolyte SE by Ab in a balanced manner.

In the present invention, from the viewpoint of further improving the dispersibility of the active material AC and the inorganic solid electrolyte SE to a more advanced level in a balanced manner, Ac calculated by the expression 3 is more preferably in a range of 5 to 75 and still more preferably in a range of 10 to 50.

In the second aspect of the composition for an all-solid-state secondary battery according to the embodiment of the present invention, Ab calculated by the following expression 2 satisfies 2≤Ab≤500. The composition for an all-solid-state secondary battery according to the second aspect is usually an inorganic solid electrolyte-containing composition, but includes an electrode composition. In the composition for an all-solid-state secondary battery according to the second aspect, as Aa is within the range, even in a case where the active material AC is in coexistence, the dispersibility of the solid particles, particularly the inorganic solid electrolyte SE, is improved, and even in a case where the concentration is increased or the preparation time is shortened, the solid particles can be dispersed in the dispersion medium D while suppressing the occurrence of aggregation. From the viewpoint of achieving more advanced dispersion of the solid particles, particularly the inorganic solid electrolyte SE, Ab is preferably in a range of 2 to 300, more preferably in a range of 3 to 250, and still more preferably in a range of 5 to 200. Details of Ab (more preferred range depending on the type of the inorganic solid electrolyte, and the like) are the same as the details of Ab in the composition for an all-solid-state secondary battery according to the first aspect of the present invention described above.

The technical meaning of the expression 2 is as described above.

$$Ab = {( Adsorption rate of polymer A to inorganic solid electrolyte SE )}^{2} \times [ ( ( Content of polymer A / Total solid content amount ) / ( Molecular weight of polymer A ) ) / {( Total specific surface area of inorganic solid electrolyte SE )}^{3 / 2} ] \times {10}^{10} \qquad [ Expression 2 ]$$

In the expression 2, the total specific surface area of the inorganic solid electrolyte SE is a value calculated from Specific surface area of inorganic solid electrolyte SE×Content of inorganic solid electrolyte SE/Total solid content amount.

In a case where the composition for an all-solid-state secondary battery according to the second aspect of the present invention contains an active material (in a case corresponding to an electrode composition), Aa calculated by the following expression 1 preferably satisfies 1≤Aa≤100. That is, in a case where the composition for an all-solid-state secondary battery according to the second aspect of the present invention contains an active material, the form thereof is the same as the preferred form of the composition for an all-solid-state secondary battery according to the first aspect of the present invention, which satisfies Aa calculated by the expression 1 and Ab calculated by the expression 2, and thus the description thereof will not be repeated.

In addition, in a case where the composition for an all-solid-state secondary battery according to the second aspect of the present invention contains an active material, a further preferred form is also the same as the preferred form of the composition for an all-solid-state secondary battery according to the first aspect of the present invention, which satisfies Aa calculated by the expression 1 and Ab calculated by the expression 2, and thus the description thereof will not be repeated.

Since the composition for an all-solid-state secondary battery according to the embodiment of the present invention exhibits the above-described excellent characteristics, the composition for an all-solid-state secondary battery can be preferably used as a material for forming a constituent layer of a sheet for an all-solid-state secondary battery and an all-solid-state secondary battery. In particular, the composition can be preferably used as a material for forming a negative electrode active material layer.

The composition for an all-solid-state secondary battery according to the embodiment of the present invention is preferably a slurry in which the inorganic solid electrolyte SE and the active material AC are dispersed in the dispersion medium D.

The composition for an all-solid-state secondary battery according to the embodiment of the present invention is preferably a non-aqueous composition. In the present invention, the non-aqueous composition includes not only an aspect including no watery moisture but also an aspect in which the moisture content (also referred to as the watery moisture content) is preferably 500 ppm or less. In the non-aqueous composition, the moisture content is more preferably 200 ppm or less, still more preferably 100 ppm or less, and particularly preferably 50 ppm or less. In a case where the composition for an all-solid-state secondary battery is a non-aqueous composition, it is possible to suppress the deterioration of the inorganic solid electrolyte SE. The water content refers to the water amount contained in the composition for an all-solid-state secondary battery (mass proportion to the electrode composition), and specifically, it is a value measured by carrying out filtration through a 0.02 μm membrane filter and then Karl Fischer titration.

Hereinafter, components which are contained in the composition for an all-solid-state secondary battery according to the embodiment of the present invention and components which can be contained therein will be described.

Each component contained in the composition for an all-solid-state secondary battery according to the embodiment of the present invention may be one kind or two or more kinds.

### <Inorganic Solid Electrolyte SE>

The composition for an all-solid-state secondary battery according to the embodiment of the present invention contains the inorganic solid electrolyte SE.

In the present invention, the inorganic solid electrolyte is an inorganic solid electrolyte, where the solid electrolyte refers to a solid-form electrolyte capable of migrating ions therein. The inorganic solid electrolyte is clearly distinguished from an organic solid electrolyte (a polymeric electrolyte such as polyethylene oxide (PEO), and an organic electrolyte salt such as lithium bis(trifluoromethanesulfonyl)imide (LiTFSI)) since it does not include any organic substance as a principal ion-conductive material. In addition, the inorganic solid electrolyte is solid in a steady state, and thus, typically, is not dissociated or liberated into cations and anions. From the viewpoint, the inorganic solid electrolyte is also clearly distinguished from an inorganic electrolyte salt in which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has ionic conductivity of a metal belonging to Group 1 or Group 2 in the periodic table, and generally does not have electron conductivity.

As the above-described inorganic solid electrolyte, a solid electrolyte material which is typically used for an all-solid-state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolyte is preferable from the viewpoint that it is possible to form a more favorable interface between the active material and the inorganic solid electrolyte.

In a case where the all-solid-state secondary battery according to the embodiment of the present invention is a lithium ion battery, the inorganic solid electrolyte preferably has ion conductivity for lithium ions.

### (i) Sulfide-Based Inorganic Solid Electrolyte

The sulfide-based inorganic solid electrolyte is preferably an electrolyte which contains a sulfur atom, has ionic conductivity of a metal belonging to Group 1 or Group 2 in the periodic table, and has electron-insulating properties. The sulfide-based inorganic solid electrolyte is preferably an inorganic solid electrolyte which contains, as elements, at least Li, S, and P and have lithium ion conductivity, but the sulfide-based inorganic solid electrolyte may appropriately contain elements other than Li, S, and P.

Examples of the sulfide-based inorganic solid electrolyte include an inorganic solid electrolyte having ionic conductivity for lithium ions, which satisfies a formulation represented by Formula (S1).

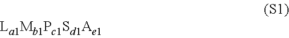

In Formula (S1), L represents an element selected from Li, Na, or K, and is preferably Li. M represents an element selected from B, Zn, Sn, Si, Cu, Ga, Sb, Al, or Ge. A represents an element selected from I, Br, Cl, or F. a1 to e1 represent compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic), and may be only partially crystallized. For example, it is possible to use Li—P—S-based glass containing Li, P, and S or Li—P—S-based glass ceramic containing Li, P, and S.

The sulfide-based inorganic solid electrolyte can be manufactured by a reaction of at least two or more raw materials of, for example, lithium sulfide (Li₂S), phosphorus sulfide (for example, diphosphorus pentasulfide (P₂S5)), a phosphorus single body, a sulfur single body, sodium sulfide, hydrogen sulfide, lithium halides (for example, LiI, LiBr, and LiCl), and sulfides of an element represented by M described above (for example, SiS₂, SnS, and GeS₂).

A ratio between Li₂S and P₂S₅ in the Li—P—S-based glass and the Li—P—S-based glass ceramic is preferably 60:40 to 90:10 and more preferably 68:32 to 78:22 in terms of a molar ratio between Li₂S:P₂S5. In a case where the ratio between Li₂S and P₂S₅ is set in the above-described range, it is possible to increase the lithium ion conductivity. Specifically, the lithium ion conductivity can be preferably set to 1×10⁻⁴ S/cm or more, and more preferably set to 1×10⁻³ S/cm or more. The upper limit thereof is not particularly limited, and it is practically 1×10⁻¹ S/cm or less.

As specific examples of the sulfide-based inorganic solid electrolyte, combination examples of raw materials are described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. However, a mixing ratio of the respective raw materials is not important. Examples of a method of synthesizing the sulfide-based inorganic solid electrolyte material using the above-described raw material compositions include an amorphization method. Examples of the amorphization method include a mechanical milling method, a solution method, and a melting quenching method. This is because the treatments can be carried out at normal temperature, and it is possible to simplify manufacturing process.

### (ii) Oxide-Based Inorganic Solid Electrolyte

The oxide-based inorganic solid electrolyte is preferably an electrolyte which contains an oxygen atom, has ionic conductivity of a metal belonging to Group 1 or Group 2 in the periodic table, and has electron-insulating properties.

An ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit thereof is not particularly limited, and it is practically 1×10⁻¹ S/cm or less.

Specific examples thereof include compounds such as LiₓₐLa_{ya}TiO₃ (LLT) [xa satisfies 0.3≤xa≤0.7 and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al,Ga)_{yd}(Ti,Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑ₎M^{ee}ₓₑD^{ee}O (xe represents a number of 0 or more and 0.1 or less, M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, and zf satisfies 1≤zf≤10); Li_{xg}S_{yg}O_{zg}(xg satisfies 1≤xg≤3, yg satisfies 0<yg≤2, and zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂Oi₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-y}hO₁₂ (xh satisfies 0≤xh≤1 and yh satisfies 0≤yh≤1); and Li₇La₃Zr₂Oi₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are replaced with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Furthermore, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound which contains a halogen atom, has ionic conductivity of a metal belonging to Group 1 or Group 2 in the periodic table, and has electron-insulating properties.

The halide-based inorganic solid electrolyte is not particularly limited, and examples thereof include LiCl, LiBr, LiI, and compounds such as Li₃YBr₆ and Li₃YCl₆ described in ADVANCED MATERIALS, 2018, 30, 1803075. Among these, Li₃YBr₆ or Li₃YCl₆ is preferable.

### (iv) Hydride-Based Inorganic Solid Electrolyte

The hydride-based inorganic solid electrolyte is preferably a compound which contains a hydrogen atom, has ionic conductivity of a metal belonging to Group 1 or Group 2 in the periodic table, and has electron-insulating properties.

The hydride-based inorganic solid electrolyte is not particularly limited, and examples thereof include LiBH₄, Li₄(BH₄)₃I, and 3LiBH₄—LiCl.

It is preferable that the inorganic solid electrolyte has a particle shape in the composition for an all-solid-state secondary battery. A shape of the particles is not particularly limited, and may be a flat shape, an amorphous shape, or the like; and a spherical shape or a granular shape is preferable. In a case where the inorganic solid electrolyte has a particle shape, a particle diameter (volume average particle size) of the inorganic solid electrolyte is not particularly limited, and is preferably 0.01 μm or more, more preferably 0.1 μm or more, and still more preferably 0.5 μm or more. The upper limit thereof is preferably 100 μm or less, more preferably 50 μm or less, and still more preferably 10 μm or less.

The particle diameter of the inorganic solid electrolyte is measured according to the following procedure. Particles of the inorganic solid electrolyte are diluted using water (heptane in a case where the material is unstable in water) in a 20 mL sample bottle to prepare 1% by mass of a dispersion liquid. The diluted dispersion liquid sample is irradiated with 1 kHz ultrasonic waves for 10 minutes, and then immediately used for test. Data collection is performed 50 times with the dispersion liquid sample using a laser diffraction/scattering-type particle size distribution analyzer LA-920 (product name, manufactured by Horiba Ltd.) and a quartz cell for measurement at a temperature of 25° C., thereby obtaining the volume average particle size. For other detailed conditions and the like, Japanese Industrial Standards (JIS) Z 8828: 2013 “Particle Diameter Analysis-Dynamic Light Scattering” is referred to as necessary. Five samples are produced for each level, and the average value thereof is adopted.

A method of adjusting the particle diameter is not particularly limited, and a known method can be applied. Examples thereof include a method using a typical pulverizer or a classifier. As the pulverizer or the classifier, for example, a mortar, a ball mill, a sand mill, a vibration ball mill, a satellite ball mill, a planetary ball mill, a swirling airflow-type jet mill, or a sieve is suitably used. During the pulverization, it is possible to carry out wet-type pulverization in which water or a dispersion medium such as methanol is allowed to be present together. In order to provide the desired particle diameter, classification is preferably performed. The classification is not particularly limited, and can be carried out using a sieve, a wind power classifier, or the like. Both a dry-type classification and a wet-type classification can be used.

The specific surface area of the inorganic solid electrolyte is not particularly limited, and is appropriately determined in consideration of Aa or Ab calculated by the expression 1 or the expression 2, or the like.

The specific surface area of the inorganic solid electrolyte SE is usually in a range of 0.1 to 100 m²/g, but in particular, from the viewpoint of improving the balance with the present amount of the polymer A to improve the dispersibility of the solid particles and from the viewpoint of easily setting Ab calculated by the expression 2 within the above-described range, it is preferably in a range of 0.5 to 15 m²/g, more preferably in a range of 1 to 10 m²/g, and still more preferably in a range of 1 to 5 m²/g. The specific surface area of the inorganic solid electrolyte SE can be adjusted to the above-described range by changing the above-described (conditions) for adjusting the particle diameter, micronization conditions (for example, mechanical milling conditions in Examples), or the like.

The composition for an all-solid-state secondary battery may contain one kind or two or more kinds of the inorganic solid electrolytes.

A content of the inorganic solid electrolyte SE in the composition for an all-solid-state secondary battery is not particularly limited and is appropriately determined. For example, from the viewpoint of dispersibility and binding property, the content of the inorganic solid electrolyte SE is preferably 50% by mass or more, more preferably 70% by mass or more, and particularly preferably 90% by mass or more in 100% by mass of the solid contents. From the same viewpoint, the upper limit thereof is preferably 99.9% by mass or less, more preferably 99.5% by mass or less, and particularly preferably 99% by mass or less.

However, in a case where the composition for an all-solid-state secondary battery contains the active material AC described later, regarding the content of the inorganic solid electrolyte in the composition for an all-solid-state secondary battery, the total content of the active material AC and the inorganic solid electrolyte SE is preferably within the above-described range.

In a case where the composition for an all-solid-state secondary battery contains the active material AC described later, the content of the inorganic solid electrolyte SE alone is appropriately determined in consideration of the above-described total content with the active material AC, and for example, is preferably 5% to 70% by mass, more preferably 10% to 60% by mass, and still more preferably 10% to 50% by mass in 100% by mass of the solid contents.

A ratio [content of inorganic solid electrolyte SE:content of active material AC] of the content of the inorganic solid electrolyte SE to the content of the active material AC in 100% by mass of the solid contents of the composition for an all-solid-state secondary battery is not particularly limited, and is, for example, preferably 1:1 to 1:6 and more preferably 1:1.2 to 1:5.

In the present invention, the solid content (solid component) refers to components which do not disappear by being volatilized or evaporated in a case where the composition for an all-solid-state secondary battery is subjected to drying treatment at 150° C. for 6 hours in a nitrogen atmosphere at a pressure of 1 mmHg. Typically, the solid content refers to a constitutional component other than the dispersion medium D described later. In addition, the content in the total solid content indicates the content in 100% by mass of the total mass of the solid content.

### <Active Material AC>

The electrode composition according to the embodiment of the present invention contains the active material AC capable of intercalating and deintercalating ions of a metal belonging to Group 1 or Group 2 in the periodic table. On the other hand, the inorganic solid electrolyte-containing composition according to the embodiment of the present invention may appropriately contain the active material AC.

Examples of the active material AC include a positive electrode active material and a negative electrode active material, which will be described later.

### (Positive Electrode Active Material)

The positive electrode active material is an active material capable of intercalating and deintercalating an ion of a metal belonging to Group 1 or Group 2 in the periodic table, and an active material capable of reversibly intercalating and deintercalating lithium ions is preferable. The material is not particularly limited as long as the material has the above-described characteristics, and the material may be a transition metal oxide, an organic substance, an element capable of being complexed with Li, such as sulfur, or the like.

Among these, as the positive electrode active material, transition metal oxides are preferably used, and transition metal oxides having a transition metal element Ma (one or more elements selected from Co, Ni, Fe, Mn, Cu, and V) are more preferable. In addition, an element M^{b} (an element of Group 1 (Ia) in the periodic table other than lithium, an element of Group 2 (IIa), or an element such as Al, Ga, In, Ge, Sn, Pb, Sb, Bi, Si, P, or B) may be mixed into the transition metal oxide. A mixing amount thereof is preferably 0% to 30% by mole of the amount (100% by mole) of the transition metal element M^{a}. It is more preferable that the transition metal oxide is synthesized by mixing the above-described components such that a molar ratio Li/M^{a} is 0.3 to 2.2.

Specific examples of the transition metal oxide include (MA) transition metal oxides having a bedded salt-type structure, (MB) transition metal oxides having a spinel-type structure, (MC) lithium-containing transition metal phosphoric acid compounds, (MD) lithium-containing transition metal halogenated phosphoric acid compounds, and (ME) lithium-containing transition metal silicate compounds.

Specific examples of the transition metal oxide having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{0/3}Co_{1/3}Mn_{1/3}O₂ (lithium nickel manganese cobalt oxide [NMC]; also referred to as [NCM]), and LiNi_{0.5}Mn_{0.5}O₂ (lithium manganese nickelate).

Specific examples of the transition metal oxide having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃; cobalt phosphates such as LiCoPO₄; iron pyrophosphates such as LiFeP₂O₇; and monoclinic NASICON-type vanadium phosphate salts such as Li₃V₂(PO₄)₃(lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, and cobalt fluorophosphates such as Li₂CoPO₄F. Examples of the lithium-containing transition metal silicate compound (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

A positive electrode active material obtained using a baking method may be used after being washed with water, an acidic aqueous solution, an alkaline aqueous solution, or an organic solvent.

The positive electrode active material contained in the electrode composition according to the embodiment of the present invention preferably has a particle shape in the electrode composition. A shape of the particles is not particularly limited, and may be a flat shape, an amorphous shape, or the like; and a spherical shape or a granular shape is preferable. In a case where the positive electrode active material has a particle shape, a particle diameter (volume average particle size) of the positive electrode active material is not particularly limited, and for example, it is preferably 0.1 to 50 μm and more preferably 0.5 to 10 μm. The particle diameter of the positive electrode active material particles can be adjusted in the same manner as in the adjustment of the particle diameter of the inorganic solid electrolyte described above, and it can be measured by the same measuring method as the method of measuring the particle diameter of the inorganic solid electrolyte.

The positive electrode active material contained in the electrode composition according to the embodiment of the present invention may be one kind or two or more kinds.

A content of the positive electrode active material in the electrode composition is not particularly limited and is appropriately determined. For example, it is preferably 10% to 97% by mass, more preferably 30% to 95% by mass, still more preferably 40% to 93% by mass, and particularly preferably 50% to 90% by mass in 100% by mass of the solid content.

### (Negative Electrode Active Material)

The negative electrode active material is an active material capable of intercalating and deintercalating an ion of a metal belonging to Group 1 or Group 2 in the periodic table, and an active material capable of reversibly intercalating and deintercalating lithium ions is preferable. The material is not particularly limited as long as the material has the above-described characteristics, and examples thereof include a carbonaceous material, a metal oxide, a metal composite oxide, lithium, a lithium alloy, and a negative electrode active material capable of forming an alloy (capable of being alloyed) with lithium. Among these, a carbonaceous material, a metal composite oxide, or a lithium single body is preferably used from the viewpoint of reliability. An active material which is capable of being alloyed with lithium is preferable because a capacity of the all-solid-state secondary battery can be increased.

The carbonaceous material used as the negative electrode active material is a material substantially consisting of carbon. Examples thereof include petroleum pitch, carbon black such as acetylene black (AB), graphite (natural graphite and artificial graphite such as vapor-grown graphite), and carbonaceous material obtained by calcining a variety of synthetic resins such as a polyacrylonitrile (PAN)-based resin and a furfuryl alcohol resin. Furthermore, examples thereof also include various carbon fibers such as PAN-based carbon fiber, cellulose-based carbon fiber, pitch-based carbon fiber, vapor-grown carbon fiber, dehydrated polyvinyl alcohol (PVA)-based carbon fiber, lignin carbon fiber, vitreous carbon fiber, and activated carbon fiber; mesophase microspheres, graphite whisker, and tabular graphite.

These carbonaceous materials can be classified into non-graphitizable carbonaceous materials (also referred to as “hard carbon”) and graphitizable carbonaceous materials, based on the graphitization degree. In addition, it is preferable that the carbonaceous material has the surface spacing, density, and crystallite size described in JP1987-22066A (JP-S₆₂-22066A), JP1990-6856A (JP-H2-6856A), and JP1991-45473A (JP-H3-45473A). The carbonaceous material is not necessarily a single material, and may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element, which is applied as the negative electrode active material, is not particularly limited as long as it is an oxide capable of intercalating and deintercalating lithium; and examples thereof include an oxide of a metal element (metal oxide), a composite oxide of a metal element or a composite oxide of a metal element and a metalloid element (collectively referred to as a metal composite oxide), and an oxide of a metalloid element (a metalloid oxide). The oxide is preferably an amorphous oxide, and preferred examples thereof include chalcogenides which are reaction products between metal elements and elements of Group 16 in the periodic table. In the present invention, the metalloid element refers to an element having intermediate properties between those of a metal element and a non-metal element, and typically, the metalloid element includes six elements including boron, silicon, germanium, arsenic, antimony, and tellurium, and further includes three elements including selenium, polonium, and astatine. In addition, the “noncrystalline” means an oxide having a broad scattering band with an apex in a range of 200 to 400 in terms of the 20 value in case of being measured by an X-ray diffraction method using a CuKα ray, and the oxide may have a crystalline diffraction line. The highest intensity in a crystalline diffraction line observed in a range of 400 to 700 in terms of the 20 value is preferably 100 times or less and more preferably 5 times or less with respect to the intensity of a diffraction line at the apex in a broad scattering band observed in a range of 200 to 400 in terms of the 20 value, and it is particularly preferable that the oxide does not have a crystalline diffraction line.

In the compound group consisting of the noncrystalline oxides and the chalcogenides described above, the noncrystalline oxide of a metalloid element or the above-described chalcogenide is more preferable; and a (composite) oxide consisting of one element or a combination of two or more elements selected from elements (for example, Al, Ga, Si, Sn, Ge, Pb, Sb, and Bi) of Group 13 (IIIB) to Group 15 (VB) in the periodic table or the chalcogenide is particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of a negative electrode active material which can be used in combination with the noncrystalline oxide mainly using Sn, Si, or Ge include a carbonaceous material capable of intercalating and deintercalating lithium ions or lithium metal, a lithium single substance, a lithium alloy, and a negative electrode active material capable of forming an alloy with lithium.

It is preferable that an oxide of a metal or a metalloid element, in particular, a metal (composite) oxide and the above-described chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅Oi₂ (lithium titanium oxide [LTO]) is preferable from the viewpoint that the volume variation during the intercalation and deintercalation of lithium ions is small, and thus high-speed charging and discharging characteristics are excellent, and deterioration of electrodes is suppressed, whereby it is possible to improve life of the lithium ion secondary battery.

The lithium alloy as the negative electrode active material is not particularly limited as long as it is typically used as a negative electrode active material for a secondary battery; and examples thereof include a lithium aluminum alloy, specifically, a lithium aluminum alloy using lithium as a base metal, to which 10% by mass of aluminum is added.

The negative electrode active material capable of forming an alloy with lithium is not particularly limited as long as it is typically used as a negative electrode active material for a secondary battery. Such an active material is greatly expanded and contracted by the charging and discharging of the all-solid-state secondary battery, which accelerates the deterioration of the battery performance, but the composition for an all-solid-state secondary battery according to the embodiment of the present invention contains the polymer A described later and has Aa or Ab calculated by the expression 1 or the expression 2, so that the deterioration of the battery performance can be suppressed. Examples of such an active material include a (negative electrode) active material (an alloy or the like) having a silicon element or a tin element, and a metal such as Al or In; and a negative electrode active material (a silicon element-containing active material) having a silicon element capable of exhibiting high battery capacity is preferable, and a silicon element-containing active material in which a content of the silicon element is 50% by mole or more with respect to all constitutional elements is more preferable.

Generally, a negative electrode containing these negative electrode active materials (for example, an Si negative electrode containing a silicon element-containing active material, an Sn negative electrode containing a tin element-containing active material, and the like) can absorb a larger amount of Li ions than carbon negative electrodes (such as graphite and acetylene black). That is, the amount of Li ions absorbed per unit mass increases. Therefore, the battery capacity (energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOₓ (0<x≤1) and titanium, vanadium, chromium, manganese, nickel, copper, lanthanum, or the like or a structured active material thereof (for example, LaSi₂/Si), and an active material containing a silicon element and a tin element, such as SnSiO₃ or SnSiS₃. Since SiOₓ itself can be used as the negative electrode active material (the metalloid oxide) and Si is produced along with the operation of the all-solid-state secondary battery, SiOₓ can be used as a negative electrode active material (or a precursor material thereof) capable of forming an alloy with lithium.

Examples of the negative electrode active material containing a tin element include Sn, SnO, SnO₂, SnS, SnS₂, and the above-described active material containing a silicon element and a tin element. In addition, a composite oxide with lithium oxide, for example, Li₂SnO₂ can also be used.

In the present invention, the above-described negative electrode active material can be used without being particularly limited. However, from the viewpoint of battery capacity, a preferred aspect as the negative electrode active material is a negative electrode active material capable of being alloyed with lithium, and among these, the silicon material or the silicon-containing alloy (the alloy containing a silicon element) described above is more preferable, and it is still more preferable to contain a negative electrode active material containing silicon (Si) or a silicon-containing alloy.

The negative electrode active material contained in the electrode composition according to the embodiment of the present invention preferably has a particle shape in the electrode composition. A shape of the particles is not particularly limited, and may be a flat shape, an amorphous shape, or the like; and a spherical shape or a granular shape is preferable. In a case where the negative electrode active material has a particle shape, a particle diameter (volume average particle size) of the negative electrode active material is not particularly limited, and for example, it is preferably 0.1 to 60 μm and more preferably 0.5 to 10 μm. The particle diameter of the negative electrode active material particles can be adjusted in the same manner as in the adjustment of the particle diameter of the inorganic solid electrolyte described above, and it can be measured by the same measuring method as the method of measuring the particle diameter of the inorganic solid electrolyte.

The negative electrode active material contained in the electrode composition according to the embodiment of the present invention may be one kind or two or more kinds.

A content of the negative electrode active material in the electrode composition is not particularly limited and is appropriately determined. For example, it is preferably 10% to 90% by mass, more preferably 20% to 85% by mass, still more preferably 30% to 80% by mass, and even still more preferably 40% to 75% by mass in 100% by mass of the solid content.

The specific surface area of the active material AC is not particularly limited, and is appropriately determined in consideration of Aa or Ab calculated by the expression 1 or the expression 2, or the like.

The specific surface area of the active material AC is usually in a range of 0.1 to 100 m²/g, but in particular, from the viewpoint of improving the balance with the present amount of the polymer A to improve the dispersibility of the solid particles and from the viewpoint of easily setting Aa calculated by the expression 1 within the above-described range, it is preferably in a range of 0.3 to 50 m²/g and more preferably in a range of 2 to 35 m²/g.

In a case where the active material AC is a positive electrode active material, among the above-described ranges, the specific surface area thereof is more preferably in a range of 0.3 to 20 m²/g and still more preferably in a range of 0.5 to 10 m²/g. On the other hand, in a case where the active material AC is a negative electrode active material, among the above-described ranges, the specific surface area thereof is preferably in a range of 2 to 100 m²/g and more preferably in a range of 2 to 35 m²/g.

The specific surface area of the active material AC can be adjusted to the above-described range by changing the above-described (conditions) for adjusting the particle diameter, micronization conditions (for example, mechanical milling conditions in Examples), or the like.

In the present invention, a negative electrode active material layer can be formed by charging a secondary battery. In this case, ions of a metal belonging to Group 1 or Group 2 in the periodic table, produced in the all-solid-state secondary battery, can be used instead of the above-described negative electrode active material. By bonding the ions to electrons and precipitating a metal, the negative electrode active material layer can be formed.

A chemical formula of a compound obtained by the above-described baking method can be calculated using an inductively coupled plasma (ICP) emission spectroscopy as a measuring method from the mass difference of powder before and after baking as a convenient method.

### (Coating of Active Material)

Surfaces of the positive electrode active material and the negative electrode active material may be subjected to surface coating with another metal oxide. Examples of a surface coating agent include metal oxides containing Ti, Nb, Ta, W, Zr, Al, Si, or Li. Examples thereof include titanium oxide spinel, tantalum-based oxides, niobium-based oxides, and lithium niobate-based compounds; and specific examples thereof include Li₄Ti₅Oi₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or the negative electrode active material may be subjected to a surface treatment with sulfur or phosphorus.

Furthermore, the particle surface of the positive electrode active material or the negative electrode active material may be subjected to a surface treatment with an actinic ray or an active gas (plasma or the like) before and after the surface coating.

### <Polymer A>

The polymer A used in the present invention is soluble in at least the dispersion medium D. A solubility of the polymer A in the dispersion medium D is as described above.

The adsorption rate A_{AC} (°/o) of the polymer A to the active material AC is not particularly limited, but in a case where the adsorption rate A_{AC} is too small, the polymer A cannot be adsorbed to the active material AC and cannot be dispersed in the dispersion medium D. On the other hand, in a case where the adsorption rate A_{AC} is too large, the polymer A is excessively adsorbed to the active material AC and is likely to aggregate. From the viewpoint that the polymer A is moderately adsorbed to the active material AC for functioning as a dispersant to improve the dispersibility in the dispersion medium D, the adsorption rate A_{AC} is preferably 2% to 50%, more preferably 3% to 40%, and still more preferably 4% to 35%.

In a case where the active material AC is a positive electrode active material, among the above-described ranges, the adsorption rate A_{AC} of the polymer A to the positive electrode active material is more preferably 3% to 40%, still more preferably 5% to 30%, and particularly preferably 5% to 20%. On the other hand, in a case where the active material AC is a negative electrode active material, among the above-described ranges, the adsorption rate A_{AC} of the polymer A to the negative electrode active material is preferably 2% to 50%, more preferably 3% to 40%, and still more preferably 4% to 35%. The meaning of the adsorption rate A_{AC} is as described above.

The adsorption rate A_{SE} (%) of the polymer A to the inorganic solid electrolyte SE is not particularly limited, but in a case where the adsorption rate A_{SE} is too small, the polymer A cannot be adsorbed to the inorganic solid electrolyte SE and cannot be dispersed in the dispersion medium D. On the other hand, in a case where the adsorption rate A_{SE} is too large, the polymer A is excessively adsorbed to the inorganic solid electrolyte SE and is likely to aggregate. From the viewpoint that the polymer A is moderately adsorbed to the inorganic solid electrolyte SE to improve the dispersibility in the dispersion medium D, the adsorption rate A_{SE} is preferably 1% to 70%, more preferably 2% to 50%, and still more preferably 5% to 40%.

In a case where the inorganic solid electrolyte SE is a sulfide-based inorganic solid electrolyte, among the above-described ranges, the adsorption rate A_{SE} of the polymer A to the sulfide-based inorganic solid electrolyte is preferably 1% to 70%, more preferably 2% to 50%, and still more preferably 5% to 40%. On the other hand, in a case where the inorganic solid electrolyte SE is an oxide-based inorganic solid electrolyte, among the above-described ranges, the adsorption rate A_{SE} of the polymer A to the oxide-based inorganic solid electrolyte is preferably 1% to 70%, more preferably 5% to 50%, and still more preferably 7% to 50%. The meaning of the adsorption rate A_{SE} is as described above.

A molecular weight (which means a weight-average molecular weight) of the polymer A is not particularly limited, and can be set to 1.0×10³ to 1.0×10⁵. In the present invention, from the viewpoint that the number of molecules of the polymer A per unit mass can be increased to effectively function as a dispersant, and from the viewpoint that Aa and Ab calculated by the expression 1 and the expression 2 can be easily set within the above-described ranges, the weight-average molecular weight thereof is preferably 2.0×10³ to 7.0×10⁴, more preferably 3.0×10³ to 6.0×10⁴, still more preferably 2.0×10⁴ or less, and particularly preferably 4.0× 10³ to 2.0×10⁴.

The weight-average molecular weight of the polymer A can be appropriately adjusted by changing the kind and used amount of the polymerization initiator and the like, polymerization time, polymerization temperature, and the like.

In the present invention, the molecular weight of the polymer A refers to a weight-average molecular weight in terms of standard polystyrene, which is measured by gel permeation chromatography (GPC), unless otherwise specified. A measuring method thereof includes, basically, a method in which conditions are set to Condition 1 or Condition 2 (preferential) described below.

In the present invention, unless otherwise specified, the weight-average molecular weight or the number-average molecular weight of the polymer chain (polymerized chain) and the macromonomer is a weight-average molecular weight or a number-average molecular weight in terms of standard polystyrene, which is measured in the same manner as the molecular weight measurement method of the polymer A described above.

However, an appropriate eluant may be appropriately selected and used depending on the type of the polymer A, the polymer chain, the macromonomer, and the like.

### (Condition 1)

Column: two connected columns of TOSOH TSKgel Super AWM-H (trade name, manufactured by Tosoh Corporation)
Carrier: 10 mM LiBr/N-methylpyrrolidone
Measurement temperature: 40° C.
Carrier flow rate: 1.0 ml/min
Sample concentration: 0.1 mass %
Detector: refractive index (RI) detector

### (Condition 2)

Column: column obtained by connecting TOSOH TSKgel Super HZM-H, TOSOH TSKgel Super HZ4000, and TOSOH TSKgel Super HZ2000 (all of which are trade names, manufactured by Tosoh Corporation)
Carrier: tetrahydrofuran
Measurement temperature: 40° C.
Carrier flow rate: 1.0 ml/min
Sample concentration: 0.1 mass %
Detector: refractive index (RI) detector

As the polymer A, various polymers used in the all-solid-state secondary battery can be used without particular limitation as long as it is dissolved in the dispersion medium D.

Preferred examples of the polymer A include a polymer having, in the main chain, at least one bond selected from a urethane bond, a urea bond, an amide bond, an imide bond, and an ester bond, or a polymerized chain of carbon-carbon double bonds. In the present invention, the polymerized chain of carbon-carbon double bonds refers to a polymerized chain which is obtained by polymerizing carbon-carbon double bonds (ethylenically unsaturated groups), and specifically, it refers to a polymerized chain obtained by polymerizing (homopolymerizing or copolymerizing) a monomer having a carbon-carbon unsaturated bond. More specifically, examples of the polymer having a urethane bond, a urea bond, an amide bond, an imide bond, or an ester bond in the main chain among the above-described bonds include step-polymerization polymers (polycondensation, polyaddition, or addition condensation) such as polyurethane, polyurea, polyamide, polyimide, polyester, polyether, and polycarbonate. In addition, examples of the polymer having a polymerized chain of carbon-carbon double bonds in the main chain include chain-polymerization polymers such as a fluoropolymer (a fluorine-containing polymer), a hydrocarbon polymer, a vinyl polymer, and a (meth)acrylic polymer. The polymerization mode of these polymers is not particularly limited, and the polymers may be any one of a block copolymer, an alternating copolymer, or a random copolymer. Among these, a chain-polymerization polymer is preferable, a hydrocarbon polymer, a vinyl polymer, or a (meth)acrylic polymer is more preferable, and a (meth)acrylic polymer is still more preferable.

The composition for an all-solid-state secondary battery according to the embodiment of the present invention may contain one kind or two or more kinds of the polymers A. In a case of containing two or more kinds of the polymers, it is preferable that at least one polymer is the chain-polymerization polymer, and it is more preferable that all polymers are the chain-polymerization polymers.

### (Polymer A According to Preferred First Aspect)

Examples of the polymer A preferably used in the present invention (which is sometimes referred to as a polymer A according to a preferred first aspect) include a polymer containing at least one of a constitutional component which has a substituent having 8 or more carbon atoms as a side chain, or a constitutional component which has a functional group selected from a group (a) of functional groups. The polymer exhibits a moderate adsorption rate to the active material AC and the inorganic solid electrolyte SE, and contributes to the improvement of the dispersibility.

It is preferable that the polymer A according to the preferred first aspect does not contain a constitutional component (X) in a polymer A according to the preferred second aspect (a content of the constitutional component (X) in the polymer A is 0.2% by mass or less). In addition, a molecular structure of the polymer A according to the preferred first aspect is not particularly limited, but it is preferable that the polymer A does not have a star structure (multibranched structure).

—Constitutional Component which has Substituent Having 8 or More Carbon Atoms as Side Chain—

It is preferable that the polymer A contains a constitutional component which has a substituent having 8 or more carbon atoms as a side chain. The constitutional component contributes to the improvement of the dispersibility by reducing polarity of the polymer A to improve the solubility in the dispersion medium.

The constitutional component may be any constitutional component forming the polymer A, and the substituent having 8 or more carbon atoms thereof is introduced as a side chain of the polymer A or a part thereof. It is preferable that the constitutional component has a substituent having 8 or more carbon atoms in a partial structure incorporated into the main chain of the polymer A directly or through a linking group.

The partial structure incorporated into the main chain of the polymer A is appropriately selected depending on the type of the polymer A or the like, and examples thereof include a carbon chain (carbon-carbon bond) in a case where the polymer A is a chain-polymerization polymer.

The substituent having 8 or more carbon atoms is not particularly limited, and examples thereof include a group having 8 or more carbon atoms among the substituents Z described later. In a case where the constitutional component includes a polymerized chain as a side chain, the substituent having 8 or more carbon atoms includes a substituent having 8 or more carbon atoms, which is contained in each constitutional component constituting the polymerized chain, but the entire polymerized chain is not regarded as the substituent having 8 or more carbon atoms.

Specific examples of the substituent having 8 or more carbon atoms include a long-chain alkyl group having 8 or more carbon atoms, a cycloalkyl group having 8 or more carbon atoms, an aryl group having 8 or more carbon atoms, an aralkyl group having 8 or more carbon atoms, and a heterocyclic group having 8 or more carbon atoms; and a long-chain alkyl group having 8 or more carbon atoms is preferable.

The number of carbon atoms in the substituent may be 8 or more, and is preferably 10 or more, and more preferably 12 or more. The upper limit thereof is not particularly limited, and is preferably 24 or less, more preferably 20 or less, and still more preferably 16 or less. The number of carbon atoms in the substituent indicates the number of carbon atoms constituting the substituent, and in a case where the substituent further has a substituent, the number of carbon atoms constituting the further substituent is included.

The linking group is not particularly limited, and examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—; R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group of a combination thereof. The linking group is preferably a group obtained by combining an alkylene group, an arylene group, a carbonyl group, an oxygen atom, a sulfur atom, and an imino group; more preferably a group obtained by combining an alkylene group, an arylene group, a carbonyl group, an oxygen atom, and an imino group; still more preferably a group containing a —CO—O— group, a —CO—N(R^{N})— group (R^{N} is as described above); particularly preferably a —CO—O— group or a —CO—N(R^{N})— group (R^{N} is as described above); and most preferably a —CO—O— group. The number of atoms constituting the linking group and the number of linking atoms are as described below.

In the present invention, the number of atoms constituting the linking group is preferably 1 to 36, more preferably 1 to 24, still more preferably 1 to 12, and particularly preferably 1 to 6. The number of linking atoms of the linking group is preferably 10 or less, and more preferably 8 or less. The lower limit thereof is 1 or more. The above-described number of linking atoms refers to the minimum number of atoms linking predetermined structural moieties. For example, in a case of —C(═O)—O—, the number of atoms constituting the linking group is 3 and the number of linking atoms is 2.

Each of the partial structure incorporated into the main chain, the linking group, and the substituent having 8 or more carbon atoms may have a substituent. Such a substituent is not particularly limited, and examples thereof include a group selected from the substituents Z described later, and a group other than functional groups selected from the group (a) of functional groups is preferable.

The constitutional component having a substituent having 8 or more carbon atoms can be constituted by appropriately combining the above-described partial structure incorporated into the main chain, the substituent having 8 or more carbon atoms, and the linking group; and for example, it is preferably a constitutional component represented by Formula (1-1).

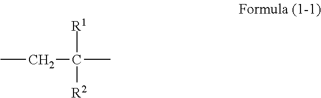

In Formula (1-1), R¹ represents a hydrogen atom or an alkyl group (preferably having 1 to 12 carbon atoms, more preferably having 1 to 6 carbon atoms, and still more preferably having 1 to 3 carbon atoms). The alkyl group which can be adopted as R¹ may have a substituent. The substituent is not particularly limited, and examples thereof include the substituents Z described later. A group other than functional groups selected from the group (a) of functional groups is preferable, and suitable examples thereof include a halogen atom.

R² represents a group having a substituent having 8 or more carbon atoms. In the present invention, the group having a substituent includes a group consisting of the substituent itself (the substituent is directly bonded to the carbon atom in the above formula, to which R¹ is bonded), a linking group which links the carbon atom in the above formula, to which R² is bonded, to the substituent, and a group consisting of the substituent (the substituent is bonded to the carbon atom in the above formula, to which R¹ is bonded, through a linking group).

The substituent having 8 or more carbon atoms contained in R² and the linking group which may be contained in R² are as described above. R² is particularly preferably —C(═O)—O-long-chain alkyl group having 8 or more carbon atoms.

In Formula (1-1), the carbon atom adjacent to the carbon atom to which R¹ is bonded has two hydrogen atoms, but in the present invention, it may have one or two substituents. The substituent is not particularly limited, and examples thereof include the substituents Z described later, and a group other than functional groups selected from the group (a) of functional groups is preferable.

It is preferable that the constitutional component having a substituent having 8 or more carbon atoms is, for example, a constitutional component derived from a compound having a substituent having 8 or more carbon atoms, among (meth)acrylic compounds (M1) described later, or a constitutional component derived from a compound having a substituent having 8 or more carbon atoms, among other polymerizable compounds (M2) described later, and a long-chain alkyl ester compound of a (meth)acrylic acid (having 8 or more carbon atoms) is preferable.

Specific examples of the constitutional component having a substituent having 8 or more carbon atoms include constitutional components in polymers shown in specific examples described later and constitutional components in polymers synthesized in Examples, but the present invention is not limited thereto.

A content of the constitutional component having a substituent having 8 or more carbon atoms in the polymer A is not particularly limited, and is selected from a range of 0% to 100% by mass. For example, from the viewpoint of the dispersibility of the polymer A, the content thereof is preferably 20% to 99.9% by mass, more preferably 30% to 99.5% by mass, still more preferably 30% to 99% by mass, particularly preferably 50% to 99% by mass, and most preferably 80% to 99% by mass.

The content defined in the present specification can be set in a range obtained by appropriately combining the upper limit value and the lower limit value of each range.

(Constitutional Component which has Functional Group Selected from Group (a) of Functional Groups)

It is preferable that the polymer A according to the preferred first aspect contains a constitutional component having a functional group selected from the following group (a) of functional groups. The constitutional component contributes to the improvement of the dispersibility and adhesiveness by improving adsorption force of the polymer A to the inorganic solid electrolyte SE, the active material AC, and the conductive auxiliary agent.

The constitutional component may be any constitutional component forming the polymer A. The functional group may be incorporated into the main chain of the polymer, or may be incorporated into the side chain. In the case of being incorporated into the side chain, the functional group may be directly bonded to the main chain or may be bonded through the above-described linking group.

In the chain-polymerization polymer, the constitutional component having an ester bond (excluding an ester bond forming a carboxy group) or an amide bond refers to a constitutional component in which the ester bond or the amide bond is not directly bonded to an atom constituting the main chain of the chain-polymerization polymer or to an atom constituting the main chain of the polymerized chain (for example, polymerized chain of a macromonomer) which is incorporated into the chain-polymerization polymer as a branched chain or a pendant chain; and it does not include, for example, a constitutional component derived from a (meth)acrylic acid alkyl ester.

The functional group contained in one constitutional component may be one kind or two or more kinds; and in a case where two or more kinds are contained, the functional groups may be or may not be bonded to each other.

### <Group (a) of Functional Groups>

A hydroxy group, an amino group, a carboxy group, a sulfo group, a phosphate group, a phosphonate group, a sulfanyl group, an ether bond (—O—), an imino group (=NR, or —NR—), an ester bond (—CO—O—), an amide bond (—CO—NR—), a urethane bond (—NR—CO—O—), a urea bond (—NR—CO—NR—), a heterocyclic group, an aryl group, a carboxylic acid anhydride group, and a fluoroalkyl group

Each of the amino group, the sulfo group, the phosphate group (phosphoryl group), the heterocyclic group, and the aryl group, which are included in the group (a) of functional groups, is not particularly limited, but it has the same meaning as the corresponding group of the substituent Z described later. However, the amino group more preferably has 0 to 12 carbon atoms, still more preferably 0 to 6 carbon atoms, and particularly preferably 0 to 2 carbon atoms. The phosphonate group is not particularly limited, and examples thereof include a phosphonate group having 0 to 20 carbon atoms. In a case where a ring structure contains an amino group, an ether bond, an imino group (—NR—), an ester bond, an amide bond, a urethane bond, a urea bond, or the like, it is classified as a heterocyclic ring. The hydroxy group, the amino group, the carboxy group, the sulfo group, the phosphate group, the phosphonate group, or the sulfanyl group may form a salt.

The fluoroalkyl group is a group obtained by replacing at least one hydrogen atom of an alkyl group or a cycloalkyl group with a fluorine atom, and it preferably has 1 to 20 carbon atoms, more preferably 2 to 15 carbon atoms, and still more preferably 3 to 10 carbon atoms. Regarding the number of fluorine atoms on the carbon atom, a part of the hydrogen atoms may be replaced, or all hydrogen atoms may be replaced (a perfluoroalkyl group).

R in each bond represents a hydrogen atom or a substituent, and it is preferably a hydrogen atom. The substituent is not particularly limited, it is selected from the substituents Z described later, and an alkyl group is preferable.

The carboxylic acid anhydride group is not particularly limited, and it includes a group obtained by removing one or more hydrogen atoms from a carboxylic acid anhydride (for example, a group represented by Formula (2a)), and a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from an acyclic carboxylic acid anhydride or a cyclic carboxylic acid anhydride is preferable. The carboxylic acid anhydride group derived from a cyclic carboxylic acid anhydride also corresponds to the heterocyclic group, but it is classified as a carboxylic acid anhydride group in the present invention. Examples thereof include acyclic carboxylic acid anhydrides such as acetic acid anhydride, propionic acid anhydride, and benzoic acid anhydride; and cyclic carboxylic acid anhydrides such as maleic acid anhydride, phthalic acid anhydride, fumaric acid anhydride, succinic acid anhydride, and itaconic acid anhydride. The polymerizable carboxylic acid anhydride is not particularly limited, and examples thereof include a carboxylic acid anhydride having an unsaturated bond in the molecule, where a polymerizable cyclic carboxylic acid anhydride is preferable. Specific examples thereof include maleic acid anhydride and itaconic acid anhydride. Examples of the carboxylic acid anhydride group include a group represented by Formula (2a) and a constitutional component represented by Formula (2b, but the present invention is not limited thereto. In each formula, * represents a bonding position. As the carboxylic acid anhydride group, a dicarboxylic acid group included in a group (a1) of functional groups, which will be described later, can also be used.

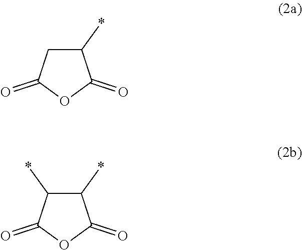 [SMILES: *C1CC(=O)OC1=O ; *C1C(=O)OC(=O)C1*]

The linking group which bonds the functional group to the main chain is not particularly limited, and examples thereof include the above-described linking groups. A particularly preferred linking group is a group obtained by combining a —CO—O— group or a —CO—N(R^{N})— group (R^{N} is as described above) and an alkylene group.

A method of incorporating the functional group into the polymer chain will be described later.

The compound having the above-described functional group is not particularly limited, and examples thereof include compounds having at least one carbon-carbon unsaturated bond and at least one functional group described above. For example, it includes a compound in which a carbon-carbon unsaturated bond and the above-described functional group are directly bonded to each other, a compound in which a carbon-carbon unsaturated bond and the above-described functional group are bonded to each other through a linking group, and a compound in which the functional group itself contains a carbon-carbon unsaturated bond (for example, the above-described polymerizable cyclic carboxylic acid anhydride). In addition, the compound having the above-described functional group includes compounds which are capable of introducing the functional group into a polymer constitutional component after polymerization by various reactions (for example, alcohol and each of the amino, mercapto, and epoxy compounds (including polymers thereof), which are capable of undergoing an addition reaction or a condensation reaction with a constitutional component derived from carboxylic acid anhydride, a constitutional component having a carbon-carbon unsaturated bond, or the like). Furthermore, the compound having the above-described functional group also include a compound in which a carbon-carbon unsaturated bond is bonded to a macromonomer having a functional group incorporated as a substituent in the polymerized chain, directly or through a linking group. Examples of the macromonomer from which the macromonomer constitutional component is derived include a macromonomer having a polymerized chain of a chain-polymerization polymer described later. A number-average molecular weight of the macromonomer is not particularly limited, but from the viewpoint that the binding force of the solid particles and the adhesiveness to the collector can be further strengthened while maintaining excellent dispersibility and coating suitability, it is preferably 500 to 100,000, more preferably 1,000 to 50,000, and still more preferably 2,000 to 20,000. In addition, a content of the repeating unit having the functional group, which is incorporated into the macromonomer, is preferably 1% to 100% by mole, more preferably 3% to 80% by mole, and still more preferably 5% to 70% by mole. A content of the repeating unit having no functional group is preferably 0%% to 90% by mole, more preferably 0% to 70% by mole, and still more preferably 0% to 50% by mole. Any component can be selected from the viewpoint of solubility and the like.

The constitutional component having the above-described functional group is not particularly limited as long as it has the above-described functional group, and examples thereof include a constitutional component obtained by introducing the above-described functional group into a (meth)acrylic compound (M1) or other polymerizable compounds (M2) described later, a constitutional component represented by any one of Formulae (b-1) to (b-3), or a constitutional component represented by Formulae (1-1) described later.

The compound from which the constitutional component having the above-described functional group is derived is not particularly limited, and examples thereof include a polymerizable cyclic carboxylic acid anhydride and a compound in which the above-described functional group is introduced into a fluoroalkyl group-containing (meth)acrylic acid short-chain alkyl ester compound (short-chain alkyl means an alkyl group having 3 or less of carbon atoms). The compound obtained by introducing the above-described functional group into the polymerizable cyclic carboxylic acid anhydride is as described above, and examples thereof include a dicarboxylic acid monoester compound which is obtained by subjecting a maleic acid anhydride compound and an alcohol to an addition reaction (a ring-opening reaction).

From the viewpoint of dispersibility and binding property of the polymer A, a content of the constitutional component having the above-described functional group in the polymer A is preferably 0.01% to 70% by mass, more preferably 0.01% to 50% by mass, still more preferably 0.01% to 30% by mass, particularly preferably 0.1% to 10% by mass, and most preferably 0.3% to 8% by mass.

In a case where the polymer A has a plurality of constitutional components having the functional group, the content of the constitutional component having the functional group is a total amount thereof. In addition, in a case where one constitutional component has a plurality of the functional groups or a plurality of kinds of the functional groups, the content of the constitutional component having the functional group is usually means a content of this constitutional component.

In a case where two or more kinds of the polymers A are contained, the content of the constitutional component having the above-described functional group with respect to the total number of moles of the constitutional components of all polymers A is not particularly limited, and is appropriately set according to the content in each polymer.

### (Other Constitutional Components)

The polymer A according to the preferred first aspect may contain a constitutional component (referred to as other constitutional components) which does not correspond to any of the above-described constitutional component having the substituent having 8 or more carbon atoms or the above-described constitutional component having a functional group selected from the group (a) of functional groups. The other constitutional components are not particularly limited as long as the constitutional components can constitute the polymer A, and the other constitutional components can be appropriately selected depending on the type of the polymer A or the like. Examples thereof include a constitutional component derived from a compound which does not have the substituent having 8 or more carbon atoms and the above-described functional group, among the (meth)acrylic compound (M1) and the other polymerizable compounds (M2) described later.

A content of the other constitutional components in the polymer A is not particularly limited, and is appropriately determined from a range of 0 to 100% by mass in consideration of the content of the above-described constitutional components. In a case where the polymer A contains the other constitutional components, for example, the content thereof is preferably 1% to 99% by mass, more preferably 5% to 80% by mass, and still more preferably 8% to 60% by mass.

The polymer A according to the preferred first aspect is preferably a chain-polymerization polymer, preferably a hydrocarbon polymer, a vinyl polymer, or a (meth)acrylic polymer, and more preferably a hydrocarbon polymer or a (meth)acrylic polymer.

Suitable chain-polymerization polymers will be specifically described below.

### (Hydrocarbon Polymer)

Examples of the hydrocarbon polymer include polyethylene, polypropylene, natural rubber, polybutadiene, polyisoprene, polystyrene, a polystyrene-butadiene copolymer, a styrene-based thermoplastic elastomer, polybutylene, an acrylonitrile-butadiene copolymer, and hydrogen-added (hydrogenated) polymers thereof. The styrene-based thermoplastic elastomer or a hydrogenated product thereof is not particularly limited, and examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated styrene-butadiene rubber (HSBR), and a random copolymer corresponding to each of the block copolymers such as SEBS. In the present invention, from the viewpoint that formation of chemical crosslink can be suppressed, the hydrocarbon polymer preferably has no unsaturated group (for example, a 1,2-butadiene constitutional component) which is bonded to the main chain.

It is also preferable that the above-described hydrocarbon polymer contains, in addition to the constitutional component (for example, styrene) constituting the hydrocarbon polymer described above, the above-described constitutional component having a substituent having 8 or more carbon atoms and the above-described constitutional component having a functional group; and examples thereof include a constitutional component derived from a polymerizable cyclic carboxylic acid anhydride such as maleic acid anhydride. Furthermore, the constitutional component having the functional group also includes, for example, a constitutional component obtained by introducing a functional group selected from the above-described group (a) of functional groups, or the like into a copolymerized constitutional component by various reactions.

A content of the constitutional component in the hydrocarbon polymer is not particularly limited, and can be appropriately selected, for example, set to the following range. A content of the constitutional component having a substituent having 8 or more carbon atoms in all constitutional components constituting the hydrocarbon polymer is as described above.

In all constitutional components constituting the hydrocarbon polymer, a content of the constitutional component derived from the compound having a functional group selected from the above-described group (a) of functional groups is, regardless of the above-described range, preferably 0.01% by mass or more, more preferably 0.02% by mass or more, still more preferably 0.05% by mass or more, and particularly preferably 0.1% by mass or more. The upper limit value thereof is preferably 20% by mass or less, more preferably 15% by mass or less, and still more preferably 10% by mass or less in all constitutional components constituting the hydrocarbon polymer. In a case where the hydrocarbon polymer has a plurality of constitutional components having a functional group, the content of the constitutional component having a functional group is a total amount thereof.

### (Vinyl Polymer)

Examples of the vinyl polymer include a polymer containing a vinyl monomer other than the (meth)acrylic compound (M1), in which a content of the vinyl polymer is, for example, 50% by mass or more. Examples of the vinyl monomer include vinyl compounds described later. Specific examples of the vinyl polymer include polyvinyl alcohol, polyvinyl acetal, polyvinyl acetate, and a copolymer containing these compounds.

It is also preferable that the vinyl polymer has, in addition to the constitutional component derived from the vinyl-based monomer, the above-described constitutional component having a substituent having 8 or more carbon atoms, the above-described constitutional component having a functional group, and at least one of a constitutional component derived from a (meth)acrylic compound (M1) forming a (meth)acrylic polymer described later.

A content of the constitutional component in the vinyl polymer is not particularly limited, can be appropriately selected in consideration of other physical properties, and for example, can be set to the following range.

The content of the constitutional component derived from a vinyl monomer in all constitutional components constituting the vinyl polymer is preferably the same as the content of the constitutional component derived from the (meth)acrylic compound (M1) in the (meth)acrylic polymer. Here, in a case where the constitutional component having a substituent having 8 or more carbon atoms and the constitutional component having a functional group are a constitutional component derived from a vinyl monomer, the contents of the constitutional components are included for calculation in the content of the constitutional component derived from a vinyl monomer.

Each of the content of the above-described constitutional component having a substituent having 8 or more carbon atoms and the content of the above-described constitutional component having a functional group in all constitutional components constituting the vinyl polymer are as described above.

A content of the constitutional component derived from the (meth)acrylic compound (M1) in the polymer is not particularly limited as long as it is less than 50% by mass, and is preferably 0 to 30% by mass.

### ((Meth)Acrylic Polymer)

The (meth)acrylic polymer is preferably a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound, and is also preferably a polymer having a constitutional component derived from this (meth)acrylic compound (M1) and at least one of the constitutional component having a substituent having 8 or more carbon atoms or the constitutional component having a functional group. In addition, a polymer containing a constitutional component derived from other polymerizable compounds (M2) is also preferable.

Examples of the (meth)acrylic acid ester compound include a (meth)acrylic acid alkyl ester compound, a (meth)acrylic acid aryl ester compound, a (meth)acrylic acid ester compound having a heterocyclic group, and a (meth)acrylic acid ester compound having a polymerized chain, and a (meth)acrylic acid alkyl ester compound is preferable. The number of carbon atoms in the alkyl group constituting the (meth)acrylic acid alkyl ester compound is not particularly limited, but it can be set to, for example, 1 to 24, from the viewpoint of dispersibility and adhesiveness, preferably 3 to 20, more preferably 4 to 16, and still more preferably 8 to 14. The number of carbon atoms in the aryl group constituting the aryl ester is not particularly limited, but it can be set to, for example, 6 to 24, preferably 6 to 10 and more preferably 6. In the (meth)acrylamide compound, the nitrogen atom of the amide group may be substituted with an alkyl group or an aryl group. The above-described polymerized chain contained in the (meth)acrylic acid ester compound is not particularly limited, and it is preferably an alkylene oxide polymerized chain and more preferably a polymerized chain consisting of an alkylene oxide having 2 to 4 carbon atoms. The degree of polymerization of the polymerized chain is not particularly limited and is appropriately set. An alkyl group or an aryl group is generally bonded to the end part of the polymerized chain.

The other polymerizable compounds (M2) are not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include “vinyl-based monomers” described in JP2015-88486A.

The (meth)acrylic compound (M1) and the other polymerizable compounds (M2) may have a substituent. The substituent is not particularly limited, and examples thereof preferably include groups selected from the substituent Z described later.

A content of the constitutional component in the (meth)acrylic polymer is not particularly limited, and can be appropriately selected, for example, set to the following range. A content of the constitutional component derived from the (meth)acrylic compound (M1) in all constitutional components constituting the (meth)acrylic polymer is not particularly limited and is appropriately set in a range of 0% to 100% by mass. The upper limit thereof can be, for example, 95% by mass. Here, in a case where the constitutional component having a substituent having 8 or more carbon atoms and the constitutional component having a functional group are a constitutional component derived from the (meth)acrylic compound (M1), the contents of the constitutional components are included for calculation in the content of the constitutional component derived from the (meth)acrylic compound (M1).

Each of the content of the above-described constitutional component having a substituent having 8 or more carbon atoms and the contents of the above-described constitutional component having a functional group and the other constitutional components in all constitutional components constituting the (meth)acrylic polymer is as described above.

A content of the other polymerizable compounds (M2) in all constitutional components constituting the (meth)acrylic polymer is not particularly limited, but can be, for example, less than 50% by mass, preferably 1% to 30% by mass, more preferably 1% to 25% by mass, and still more preferably 3% to 25% by mass.

The (meth)acrylic compound (M1) and the other polymerizable compounds (M2), from which the constitutional components of the (meth)acrylic polymer and the vinyl polymer are derived, are preferably a compound represented by Formula (b-1). It is preferable that the compound is different from the compound from which the constitutional component having a substituent having 8 or more carbon atoms is derived or the compound from which the constitutional component having the above-described functional group is derived.

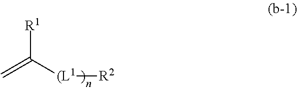

In the formula, R¹ represents a hydrogen atom, a hydroxy group, a cyano group, a halogen atom, an alkyl group (preferably having 1 to 24 carbon atoms, more preferably having 1 to 12 carbon atoms, and particularly preferably having 1 to 6 carbon atoms), an alkenyl group (preferably having 2 to 24 carbon atoms, more preferably having 2 to 12 carbon atoms, and particularly preferably having 2 to 6 carbon atoms), an alkynyl group (preferably having 2 to 24 carbon atoms, more preferably having 2 to 12 carbon atoms, and particularly preferably having 2 to 6 carbon atoms), or an aryl group (preferably having 6 to 22 carbon atoms and more preferably having 6 to 14 carbon atoms). Among these, a hydrogen atom or an alkyl group is preferable, and a hydrogen atom or a methyl group is more preferable.

R² represents a hydrogen atom or a substituent. The substituent which can be adopted as R² is not particularly limited, and examples thereof include an alkyl group (which may be a branched chain, but preferably a linear chain), an alkenyl group (preferably having 2 to 12 carbon atoms, more preferably having 2 to 6 carbon atoms, and particularly preferably having 2 or 3 carbon atoms), an aryl group (preferably having 6 to 22 carbon atoms and more preferably having 6 to 14 carbon atoms), an aralkyl group (preferably having 7 to 23 carbon atoms and more preferably having 7 to 15 carbon atoms), and a cyano group.

The number of carbon atoms in the alkyl group has the same meaning as the number of carbon atoms of the alkyl group constituting the (meth)acrylic acid alkyl ester compound described above, and a long-chain alkyl ester having 8 or more carbon atoms or an alkyl ester having 7 or less carbon atoms is preferable.

L¹ is a linking group and is not particularly limited, and examples thereof include a linking group in the above-described constitutional component having a substituent having 8 or more carbon atoms. A —CO—O— group or a —CO—N(R^{N})— group (R^{N} is as described above) is preferable. The above-described linking group may have any substituent. The number of atoms constituting the linking group and the number of linking atoms are as described above. Examples of any substituent include the substituents Z described later, and examples thereof include an alkyl group and a halogen atom.

n is 0 or 1, preferably 1. However, in a case where-(L¹)ₙ-R² represents one kind of substituent (for example, an alkyl group), n is 0 and R² is a substituent (an alkyl group).

In Formula (b-1), the carbon atom which forms a polymerizable group and to which R¹ is not bonded is represented as an unsubstituted carbon atom (H₂C═), but it may have a substituent. The substituent is not particularly limited, and examples thereof include the above-described groups which can be adopted as R¹.

In addition, the group which may adopt a substituent such as an alkyl group, an aryl group, an alkylene group, and an arylene group may have a substituent within a range in which the effect of the present invention is not impaired. The substituent is not particularly limited and examples thereof include a group selected from the substituents Z described later, and specific examples thereof include a halogen atom.

Preferred examples of the above-described (meth)acrylic compound (M1) include a compound represented by Formula (b-2) or (b-3). It is preferable that the compound is different from the compound from which the constitutional component having a substituent having 8 or more carbon atoms is derived or the compound from which the constitutional component having the above-described functional group is derived.

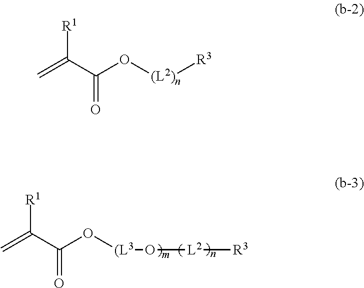

R¹ and n have the same meanings as those in Formula (b-1).

R³ has the same meaning as R².

L² is a linking group, and the description for L¹ above can be preferably applied thereto.

L³ is a linking group and the description for L¹ above can be preferably applied thereto, and it is preferably an alkylene group having 1 to 6 carbon atoms (preferably having 1 to 3 carbon atoms).

m is an integer of 1 to 200, preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C=), but it may have a substituent. The substituent is not particularly limited, and examples thereof include the above-described groups which can be adopted as R¹.

In addition, in Formulae (b-1) to (b-3), the group which may adopt a substituent such as an alkyl group, an aryl group, an alkylene group, and an arylene group may have a substituent within a range in which the effect of the present invention is not impaired. It is sufficient that the substituent is a substituent other than the functional group selected from the group (a) of functional groups; and examples thereof include a group selected from the substituents Z described later, and specific examples thereof include a halogen atom.

The chain-polymerization polymer (each constitutional component and raw material compound) may have a substituent. The substituent is not particularly limited, and preferred examples thereof include a group selected from the substituents Z described later. However, a group other than functional groups included in the group (a) of functional groups is preferable.

### —Substituent Z—

Examples of the substitutent Z include an alkyl group (preferably an alkyl group having 1 to 20 carbon atoms; for example, methyl, ethyl, isopropyl, tert-butyl, pentyl, heptyl, 1-ethylpentyl, benzyl, 2-ethoxyethyl, 1-carboxymethyl, and the like); an alkenyl group (preferably an alkenyl group having 2 to 20 carbon atoms; for example, vinyl, allyl, oleyl, and the like); an alkynyl group (preferably an alkynyl group having 2 to 20 carbon atoms, for example, ethynyl, adynyl, phenylethynyl, and the like); a cycloalkyl group (preferably a cycloalkyl group having 3 to 20 carbon atoms; for example, cyclopropyl, cyclopentyl, cyclohexyl, 4-methylcyclohexyl, and the like; in the present invention, the alkyl group generally has a meaning including a cycloalkyl group in a case of being referred to, however, it will be described separately here); an aryl group (preferably an aryl group having 6 to 26 carbon atoms; for example, phenyl, 1-naphthyl, 4-methoxyphenyl, 2-chlorophenyl, 3-methylphenyl, and the like); an aralkyl group (preferably an aralkyl group having 7 to 23 carbon atoms; for example, benzyl, phenethyl, and the like); a heterocyclic group (preferably a heterocyclic group having 2 to 20 carbon atoms and more preferably a 5- or 6-membered heterocyclic group having at least one oxygen atom, one sulfur atom, or one nitrogen atom; the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, 2-oxazolyl, a pyrrolidone group, and the like); an alkoxy group (preferably an alkoxy group having 1 to 20 carbon atoms; for example, methoxy, ethoxy, isopropyloxy, benzyloxy, and the like); an aryloxy group (preferably an aryloxy group having 6 to 26 carbon atoms; for example, phenoxy, 1-naphthyloxy, 3-methylphenoxy, 4-methoxyphenoxy, and the like); a heterocyclic oxy group (a group in which an —O— group is bonded to the heterocyclic group); an alkoxycarbonyl group (preferably an alkoxycarbonyl group having 2 to 20 carbon atoms; for example, ethoxycarbonyl, 2-ethylhexyloxycarbonyl, dodecyloxycarbonyl, and the like); an aryloxycarbonyl group (preferably an aryloxycarbonyl group having 7 to 26 carbon atoms; for example, phenoxycarbonyl, 1-naphthyloxycarbonyl, 3-methylphenoxycarbonyl, 4-methoxyphenoxycarbonyl, and the like); a heterocyclic oxycarbonyl group (a group in which an —O—CO— group is bonded to the heterocyclic group); an amino group (preferably an amino group having 0 to 20 carbon atoms; including an alkylamino group and an arylamino group; for example, amino (—NH₂), N,N-dimethylamino, N,N-diethylamino, N-ethylamino, anilino, and the like); a sulfamoyl group (preferably a sulfamoyl group having 0 to 20 carbon atoms; for example, N,N-dimethylsulfamoyl, N-phenylsulfamoyl, and the like); an acyl group (including an alkylcarbonyl group, an alkenylcarbonyl group, an alkynylcarbonyl group, an arylcarbonyl group, and a heterocyclic carbonyl group; preferably an acyl group having 1 to 20 carbon atoms; for example, acetyl, propionyl, butyryl, octanoyl, hexadecanoyl, acryloyl, methacryloyl, crotonoyl, benzoyl, naphthoyl, nicotinoyl, and the like); an acyloxy group (including an alkylcarbonyloxy group, an alkenylcarbonyloxy group, an alkynylcarbonyloxy group, and a heterocyclic carbonyloxy group; preferably an acyloxy group having 1 to 20 carbon atoms; for example, acetyloxy, propionyloxy, butyryloxy, octanoyloxy, hexadecanoyloxy, acryloyloxy, methacryloyloxy, crotonyloxy, nicotinoyloxy, and the like); an aryloyloxy group (preferably an aryloyloxy group having 7 to 23 carbon atoms; for example, benzoyloxy, naphthoyloxy, and the like);

a carbamoyl group (preferably a carbamoyl group having 1 to 20 carbon atoms; for example, N,N-dimethylcarbamoyl, N-phenylcarbamoyl, and the like); an acylamino groups (preferably an acylamino group having 1 to 20 carbon atoms; for example, acetylamino, benzoylamino, and the like); an alkylthio group (preferably an alkylthio group having 1 to 20 carbon atoms; for example, methylthio, ethylthio, isopropylthio, benzylthio, and the like); an arylthio group (preferably an arylthio group having 6 to 26 carbon atoms; for example, phenylthio, 1-naphthylthio, 3-methylphenylthio, 4-methoxyphenylthio, and the like); a heterocyclic thio groups (a group in which an —S— group is bonded to the heterocyclic group); an alkylsulfonyl group (preferably an alkylsulfonyl group having 1 to 20 carbon atoms; for example, methyl sulfonyl, ethyl sulfonyl, and the like); an arylsulfonyl group (preferably an arylsulfonyl group having 6 to 22 carbon atoms; for example, benzenesulfonyl and the like); an alkylsilyl group (preferably an alkylsilyl group having 1 to 20 carbon atoms; for example, monomethylsilyl, dimethylsilyl, trimethylsilyl, triethylsilyl, and the like); an arylsilyl group (preferably an arylsilyl group having 6 to 42 carbon atoms; for example, triphenylsilyl and the like); an alkoxysilyl group (preferably an alkoxysilyl group having 1 to 20 carbon atoms; for example, monomethoxysilyl, dimethoxysilyl, trimethoxysilyl, triethoxysilyl, and the like); an aryloxysilyl groups (preferably an aryloxysilyl group having 6 to 42 carbon atoms; for example, triphenyloxysilyl and the like); a phosphoryl group (preferably a phosphate group having 0 to 20 carbon atoms; for example, —OP(═O)(RP)₂); a phosphonyl group (preferably a phosphonyl group having 0 to 20 carbon atoms; for example, —P(═O)(RP)₂), a phosphinyl group (preferably a phosphinyl group having 0 to 20 carbon atoms; for example, —P(RP)₂), a phosphonic acid group (preferably a phosphonic acid group having 0 to 20 carbon atoms; for example, —PO(ORP)₂); a sulfo group (sulfonic acid group), a carboxy group, a hydroxy group, a sulfanyl group, a cyano group, and a halogen atom (for example, a fluorine atom, a chlorine atom, a bromine atom, an iodine atom, and the like). RP is a hydrogen atom or a substituent (preferably, a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like described above may be cyclic or chain-like, and may be linear or branched.

The chain-polymerization polymer can be synthesized by selecting a raw material compound and polymerizing the raw material compound according to a known method.

A method of incorporating the functional group is not particularly limited, and examples thereof include a method of copolymerizing with a compound having a functional group selected from the group (a) of functional groups, a method of using a polymerization initiator or a chain transfer agent, having (generating) the functional group, a method of using a polymeric reaction, an ene reaction or thiol-ene reaction with a double bond, and an atom transfer radical polymerization (ATRP) method using a copper catalyst. In addition, the functional group can be introduced by using a functional group which is present in the main chain, the side chain, or the terminal of the polymer, as a reaction point. For example, a functional group selected from the group (a) of functional groups can be introduced by various reactions with a carboxylic acid anhydride group in a polymerized chain using the compound having a functional group.

### (Polymer A According to Preferred Second Aspect)

Examples of the polymer A preferably used in the present invention (which is sometimes referred to as a polymer A according to a preferred second aspect) include a polymer having a constitutional component (X) which includes a polymerized chain and has a molecular weight of 400 or more. The polymer exhibits a moderate adsorption rate to the active material AC and the inorganic solid electrolyte SE, and contributes to the improvement of the dispersibility.

It is preferable that the polymer A according to the preferred second aspect does not contain the constitutional component having a substituent having 8 or more carbon atoms as a side chain in the polymer A of the preferred first aspect (the content in the polymer A is 1% by mass or less).

### —Constitutional Component (X)—

The constitutional component (X) of polymer A according to the preferred second aspect is a constitutional component including a polymerized chain, and is a constitutional component having a molecular weight of 400 or more. In the present invention, in a case where a constitutional component having a molecular weight of 400 or more includes a polymerized chain and has a polar functional group included in a group (a1) of functional groups, which is defined by the constitutional component (A) described later, the constitutional component is regarded as the constitutional component (X). The constitutional component (X) is preferably a constitutional component having no polar functional group, and one of preferred aspects is, for example, that the constitutional component has no polar functional group in a partial structure other than the polymerized chain. By having the constitutional component (X), the polymer A according to the preferred second aspect can increase an excluded volume effect between the polymers A according to the preferred second aspect, and can achieve excellent dispersibility even in a case where the dispersibility of the solid particles is improved and the dispersion time is shortened.

In the constitutional component (X), the polymerized chain may be included in a partial structure which is a main chain of the polymer A, but is preferably included in a molecular chain which is a side chain of the polymer A, and for example, more preferably incorporated into the inside or the terminal of the molecular chain which is a side chain of the polymer A. Such a constitutional component (X) can incorporate a graft structure into the chemical structure of the polymer A, and can increase the above-described excluded volume effect.

In the present invention, the molecular chain which is a side chain of the polymer A refers to a molecular chain constituting the side chain of the polymer A in which the constitutional component (X) is incorporated, and is a molecular chain other than a molecular chain constituting the main chain of the polymer A, usually a molecular chain bonded to the molecular chain (atomic group) constituting the main chain.

The type of the polymerized chain included in one constitutional component (X) may be at least one type, and is preferably one type or two types. In addition, the number of polymerized chains included in one constitutional component (X) is not particularly limited, but is usually 1.

Examples of the constitutional component (X) include a constitutional component derived from a polycondensable compound having a polycondensable group and a polymerized chain. The polycondensable group is appropriately determined depending on the main chain structure of the polymer A. For example, in a case where the polymer Ais a step-polymerization polymer, a condensable functional group is selected, and in a case where the polymer A is a chain-polymerization polymer, a polymerizable group (ethylenically unsaturated group) is selected. In a case where the polymer A is a multibranched polymer having a core portion described later, in addition to the above, examples of the polycondensable group include a reactive group for a sulfanyl group, such as an ethylenically unsaturated group capable of a thiol-ene reaction or a radical polymerization, a carboxyl group capable of a condensation reaction, and a halogenated alkyl group capable of thio-etherification. Examples of the ethylenically unsaturated group include a vinyl group.

Here, examples of the step-polymerization polymer include polymers obtained by polycondensation, polyaddition, or addition condensation of raw material compounds; and examples thereof include polyurethane, polyurea, polyamide, polyimide, polyester, polyether, polycarbonate, polysiloxane, and copolymers thereof. Examples of the chain-polymerization polymer include polymers having a polymerized chain of carbon-carbon double bonds as a main chain; and examples thereof include a hydrocarbon polymer, a vinyl polymer, a (meth)acrylic polymer, and copolymers thereof, where a (meth)acrylic polymer is preferable. Here, examples of the (meth)acrylic polymer include a polymer consisting of a (co)polymer containing 50% by mass or more of a constitutional component derived from a (meth)acrylic compound (M1A) described later. Examples of the vinyl polymer include a polymer consisting of a copolymer containing 50% by mass or more of a constitutional component derived from a vinyl-based compound (M2A) described later (where a content of a constitutional component derived from the (meth)acrylic compound (M1A) is less than 50% by mass). The polymerized chain of carbon-carbon double bonds is as described above.

The polymerized chain is a molecular chain in which two or more repeating units of one or two or more kinds are bonded. Such a polymerized chain is not particularly limited, and a chain consisting of a general polymer, for example, the above-described step-polymerization polymer or chain-polymerization polymer can be applied thereto without particular limitation. In the present invention, a polymerized chain having a repeating unit represented by Formula (L_{P}) is preferable; a polymerized chain consisting of polyester, a polymerized chain consisting of polyether, a polymerized chain consisting of polysiloxane, or a polymerized chain consisting of a (meth)acrylic polymer is more preferable; and a polymerized chain consisting of polysiloxane is still more preferable.

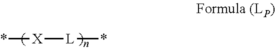

In Formula (L_{P}), X represents a divalent substituent, L represents a single bond or a linking group, and n represents an (average) degree of polymerization.

The substituent which can be adopted as X is not particularly limited, and examples thereof include a group obtained by further removing one hydrogen atom from a group appropriately selected from the substituent Z or the like described later, and it preferably represents a hydrocarbon group or an alkylsilylene group from the viewpoint of dispersibility. The hydrocarbon group which can be adopted as X is not particularly limited, and examples thereof include an alkylene group, an alkenyl group, and an arylene group, where an alkylene group is preferable. Examples of the alkylene group and the like, which can be adopted as X, include a group obtained by further removing one hydrogen atom from each of the corresponding groups of the substituent Z described later. However, the number of carbon atoms in the alkylene group is more preferably 1 to 8. In a case where the repeating unit represented by Formula (L_{P}) is an alkyleneoxy group, the number of carbon atoms in the alkylene group is still more preferably 1 to 6. The alkylsilylene group which can be adopted as X is not particularly limited, and examples thereof include a —Si(R^{s}₂)— group in a polymerized chain consisting of polysiloxane described later. The X may have a substituent.

L is selected depending on the kind of polymerized chain. For example, in a case of a chain consisting of a chain-polymerization polymer, a single bond is adopted, and in a case of a chain consisting of a step-polymerization polymer, a linking group is adopted. The linking group which can be adopted as L is not particularly limited as long as it is a group which can be bonded to another repeating unit, and it is appropriately selected depending on the kind of the polymerized chain. The linking group is generally a linking group having a heteroatom, and examples thereof include an ester bond (—CO—O—), an ether bond (—O—), a carbonate bond (—O—CO—), an amide bond (—CO—N(R^{N})—), a urethane bond (—N(R^{N})—CO—), a urea bond (—N(R^{N})—CO—N(R^{N})—), and an imide bond (—CO—N(R^{N})—CO—). In each of the above-described bonds, R^{N} represents a hydrogen atom, an alkyl group having 1 to 6 carbon atoms, or an aryl group having 6 to 10 carbon atoms. Any bonding portion of the above-described linking group may be bonded to X described above. The linking group is more preferably an ester bond, an ether bond, a carbonate bond, or the like.

n represents an (average) degree of polymerization and may be 2 or more, and it is appropriately determined in consideration of the number-average molecular weight of the polymerized chain described later. For example, the degree of polymerization n is as described later.

Two or more repeating units included in the polymerized chain may be the same or different from each other. In a case where two or more repeating units are different from each other, a bonding mode thereof is not particularly limited and may be a random type, an alternating type, or a block type.

Examples of the polymerized chain having the repeating unit represented by Formula (L_{P}) include a chain consisting of a chain-polymerization polymer, and a polymer chain consisting of a step-polymerization polymer; and more specific examples thereof include a polymerized chain consisting of a (meth)acrylic polymer, a polymerized chain consisting of polystyrene, a polymerized chain consisting of polyether, a polymerized chain consisting of polyester, a polymerized chain consisting of polycarbonate, and a polymerized chain consisting of polysiloxane. From the viewpoint of shortening the dispersion time and improving the dispersibility, a polymerized chain consisting of polysiloxane is more preferable.

The group bonded to the terminal of the above-described polymerized chain is not particularly limited, and an appropriate group can be adopted according to a polymerization method or the like. Examples thereof include a hydrogen atom, an alkyl group, an aryl group, and a hydroxy group, and examples thereof also include a substituent which can be adopted as R^{16A} in Formula 4 described later. Preferred examples of the group bonded to the terminal of the polymerized chain include an alkyl group (preferably having 1 to 20 carbon atoms, more preferably 4 to 20 carbon atoms, and still more preferably 4 to 12 carbon atoms) from the viewpoint of dispersibility. The group may further have a substituent, but it is preferably unsubstituted.

Examples of the polymerized chain consisting of polyether include a polyalkyleneoxy chain and a polyaryleneoxy chain. Examples of the alkylene group and the arylene group include a group obtained by further removing one hydrogen atom from an alkyl group or aryl group appropriately selected from the substituent Z described later, and preferred examples thereof include an alkylene group and an arylene group, which can be adopted as X described above.

The polymerized chain consisting of polysiloxane is preferably a polymerized chain having a structure represented by —(Si(R^{s}₂)—O)ₙₛ—. R^{S} represents a hydrogen atom or a substituent, and it is preferably a substituent. The substituent is not particularly limited; and examples thereof include substituents selected from the substituent Z described later, for example, a hydroxy group, an alkyl group (preferably having 1 to 12 carbon atoms, more preferably 1 to 6 carbon atoms, and particularly preferably 1 to 3 carbon atoms), an alkenyl group (preferably having 2 to 12 carbon atoms, more preferably 2 to 6 carbon atoms, and particularly preferably 2 or 3 carbon atoms), an alkoxy group (preferably having 1 to 24 carbon atoms, more preferably 1 to 12 carbon atoms, still more preferably 1 to 6 carbon atoms, and particularly preferably 1 to 3 carbon atoms), an aryl group (preferably having 6 to 22 carbon atoms, more preferably 6 to 14 carbon atoms, and particularly preferably 6 to 10 carbon atoms), an aryloxy group (preferably having 6 to 22 carbon atoms, more preferably 6 to 14 carbon atoms, and particularly preferably 6 to 10 carbon atoms), an aralkyl group (preferably having 7 to 23 carbon atoms, more preferably 7 to 15 carbon atoms, and particularly preferably 7 to 11 carbon atoms), and a group represented by Formula Z described later. Among these, an alkyl group having 1 to 3 carbon atoms, a phenyl group, or a group represented by Formula Z described later is more preferable, and an alkyl group having 1 to 3 carbon atoms is still more preferable. ns represents a polymerization degree (average repetition number) of the siloxane structure, and is appropriately determined in consideration of the number-average molecular weight of the polymerized chain described later and the molecular weight of the constitutional component (X), and is preferably as described later. The polysiloxane structure has a terminal group bonded to a terminal thereof. The terminal group is not particularly limited, and examples thereof include a hydrogen atom and a substituent. The substituent which can be adopted as the terminal group is as described above, and examples thereof include the substituent which can be adopted as R^{S}.

The polysiloxane structure is preferably a polysiloxane structure included in a chemical structure represented by Formula 4A.

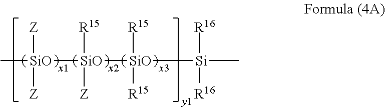

In Formula 4A, R¹⁵ and R¹⁶ represent an alkyl group or an aryl group, and Z represents a group represented by Formula (Z) described later. R¹⁵, R¹⁶, and Z in Formula 4A are the same as R¹⁵, R¹⁶, and Z in Formula 4 described later, respectively.

In Formula 4A, x1, x2, and x3 are integers of 0 or more, and y1 is an integer of 1 to 30. x1, x2, x3, and y1 in Formula 4A are the same as x1, x2, x3, and y1 in Formula 4 described later, respectively.

Examples of the polymerized chain consisting of polyester include a chain consisting of known polyester. Examples thereof include a polyester polymerized chain obtained by a reaction of a polyol such as an alkylene glycol with a polybasic acid such as an aromatic dicarboxylic acid or an aliphatic dicarboxylic acid; and a polyester polymerized chain obtained by ring-open polymerization of a cyclic ester compound such as a caprolactone monomer.

Preferred examples of the chain consisting of a chain-polymerization polymer include a polymerized chain consisting of a (meth)acrylic polymer and a polymerized chain consisting of polystyrene.

As the polymerized chain consisting of a (meth)acrylic polymer, it is preferable to have a constitutional component derived from a (meth)acrylic compound (MIA) such as a (meth)acrylic acid compound, a (meth)acrylic acid ester compound, a (meth)acrylamide compound, and a (meth)acrylonitrile compound, which will be described later; and a constitutional component derived from a vinyl-based compound (M2A), which will be described later. Among these, a polymerized chain having a constitutional component derived from one or two or more (meth)acrylic acid ester compounds is more preferable, and a polymerized chain having a constitutional component derived from a (meth)acrylic acid alkyl ester compound is still more preferable. The (meth)acrylic acid alkyl ester compound preferably includes an ester compound of a long-chain alkyl group having 4 or more carbon atoms (preferably 6 or more carbon atoms), and can further include an ester compound of a short-chain alkyl group having 3 or less carbon atoms. A content of each constitutional component in the polymerized chain is not particularly limited and is appropriately set. For example, a content of the constitutional component derived from the (meth)acrylic compound (M1A) in the polymerized chain is 30% to 100% by mass, and it can also be set to 50% to 80% by mass. A content of the constitutional component derived from a (meth)acrylic acid alkyl ester compound is preferably 50% to 100% by mass, and it can also be set to 60% to 80% by mass. In addition, in a case where a constitutional component derived from a (meth)acrylic acid long-chain alkyl ester compound and a constitutional component derived from a (meth)acrylic acid short-chain alkyl ester compound are included, a content of the constitutional component derived from a (meth)acrylic acid long-chain alkyl ester compound is preferably 20% to 100% by mass and more preferably 50% to 100% by mass, and a content of the constitutional component derived from a (meth)acrylic acid short-chain alkyl ester compound is preferably 5% to 80% by mass and more preferably 5% to 40% by mass.

It is preferable that the above-described polymerized chain is bonded to the above-described polycondensable group directly or through a linking group.

Such a linking group L^{A1} is not particularly limited, and examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—; R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group of a combination thereof. However, the linking group L^{A}i is preferably a group which does not correspond to each polar functional group defined by the constitutional component (A) described later.

The linking group L^{A1} is preferably a group formed by a combination of an alkylene group, an arylene group, a carbonyl group, an oxygen atom, a sulfur atom, and an imino group, more preferably a group formed by a combination of an alkylene group, an arylene group, a carbonyl group, an oxygen atom, a sulfur atom, and an imino group, and still more preferably a group including a —CO—O— group; and examples thereof include a —CO—O— group and a —CO—O-alkylene group.

Preferred examples of the linking group L^{A1} include a linking group including a structural part derived from a chain transfer agent (for example, 3-mercaptopropionic acid), a polymerization initiator, or the like, which is used in the synthesis of the above-described polymerized chain; and a linking group obtained by bonding the structural part to a structural part derived from the (meth)acrylic compound (M1A) which reacts with the chain transfer agent.

The number of atoms constituting the above-described linking group L^{A1} is preferably 1 to 36, more preferably 1 to 24, and still more preferably 1 to 12. The number of linking atoms of the linking group L^{A1} is preferably 12 or less, more preferably 10 or less, and particularly preferably 8 or less. The lower limit thereof is 1 or more. The above-described number of linking atoms refers to the minimum number of atoms linking predetermined structural moieties. For example, in a case of —O—C(═O)—CH₂—CH₂—, the number of atoms constituting the linking group is 9 and the number of linking atoms is 4.

The constitutional component (X) is preferably a constitutional component derived from a compound having a polymerized chain consisting of polyester, a polymerized chain consisting of polysiloxane, or a polymerized chain consisting of a (meth)acrylic polymer, which has an ethylenically unsaturated group as a polycondensable group and includes —C(═O)—O— as a linking group; and more preferably a constitutional component having a polymerized chain consisting of polysiloxane, which is represented by Formula 4.

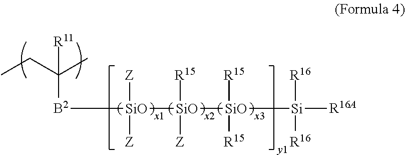

In Formula 4, R¹¹ represents a hydrogen atom or methyl.

B² represents a linking group. The linking group which can be adopted as B² is not particularly limited, and examples thereof include the linking groups which can be adopted as the linking group L^{A1} described above. The linking group as B² is preferably an alkylene group, an alkenylene group, an arylene group, an oxygen atom, a sulfur atom, a carbonyl group, or a group of a combination thereof, more preferably a group including a —CO—O— group, and particularly preferably a —CO—O— group or a —CO—O-alkylene group.

R¹⁵ represents an alkyl group or an aryl group, preferably an alkyl group. The alkyl group and the aryl group, which can be adopted as R¹⁵, have the same definitions and the same preferred ranges as those of the alkyl group and the aryl group which can be adopted as R^{S} in the above-described polysiloxane structure, respectively. Here, R¹⁵ particularly preferably represents methyl. Two R¹⁵'s bonded to the same silicon atom may be the same or different from each other, and preferably represent methyl.

R¹⁶ represents an alkyl group or an aryl group, preferably an alkyl group. Two R¹⁶'s bonded to the same silicon atom may be the same or different from each other. The alkyl group and the aryl group, which can be adopted as R¹⁶, have the same definitions and the same preferred ranges as those of the alkyl group and the aryl group which can be adopted as R^{S} in the above-described polysiloxane structure, respectively. Here, R¹⁶ particularly preferably represents methyl.

R^{16A} represents a hydrogen atom or a substituent. The substituent which can be adopted as R^{16A} is not particularly limited, and examples thereof include the substituent Z described later; and a substituent which can be adopted as R^{S} described above is preferable. Here, the substituent which can be adopted as R^{16A} is more preferably an alkyl group, an alkenyl group, an aralkyl group, an aryl group, an alkoxy group, or an aryloxy group, and still more preferably an alkyl group or the like.

Z represents a group represented by Formula (Z).

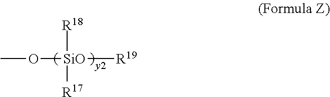

In Formula (Z), R¹⁷ and R⁸ each represent an alkyl group or an aryl group. The alkyl group and the aryl group, which can be adopted as R¹⁷ and R¹⁸, have the same definitions and the same preferred ranges as those of the alkyl group and the aryl group which can be adopted as R^{S} in the above-described polysiloxane structure, respectively. R¹⁷ and R¹⁸ may be the same or different from each other. R¹⁹ represents an unsubstituted alkyl group having 1 to 4 carbon atoms. y2 represents an integer of 1 to 100, preferably an integer of 1 to 50 and more preferably an integer of 1 to 20.

In the constitutional component represented by Formula 4, x1, x2, x3, y1, and y2 are appropriately determined in consideration of the number-average molecular weight of the polymerized chain described later and the molecular weight of the constitutional component (X), the total (polymerization degree) of x1, x2, x3, y1, and y2 is as described later, and it is preferable that a value of (x1+x2+x3)×y1 is the same as the polymerization degree described later.

For example, in Formula 4, x1, x2, and x3 each represent an integer of 0 or more.
x1 is preferably an integer of 0 to 50 and more preferably an integer of 0 to 20.
x2 is preferably an integer of 0 to 50 and more preferably an integer of 0 to 20.
x3 is preferably an integer of 1 to 100 and more preferably an integer of 1 to 30.

The sum of x1, x2, and x3 is an integer of 1 to 100, preferably an integer of 2 to 70 and more preferably an integer of 2 to 50.

In a case where x1 and x3 each represent an integer of 2 or more, two Z's or R¹⁵'s bonded to the same silicon atom in Formula 4 may be the same or different from each other.
y1 represents an integer of 1 to 30, preferably an integer of 1 to 20 and more preferably an integer of 1 to 10.
x1, x2, x3, y1, and y2 are preferably x1=x2=y2=0, x3=integer of 1 to 100, and y1=integer of 1 to 30.

The constitutional component (X) is not particularly limited, but is preferably a constitutional component derived from a compound in which the polymerized chain is introduced (substituted) into the following polycondensable compound.

The polycondensable compound is not particularly limited as long as it is a polycondensable compound having an ethylenically unsaturated bond, and examples thereof include (meth)acrylic compounds (M1A) such as a (meth)acrylic acid compound, a (meth)acrylic acid ester compound, a (meth)acrylamide compound, and a (meth)acrylonitrile compound; vinyl compounds (M2A) including vinyl aromatic compounds such as a styrene compound, a vinyl naphthalene compound, and a vinyl carbazole compound, allyl compounds, vinyl ether compounds, vinyl ester compounds, cyclic olefin compounds, diene compounds, and vinyl carboxylic acid ester compounds; and compounds such as a dialkyl itaconate compound and an unsaturated carboxylic acid anhydride. Among these, a styrene compound, a (meth)acrylic acid compound, a (meth)acrylic acid ester compound, or a (meth)acrylamide compound is preferable.

Examples of the (meth)acrylic acid ester compound include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, but it can be set to, for example, 1 to 24, preferably 1 to 12, more preferably 1 to 6, and still more preferably 1 to 4. The number of carbon atoms in the aryl group constituting the aryl ester is not particularly limited, but it can be set to, for example, 6 to 24, preferably 6 to 10 and more preferably 6.

In the present invention, the polymerized chain of the constitutional component (X) may include a polar functional group included in the group (a1) of functional groups described later as a linking group, for example, the linking group L of Formula (L_{P}); but this polar functional group functions as the linking group and is not the polar functional group selected from the group (a1) of functional groups. In addition, in a case where the constitutional component (X) is derived from a compound having the above-described polycondensable group and the above-described polymerized chain, even in a case where the constitutional component (X) has a polar functional group included in the group (a1) of functional groups described later in the above-described linking group L^{A1} which links the above-described polycondensable group and the above-described polymerized chain, the polar functional group does not sufficiently exhibit an adsorption or adhesion function to the solid particles, and thus it is included in an aspect in which the constitutional component (X) does not have a polar functional group (constitutional component which does not correspond to the constitutional component (A)).

Specific examples of the constitutional component (X) include the following examples, but the present invention is not limited thereto. In the specific examples, R^{Y} and R^{Z} represent a linking group or a substituent. In the following specific examples, although the degree of polymerization of the repeating unit is specifically indicated, it can be appropriately changed in the present invention. In addition, specific examples of the constitutional component (X) represented by Formula 4 include a terminal (meth)acrylic-modified silicone compound, specifically, those shown in each polymer synthesized in Examples described later, but the present invention is not limited thereto.

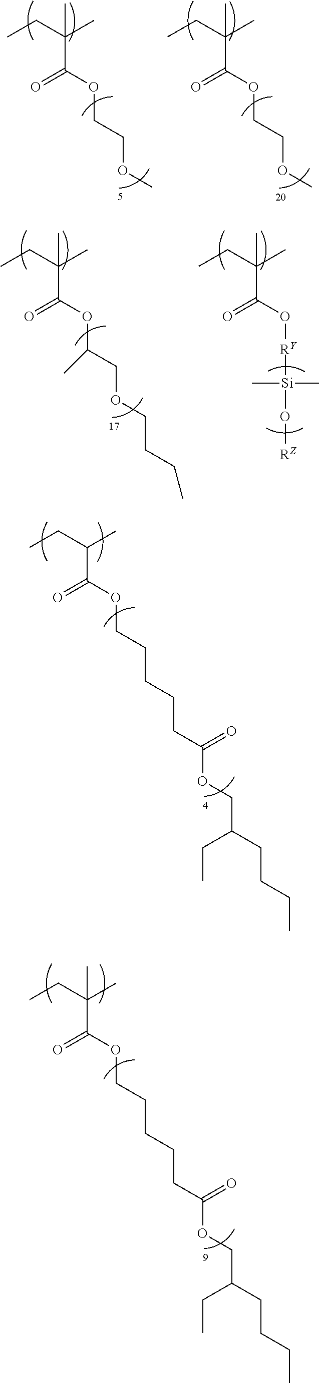

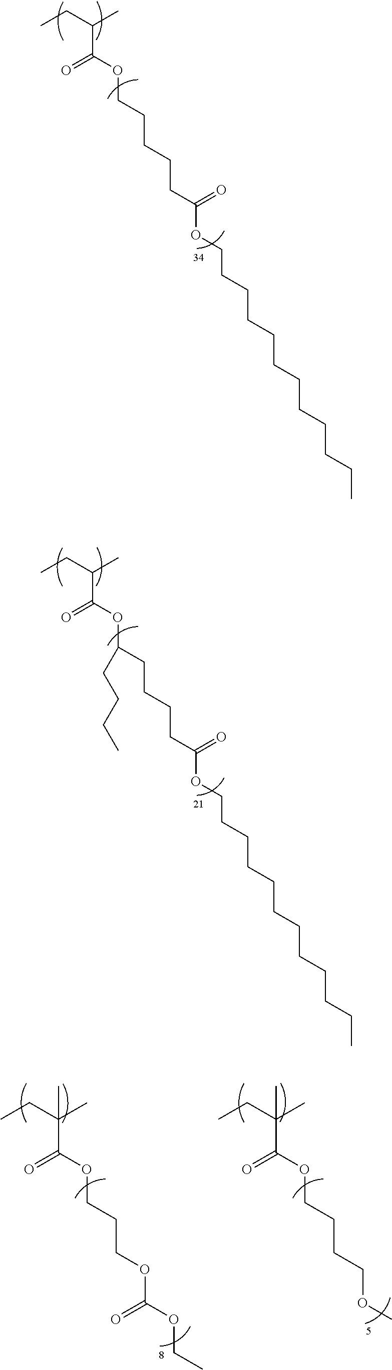

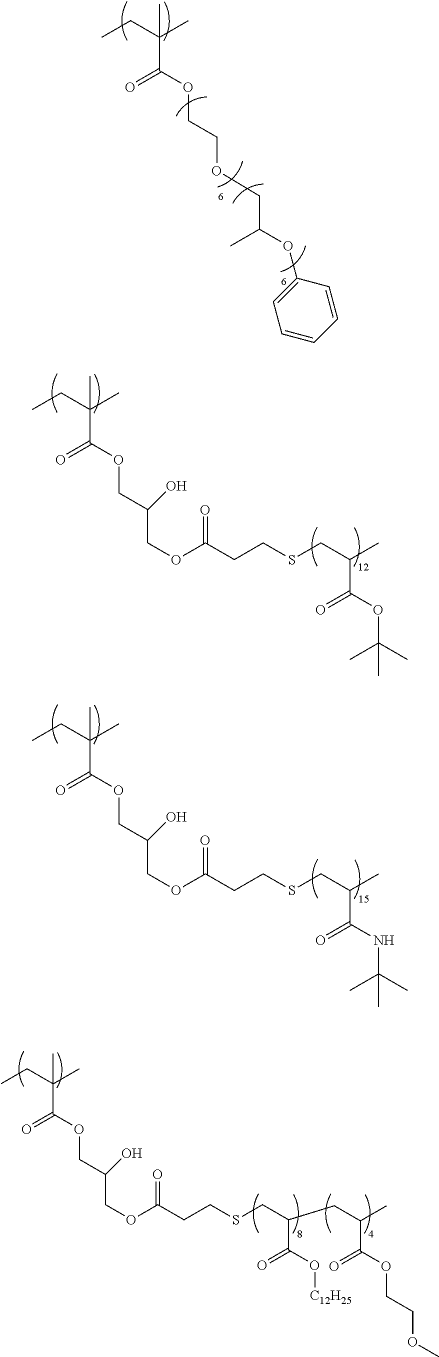

As the constitutional component (X), a degree of polymerization of repeating units may be 2 or more, and the constitutional component (X) is a constitutional component which is derived from a macromonomer having a polymerized chain and has a molecular weight of 400 or more. In a case where the constitutional component (X) includes a polymerized chain and has a molecular weight of 400 or more, the dispersibility of the solid particles is improved, and the dispersion time can be shortened and the dispersibility can be improved.

The molecular weight of the constitutional component (X) is appropriately determined in consideration of the molecular weight of the polymer A according to the preferred second aspect, the content of the constitutional component (X), and the like; and is, for example, preferably 600 or more, more preferably 800 or more, still more preferably 2,000 or more, and particularly preferably 3,000 or more from the viewpoint of being able to achieve both the shortening of the dispersion time and the improvement of the dispersibility. The upper limit thereof is not particularly limited, but is preferably 200,000 or less, more preferably 50,000 or less, still more preferably 20,000 or less, particularly preferably 7,000 or less, and most preferably 5,000 or less from the viewpoint of being able to achieve both the shortening of the dispersion time and the improvement of the dispersibility.

In the present invention, the molecular weight of the constitutional component (X) means a total molecular weight of the number-average molecular weight of the polymerized chain and the molecular weight of the other partial structure. The number-average molecular weight of the polymerized chain can be measured as a standard polystyrene-equivalent number-average molecular weight in the same manner as the weight-average molecular weight of the polymer A according to the preferred second aspect.

The number-average molecular weight of the polymerized chain and the degree of polymerization of the total structural unit forming the polymerized chain are not particularly limited, and are appropriately determined in consideration of the molecular weight of the constitutional component (X), the molecular weight of the polymer A according to the preferred second aspect, and the like. The degree of polymerization of the total structural unit forming the polymerized chain is, for example, preferably 2 to 1,000, more preferably 2 to 200, and still more preferably 6 to 80.

### —Constitutional Component (A)—

From the viewpoint of being able to improve the dispersibility of the solid particles without impairing the effect of shortening the dispersion time, it is preferable that the polymer A according to the preferred second aspect has a constitutional component (A) having at least one polar functional group of a group (a1) of functional groups described later, in which adsorptivity or adhesiveness to the solid particles is enhanced. In a case where a molecular weight of the constitutional component (A) is 400 or more, the constitutional component (A) is preferably a constitutional component having no polymerized chain defined by the constitutional component (X) in the molecular structure; and the constitutional component (A) is more preferably a constitutional component having no polymerized chain defined by the constitutional component (X) in the molecular structure regardless of the molecular weight.

In the constitutional component (A), the polar functional group is preferably included in a molecular chain which is a side chain of the polymer A, and for example, more preferably incorporated into the inside or the terminal of the molecular chain which is a side chain of the polymer A.

In the present invention, the molecular chain which is a side chain of the polymer A refers to a molecular chain constituting the side chain of the polymer A in which the constitutional component (A) is incorporated, and is a molecular chain other than a molecular chain constituting the main chain of the polymer A, usually a molecular chain bonded to the molecular chain (atomic group) constituting the main chain. For example, it refers to a molecular chain (—CONH₂) which is bonded to an ethylenic double bond which is a polymerizable group in a case where the polycondensable compound from which the constitutional component (A) is derived is acrylamide.

It is sufficient that the constitutional component (A) has at least one polar functional group, and it usually preferably has one to three kinds of polar functional groups. The number of polar functional groups included in the polymer A according to the preferred second aspect is not particularly limited, and is appropriately determined according to the number of polar functional groups included in the constitutional component (A) itself, the content of the constitutional component (A), the molecular weight of the polymer A, and the like.

It is sufficient that the constitutional component (A) has the polar functional group, and examples thereof include a constitutional component derived from a polycondensable compound having at least one kind of polar functional group of the following group (a1) of functional groups. The polycondensable compound is, for example, preferably a compound having a polycondensable group, a polar functional group or a substituent having a polar functional group, and a linking group L^{A2} appropriately linking the polycondensable group and the substituent, and more preferably a low-molecular-weight compound. A molecular weight of the constitutional component (A) is not particularly limited, but one of preferred aspects is that the molecular weight is less than 400. In the preferred aspect in which the molecular weight of the constitutional component (A) is less than 400, the constitutional component (A) may have or may not have a repeating structure in a partial structure other than the polycondensable group. On the other hand, in an aspect in which the molecular weight of the constitutional component (A) is 400 or more, the constitutional component (A) is preferably a compound having no repeating structure in a partial structure other than the polycondensable group.

The polycondensable group has the same meaning as the polycondensable group in the constitutional component (X) described above. A substituent forming the substituent having a polar functional group is not particularly limited, and examples thereof include a group selected from the substituent Z described later and a polymerized chain. Preferred examples of the polymerized chain which can be adopted as the substituent include a polymerized chain having a degree of polymerization of number-average molecular weight such that the molecular weight of the constitutional component (X) is less than 400. Such a polymerized chain (however, the number-average molecular weight thereof is limited to that the molecular weight of the constitutional component (A) is less than 400) is not particularly limited, and examples thereof include a polymerized chain having the repeating unit represented by Formula (L_{P}) in the constitutional component (X) described above; and a polymerized chain consisting of polyether is preferable, and a polyalkyleneoxy chain is more preferable.

The substituent is preferably an alkyl group or a polyalkyleneoxy chain. In the present invention, in a case where the substituent forming the substituent having a polar functional group can also correspond to the linking group L^{A2}, the substituent is interpreted as the substituent forming the substituent having a polar functional group.

As the linking group L^{A2}, the above-described linking group L^{A1} which links the above-described polycondensable group and the above-described polymerized chain in the constitutional component (X) can be applied without particular limitation.

### <Group (a1) of Functional Groups>

a sulfonic acid group (sulfo group), a phosphoric acid group (phosphoryl group), a phosphonic acid group, a hydroxy group, a carboxy group, an oxetane group, an epoxy group, a dicarboxylic acid group, a thiol group (sulfanyl group), an ether group, a thioether group, a thioester group, an ester group, an amide group, a urethane group, a urea group, an imide group, a fluoroalkyl group, and salts thereof

The sulfonic acid group, the phosphoric acid group, the phosphonic acid group, and the like, which are included in the group (a1) of functional groups, are not particularly limited, and are synonymous with corresponding groups of the above-described substituent Z.

The dicarboxylic acid group is not particularly limited, and includes a group formed by removing one or more hydrogen atoms from dicarboxylic acid or anhydride thereof, a constitutional component itself, which is formed by copolymerization of polymerizable dicarboxylic acid or anhydride thereof as a polymerizable compound, and a group formed by dicarboxylic acid or anhydride thereof reacting with an active hydrogen compound to cleave an anhydride group. The group obtained by removing one or more hydrogen atoms from a dicarboxylic acid or an anhydride thereof is preferably a group obtained by removing one or more hydrogen atoms from an acyclic dicarboxylic acid or a cyclic dicarboxylic acid anhydride is preferable. Examples the dicarboxylic acid anhydride include acyclic dicarboxylic acid anhydrides such as acetic acid anhydride, propionic acid anhydride, and benzoic acid anhydride; and cyclic dicarboxylic acid anhydrides such as maleic acid anhydride, phthalic acid anhydride, fumaric acid anhydride, succinic acid anhydride, and itaconic acid anhydride. The polymerizable dicarboxylic acid or anhydride thereof is not particularly limited, and examples thereof include dicarboxylic acid or anhydride thereof having an unsaturated bond in the molecule, where a polymerizable cyclic dicarboxylic acid anhydride is preferable. Examples of the polymerizable dicarboxylic acid include maleic acid and itaconic acid, and examples of the polymerizable cyclic dicarboxylic acid anhydride include maleic acid anhydride and itaconic acid anhydride.

The active hydrogen compound is not particularly limited as long as it is a compound which reacts with a dicarboxylic acid anhydride group, and examples thereof include an alcohol compound, an amine compound, and a thiol compound.

The ether group (—O—), the thioether group (—S—), and the thioester group (*—CO—S—**, *—CS—O—**, *—CS—S—**) respectively mean a bond shown in the parentheses. In addition, the ester group (*—CO—O—**), the amide group (*—CONR^{NA1}—**), the urethane group (*—NR^{NA1}—CO—O—**), the urea group (—NR^{NA1}—CO—NR^{NA1}—) and the imide group (*—CO—NR^{NA2}—CO**) respectively mean a bond shown in the parentheses. Here, * and ** represent a bonding portion, R^{NA1} represents a hydrogen atom or a substituent, and R^{NA2}represents a bonding portion, a hydrogen atom, or a substituent. The substituent which can be adopted as R^{NA1} and R^{NA2} is not particularly limited, and examples thereof include the group selected from the substituent Z described later, and an alkyl group (including a cycloalkyl group), an aryl group, a heterocyclic group, or the like is preferable. The number of carbon atoms in the alkyl group is preferably 1 to 20, more preferably 1 to 12, and still more preferably 1 to 6. The number of carbon atoms in the aryl group is preferably 6 to 26, more preferably 6 to 20, and still more preferably 6 to 12. Two R^{NA1}'s in the urea group may be the same or different from each other. R^{NA1} is preferably a hydrogen atom, and R^{NA2} is preferably a bonding portion or a hydrogen atom.

In each of the above-described groups, any of the two bonding portions * and ** may be bonded to the main chain side of the polymer A according to the preferred second aspect, but it is preferable that the bonding portion * is bonded to the main chain side of the polymer A according to the preferred second aspect.

However, in a case where the constitutional component (A) is incorporated into the polymer A, the ester group is excluded from a partial structure which forms the main chain of the polymer A, for example, an ester group directly bonded to the polymerized chain of carbon-carbon double bonds.

The terminal group bonded to each of these groups is not particularly limited, and represents a hydrogen atom or a substituent. Examples of the substituent which can be adopted as the terminal group include the group selected from the substituent Z described later. Among these, an alkyl group (including a cycloalkyl group), an aryl group, or a heterocyclic group is preferable, and an alkyl group or an aryl group is more preferable. The number of carbon atoms in the alkyl group is preferably 1 to 20, more preferably 2 to 12, and still more preferably 3 to 8. The number of carbon atoms in the aryl group is the same as the number of carbon atoms in the aryl group which can be adopted as R^{NA1} In the present invention, in a case where any one of R^{NA1} or the terminal group is a hydrogen atom, the hydrogen atom is interpreted as R^{NA1}

The ether group is found in the carboxy group, the hydroxy group, the oxetane group, the epoxy group, the dicarboxylic acid anhydride group, the ester group, and the like, but —O—contained in these groups is not regarded as the ether group. The same applies to the thioether group. In addition, the ester group is found in the urethane group, but —CO—O— included in the urethane group is not interpreted as the ester group. Furthermore, the amide group is found in the urethane group, the urea group, the imide group, and the like, but —CO—N^{RN}— included in these groups is not interpreted as the amide group.

The polar functional group may form a cyclic structure. For example, the imide group may form a cyclic imide group, specifically, a cyclic imide group derived from maleimide or phthalimide.

The fluoroalkyl group is a fluoroalkyl group in which at least one hydrogen atom in the alkyl group is replaced with a fluorine atom, and a molecular structure thereof may be linear, branched, or cyclic, and is preferably linear or branched. The number of carbon atoms in the fluoroalkyl group is not particularly limited, but is preferably 1 to 20, more preferably 1 to 12, still more preferably 2 to 8, and particularly preferably 2 to 7. An aspect in which the lower limit of carbon atoms is 3 or more is a preferred aspect, and in a case where the fluoroalkyl group is linear, an aspect in which the lower limit of carbon atoms is 4 or more is a preferred aspect.

In the fluoroalkyl group, a part of hydrogen atoms may be replaced with fluorine atoms, or all hydrogen atoms may be replaced with fluorine atoms. In the present invention, a fluoroalkyl group in which a part of hydrogen atoms are replaced with fluorine atoms is preferable, a fluoroalkyl group in which a carbon atom bonded to the polymer A according to the preferred second aspect on the main chain side is not substituted with a fluorine atom and includes a methylene group (—CH₂—) is more preferable, and a fluoroalkyl group in which two or three continuous carbon atoms including the carbon atom bonded to the polymer A according to the preferred second aspect on the main chain side are not substituted with fluorine atoms and includes an ethylene group (—CH₂—CH₂—) or a propylene group (—CH₂—CH₂—CH₂—) is still more preferable. In the fluoroalkyl group in which a part of hydrogen atoms is replaced with a fluorine atom, it is preferable that the remaining alkyl group bonded to a carbon atom not substituted with a fluorine atom is a perfluoroalkyl group in which all hydrogen atoms are replaced with fluorine atoms.

The fluoroalkyl group may have a substituent other than the fluorine atom, for example, may have the substituent (other than the fluorine atom) which can be adopted as Rf described later.

A group which can form a salt, such as the sulfonic acid group (sulfo group), the phosphoric acid group, the phosphonic acid group, the hydroxy group, the carboxy group, and the dicarboxylic acid group, may form a salt together with a cation. The cation is not particularly limited, and examples thereof include various metal salts and salts of ammonium or amine. In addition, the amide group, the urethane group, the urea group, the imide group, and the like may form a salt together with an anion. The anion is not particularly limited, and examples thereof include anions of various inorganic acids or organic acids.

The polar functional group included in the constitutional component (A) is preferably a sulfonic acid group, a phosphoric acid group, a phosphonic acid group, a hydroxy group, a carboxy group, an oxetane group, an epoxy group, a dicarboxylic acid group, an ether group, an amide group, or a salt of these groups, and more preferably an amide group, a hydroxy group, or the like from the viewpoint of shortening the dispersion time and improving the dispersibility.

In a case where the constitutional component (A) has two or more kinds of polar functional groups, the combination thereof is not particularly limited and can be appropriately determined. For example, a combination including an amide group is preferable, and specifically, a combination of an amide group and a dicarboxylic acid group is preferable.

The constitutional component (A) usually has one polar functional group, but two or more polar functional groups may be linked to each other to form a repeating structure as long as the molecular weight is less than 400. In the present invention, as described above, it is preferable that the constitutional component (A) has one polar functional group.

The constitutional component (A) is not particularly limited, but is preferably a constitutional component derived from the above-described polycondensable compound, a constitutional component derived from the above-described polycondensable compound in which the above-described polar functional group is introduced (substituted), a constitutional component derived from a compound in which the above-described polar functional group is introduced into a polymerized chain (where the molecular weight is less than 400), or a constitutional component derived from a maleimide compound, an N-vinyl-substituted imide compound, or a vinyl succinimide compound; more preferably a constitutional component derived from a (meth)acrylic acid compound, a constitutional component derived from a compound in which the above-described polar functional group is introduced into a (meth)acrylic acid ester compound, or a constitutional component derived from a (meth)acrylamide compound; and still more preferably a constitutional component derived from a compound in which the above-described polar functional group is introduced into a (meth)acrylic acid alkyl ester or a (meth)acrylamide compound.

Examples of the (meth)acrylamide compound include (meth)acrylamide compounds such as an N-unsubstituted (meth)acrylamide compound and an N-monosubstituted or N-disubstituted (meth)acrylamide compound; and specifically, an N-unsubstituted (meth)acrylamide compound, an N-alkyl (meth)acrylamide compound, an N,N-dialkyl (meth)acrylamide compound, an N-aryl (meth)acrylamide compound, an N,N-diaryl (meth)acrylamide compound, or the like is preferable. Examples of the substituent which substitutes a nitrogen atom in the acrylamide compound include R^{NA1} or the terminal group bonded to the terminal of the amide bond described above, and an alkyl group or an aryl group is preferable. As the (meth)acrylamide compound, a compound which derives a group having a chemical structure represented by Formula (A1) described later is also preferable.

Examples of the compound which derives the constitutional component (A) including an amide group include a vinyl-based compound containing an amide group, a (meth)acrylate compound containing an amide group, and a (meth)acrylamide compound containing an amide group, in addition to the (meth)acrylamide compound.

The amide group contained in the constitutional component (A) may be a sulfonamide group. Examples of a compound which derives the constitutional component (A) including a sulfonamide group include a vinyl aromatic sulfonamide compound and a (meth)acrylic compound (M1A) containing a sulfonamide group. Among these, a compound in which a sulfonamide group is introduced into a vinyl aromatic compound such as a styrene compound and a vinyl naphthalene compound is preferable, and vinylbenzenesulfonamide is more preferable. The compound which derives the constitutional component (A) including a sulfonamide group may be an N-monosubstituted or N-disubstituted sulfonamide compound, and examples of the substituent which substitutes a nitrogen atom of the sulfonamide group include R^{NA1} or the terminal group bonded to the terminal of the amide bond described above, and an alkyl group is preferable.

Examples of the (meth)acrylic acid ester compound from which the constitutional component (A) is derived include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, and it can be set to, for example, 1 to 24. In general, the number of carbon atoms in the alkyl group is preferably 1 to 12, more preferably 1 to 6, and still more preferably 1 to 4. From the viewpoint of solubility in the dispersion medium and the like, the number of carbon atoms in the alkyl group is preferably 3 to 16 and more preferably 6 to 14. The number of carbon atoms in the aryl group constituting the aryl ester is not particularly limited, but it can be set to, for example, 6 to 24, preferably 6 to 10 and more preferably 6. Examples of the compound in which the above-described polar functional group is introduced into the polymerized chain include a compound having a molecular weight of less than 400 in a case of being used as a constitutional component; and examples thereof include a compound in which the above-described polymerized chain, preferably a polyalkyleneoxy chain is introduced into the above-described polycondensable compound, and the above-described polar functional group is further introduced into the polymerized chain.

As the constitutional component (A), a constitutional component represented by Formula (A1) is particularly preferable from the viewpoint of shortening the dispersion time and improving the dispersibility.

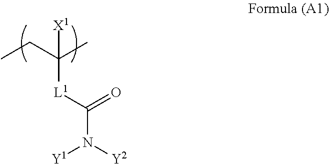

In Formula (A1), X¹ represents a hydrogen atom or a substituent. The substituent which can be adopted as X¹ is not particularly limited, and examples thereof include a group selected from the substituent Z described later; and among these, an alkyl group is preferable. X¹ is preferably a hydrogen atom or a methyl group.

L¹ represents a single bond or a linking group, and is preferably a single bond. The linking group which can be adopted as L¹ is not particularly limited, and the above-described linking group L^{A2} can be applied without particular limitation. Here, the linking group which can be adopted as L¹ does not form a urethane group, a urea group, or an imide group together with the amide group in Formula (A1).

Y¹ and Y² each represent a hydrogen atom or a substituent. The substituent which can be adopted as Y¹ and Y² is not particularly limited, and has the same meaning as R^{NA1} described above or the above-described terminal group bonded to the terminal of the amide bond, and it is preferable that Y¹ is a hydrogen atom and Y² is an alkyl group. However, the substituents which can be adopted as Y¹ and Y² do not form an imide group together with the amide group in Formula (A1). Y¹ and Y² may be the same or different from each other.

In a case where both Y¹ and Y² are alkyl groups, a preferred aspect of the alkyl group which can be adopted as Y¹ and Y² is an aspect which is synonymous with the alkyl group which can be adopted as R^{NA1} described above or as the terminal group bonded to the terminal of the amide bond; and examples thereof include methyl, ethyl, normal propyl, isopropyl, normal butyl, tertiary butyl, a linear or branched octyl group, and a linear or branched dodecyl group. The alkyl group which can be adopted as Y¹ and Y² may have a substituent, but it preferably has no hydroxy group and more preferably has no polar functional group described above. A combination of the alkyl groups which can be adopted as Y¹ and Y² is not particularly limited, and the above-described alkyl groups can be appropriately combined with each other.

The constitutional component represented by Formula (A1) may have a substituent. For example, in Formula (A1), a carbon atom bonded to a carbon atom having X¹ is represented as an unsubstituted carbon atom (methylene group; —CH₂—), but may have a substituent. Such a substituent is not particularly limited, and examples thereof include the above-described substituent which can be adopted as X¹.

Specific examples of the constitutional component (A) include each constitutional component included in the polymer Ain Examples and a constitutional component derived from an acrylamide compound, but the present invention is not limited thereto.

The molecular weight of the constitutional component (A) is appropriately determined in consideration of the molecular weight of the polymer A according to the preferred second aspect, the content of the constitutional component (A), and the like, and is not particularly limited.

In the present invention, the constitutional component (X) and the constitutional component (A) are different constitutional components. As a result, it is possible to shorten the dispersion time and improve the dispersibility.

### —Other Constitutional Components—

The polymer A according to the preferred second aspect may have other constitutional components in addition to the constitutional component (X) and the constitutional component (A) described above. It is sufficient that the other constitutional components do not correspond to the respective constitutional components described above, and examples thereof include constitutional components having no polymerized chain and no polar functional group. Examples thereof include constitutional components derived from a low-molecular-weight polycondensable compound having an ethylenically unsaturated group and having no polar functional group, and more specific examples thereof include a constitutional component derived from the above-described (meth)acrylic acid compound (M1A) or the above-described vinyl-based compound (M2A). A constitutional component derived from a styrene compound, a (meth)acrylic acid ester compound, or a (meth)acrylonitrile compound is preferable, and a constitutional component derived from a (meth)acrylic acid unsubstituted alkyl ester compound or a (meth)acrylic acid aryl group-substituted alkyl ester compound is preferable. As the other constitutional components, one of more preferred aspects is a constitutional component derived from an acrylic acid ester compound having a long-chain unsubstituted alkyl group. The number of carbon atoms in the long-chain unsubstituted alkyl group can be set to, for example, 4 to 20, and it is preferably 4 to 16 and more preferably 6 to 14. As the other constitutional components, one of more preferred aspects is a constitutional component derived from an acrylic acid ester compound having a short-chain unsubstituted alkyl group and a constitutional component derived from an acrylic acid ester compound having a short-chain alkyl group substituted with an aryl group. The number of carbon atoms in the short-chain alkyl group is, for example, preferably 1 to 3.

One of the preferred aspects of the polymer A according to the preferred second aspect is an aspect in which the polymer A does not contain other constitutional components.

The polymer A according to the preferred second aspect may have one or two or more of each of the above-described constitutional components.

A content of each constitutional component in the polymer A according to the preferred second aspect is not particularly limited, and is appropriately determined in consideration of the physical properties of the entire polymer A, and is set to, for example, the following range. The content of each constitutional component in the polymer A according to the preferred second aspect is set, for example, in the following range such that the total content of all constitutional components is 100% by mass. In a case of containing two or more constitutional components corresponding to the specific constitutional component, the total content of these constitutional components is defined.

The total content of the constitutional component (X) in the polymer A according to the preferred second aspect is not particularly limited, and can be appropriately determined in consideration of shortening of the dispersion time, improvement of the dispersibility, and the like. The total content of the constitutional component (X) is, for example, preferably 50 to 99% by mass, more preferably 55 to 95% by mass, still more preferably 60 to 90% by mass, and particularly preferably 65 to 80% by mass with respect to the total content of all constitutional components, from the viewpoint of shortening the dispersion time and improving the dispersibility.

The total content of the constitutional component (A) in the polymer A according to the preferred second aspect is not particularly limited, and can be appropriately determined in consideration of shortening of the dispersion time, improvement of the dispersibility, and the like. In general, as the total content of the constitutional component (A) increases, the viscosity of the polymer A tends to increase. From the viewpoint of easily setting the viscosity of the composition for an all-solid-state secondary battery to a suitable range, the total content of the constitutional component (A) is, for example, preferably 0 to 50% by mass, more preferably 1 to 50% by mass, still more preferably 5 to 45% by mass, particularly preferably 10 to 40% by mass, and most preferably 20 to 35% by mass with respect to the total content of all constitutional components, from the viewpoint of shortening the dispersion time and improving the dispersibility.

In the polymer A according to the preferred second aspect, a ratio [total content of the constitutional component (X)/total content of the constitutional component (A)] of the total content of the constitutional component (X) to the total content of the constitutional component (A) is not particularly limited, and can be, for example, 1.0 to 99, preferably 1.2 to 19, more preferably 1.5 to 9.0, and still more preferably 1.9 to 4.0, from the viewpoint of shortening the dispersion time and improving the dispersibility.

The total content of the other constitutional components is not particularly limited, and is preferably 0% to 50% by mass, more preferably 0% to 30% by mass, and still more preferably 0% to 10% by mass with respect to the total content of all constitutional components.

The polymer A according to the preferred second aspect may have a substituent other than the polar functional group included in the above-described group (a) of functional groups. Examples of the substituent which may be contained in the polymer A include a substituent Z described later (excluding a polar functional group).

One of preferred aspects is that the polymer A does not have a hydroxy group among the polar functional group and the substituent.

Next, a molecular structure of the polymer A according to the preferred second aspect will be described.

The polymer A according to the preferred second aspect is not particularly limited in the molecular structure as long as the polymer has the above-described constitutional component (X), but usually has a branched structure or a multibranched structure, in which the polymerized chain of the constitutional component (X) is a branched chain (side chain). In the present invention, the branched structure refers to a branched structure which is contained in a polymerized chain of the polymer A, and it refers to, for example, a structure in which one or a plurality of other polymerized chains (side chains) are bonded to the main chain. Examples of the branched structure include a graft structure, a star structure (also referred to as a star-shaped structure), and a dendritic structure. Here, the graft structure refers to a polymer in which a plurality of polymerized chains are branchedly bonded (as side chains) to one main chain without usually having a core portion; and the star structure refers to a polymer having a multibranched structure in which a plurality, usually three or more of polymeric arm portions are bonded to a core portion. The polymeric arm portion constituting the star structure may have a linear structure or a graft structure. Here, the polymeric arm portion refers to a partial structure including a polymer chain, which is bonded to the core portion to form an arm portion of the multibranched polymer.

A primary structure (bonding mode of the constitutional component) of the main chain and the graft chain in the graft structure and a primary structure (bonding mode of the constitutional component) of the polymeric arm portion in the star structure are not particularly limited, and any bonding mode of a random structure, a block structure, an alternating structure, or the like can be adopted.

The polymer A according to the preferred second aspect preferably has a graft structure or a star structure.

In a case where the polymer A according to the preferred second aspect has a graft structure, the compound from which the above-described constitutional component (X) is derived can be synthesized by homopolymerization or copolymerization.

In a case where the polymer A according to the preferred second aspect has a star structure, the polymer A is preferably a multibranched polymer represented by Formula (1).

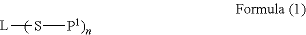

In Formula (1), L represents an n-valent linking group,
P¹ represents a polymer chain as the polymeric arm portion, where n pieces of P's may be the same or different from each other, and
n represents an integer of 3 or more.

### (L of Formula (1))

In Formula (1), L is an n-valent linking group, and is usually a linking group consisting of an organic group including a skeleton in which carbon atoms are bonded to each other by a covalent bond, and it is preferably a linking group further including an oxygen atom. A molecular weight of the linking group is not particularly limited, and for example, is preferably 200 or more and more preferably 300 or more. The upper limit of the molecular weight is preferably 5,000 or less, more preferably 4,000 or less, and particularly preferably 3,000 or less. It is preferable that the linking group does not consist of only one tetravalent carbon atom.

The valence of the linking group is 3 to 10, and has the same definition and the same preferred range as those of n described below.

It is preferable that the linking group has a group represented by Formula 1a. It is preferable that the number of groups represented by Formula 1a in the linking group L is the same as n which is the valence of L. In a case where the linking group has a plurality of the groups, the groups may be the same or different from each other.

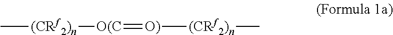

In Formula (1a), n is an integer of 0 to 10, preferably an integer of 1 to 6, and more preferably 1 or 2. Two n's may be the same or different from each other.

R^{f} represents a hydrogen atom or a substituent, and is preferably a hydrogen atom. The substituent which can be adopted as R^{f} is not particularly limited, and examples thereof include the substituent Z described later; and specific examples thereof include a halogen atom (for example, a fluorine atom, a chlorine atom, an iodine atom, or a bromine atom), an alkyl group (preferably having 1 to 12 carbon atoms, more preferably 1 to 6 carbon atoms, and particularly preferably 1 to 3 carbon atoms), an alkoxy group (preferably having 1 to 12 carbon atoms, more preferably 1 to 6 carbon atoms, and particularly preferably 1 to 3 carbon atoms), an acyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 10 carbon atoms), an alkenyl group (preferably having 2 to 12 carbon atoms and more preferably 2 to 5 carbon atoms), a hydroxy group, a nitro group, a cyano group, a mercapto group, an amino group, an amide group, and an acidic group (a carboxyl group, a phosphate group, a sulfonate group, or the like). The acidic group may be a salt. Examples of a counter ion forming the salt include an alkali metal ion, an alkaline earth metal ion, an ammonium ion, and an alkylammonium ion.

The linking group L is preferably a linking group represented by Formula 1A or Formula 1B.

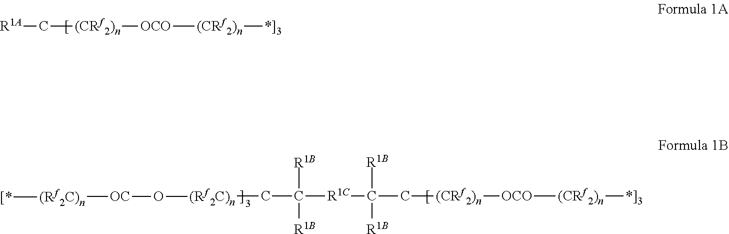

In both the formulae, R^{f} and n have the same definitions and the same preferred ranges as those of R^{f} and n in Formula 1a. * represents a bonding portion to a sulfur atom in Formula 1.

In Formula 1A, R^{1A} represents a hydrogen atom or a substituent. The substituent which can be adopted as R^{1A} is not particularly limited, and examples thereof include the respective substituents which can be adopted as R^{f} and the above-described group represented by Formula 1a. Among these, an alkyl group or the above-described group represented by Formula 1a is preferable. The number of carbon atoms in the alkyl group is preferably 1 to 12, more preferably 1 to 6, and particularly preferably 1 to 3. The substituent which can be adopted as R^{1A} may have one or two or more substituents, and the substituent which may be further included is not particularly limited; and examples thereof include the respective substituents which can be adopted as R^{f}. Among these, a hydroxy group is preferable. Examples of the substituent which may further have one or two or more substituents include a hydroxyalkyl group (the number of carbon atoms is as described above), and specifically, hydroxymethyl is preferable.

In Formula 1B, R^{1C} represents a linking group. The linking group which can be adopted as R^{1C} is not particularly limited, and is preferably an alkylene group having 1 to 30 carbon atoms, a cycloalkylene group having 3 to 12 carbon atoms, an arylene group having 6 to 24 carbon atoms, a heteroarylene group having 3 to 12 carbon atoms, an ether group (—O—), a sulfide group (—S—), a phosphinidene group (—PR—; R represents a hydrogen atom or an alkyl group having 1 to 6 carbon atoms), a silylene group (—SiR^{S1}R^{S2}—; R^{S1} and R^{S2} represent a hydrogen atom or an alkyl group having 1 to 6 carbon atoms), a carbonyl group, an imino group (—NR^{N}—; R^{N} represents a bonding site, a hydrogen atom, an alkyl group having 1 to 6 carbon atoms, or an aryl group having 6 to 10 carbon atoms), or a linking group of a combination of two or more (preferably 2 to 10) thereof. Among these, an alkylene group, an ether group, a sulfide group, a carbonyl group, or a linking group of a combination of two or more (preferably 2 to 5) thereof is preferable, and an ether group is more preferable. R^{1B} represents a hydrogen atom or a substituent, and is preferably a hydrogen atom. The substituent which can be adopted as R^{1B} is not particularly limited, and examples thereof include the respective substituents which can be adopted as R^{f}.

In Formula 1A and Formula 1B, groups represented by the same reference numeral may be the same or different from each other.

In addition to the above-described linking groups, as the linking group L, for example, a linking group in Formula 1B in which one or two or more of the groups represented by Formula 1a are substituted with each of the substituents which can be adopted as R^{f}, in particular, hydroxymethyl is also a preferred aspect.

As the linking group R¹, a linking group represented by any one of Formulae 1C to 1H is also preferable. In each of the formulae, * represents a bonding portion to S in Formula 1.

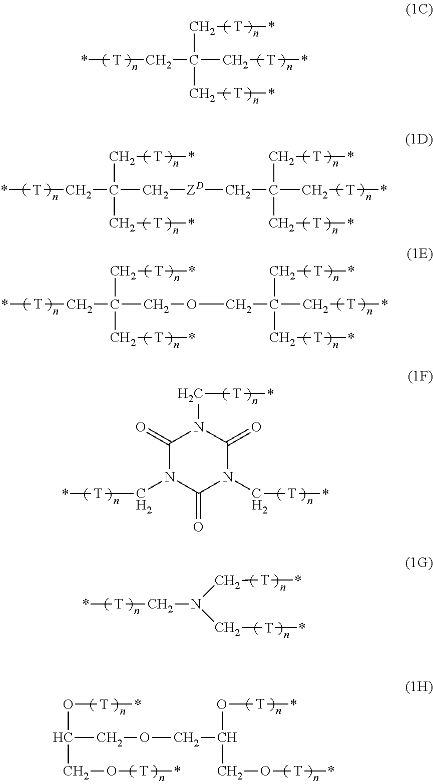

In Formulae 1C to 1H, T represents a linking group, preferably a group represented by any one of Formulae T1 to T6 or a linking group of a combination of two or more (preferably 2 or 3). Examples of the linking group of the combination include a linking group (—OCO-alkylene group) of a combination of the linking group represented by Formula T6 and the linking group represented by Formula T1. In the group represented by any one of Formulae T1 to T6, a sulfur atom in Formula 1 may be bonded to any bonding portion. However, in a case where T represents an oxyalkylene group (the group represented by any one of Formulae T2 to T5) or an —OCO-alkylene group, it is preferable that a sulfur atom in Formula 1 is bonded to a carbon atom (bonding portion) at a terminal.

A plurality of T's present in each of the above formulae may be the same or different from each other.

In each of Formulae 1C to 1H, n represents an integer, preferably an integer of 0 to 14, more preferably an integer of 0 to 5, and particularly preferably an integer of 1 to 3.

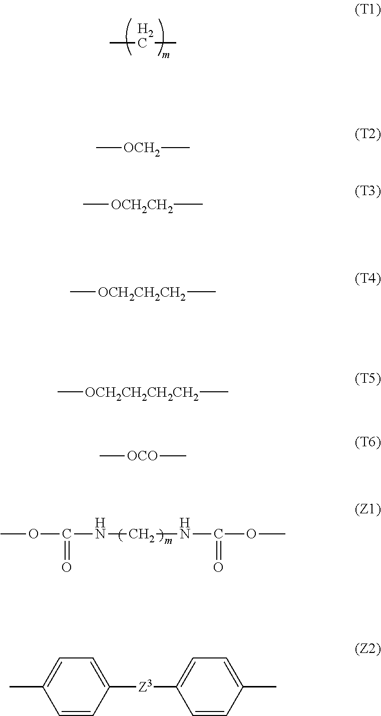

Z^{D} represents a linking group, and is preferably a group represented by Z1 or Z2.

In each of Formula T1 and Formula Z1, m represents an integer of 1 to 8, more preferably an integer of 1 to 5 and particularly preferably an integer of 1 to 3.

In Formula Z2, Z³ is a linking group, and is preferably an alkylene group having 1 to 12 carbon atoms and more preferably an alkylene group having 1 to 6 carbon atoms. Among these, a 2,2-propanediyl group is particularly preferable.

Hereinafter, specific examples of the linking group L are shown, but the present invention is not limited thereto. In each of the specific examples, * represents a bonding portion to a sulfur atom in Formula 1.

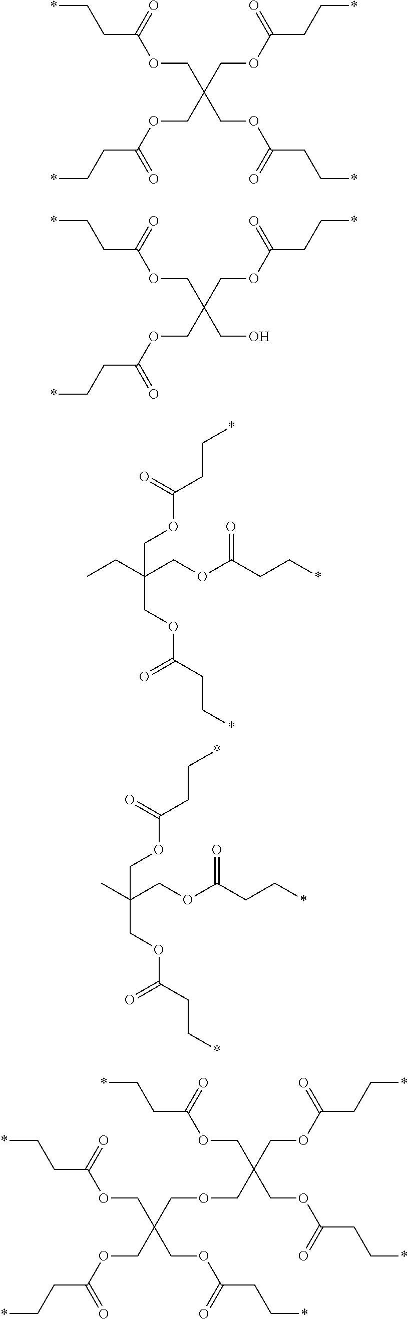

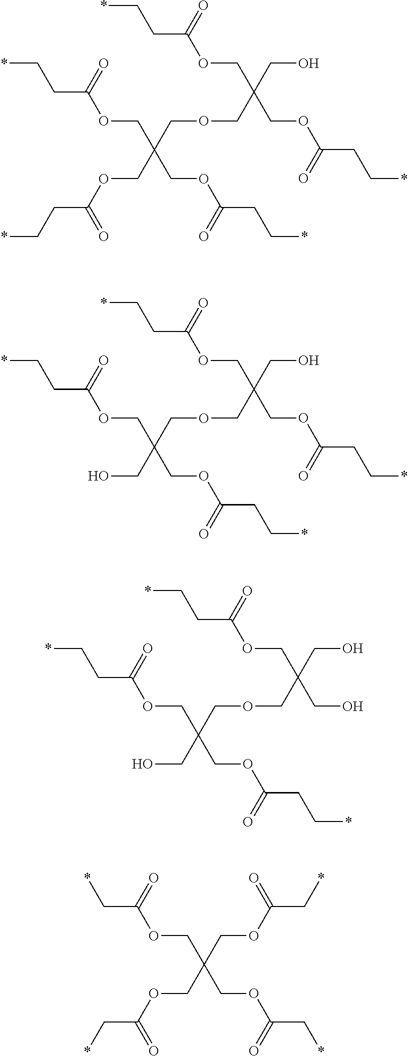 [SMILES: *CCC(=O)OCC(CO)(COCC(COC(=O)CC*)(COC(=O)CC*)COC(=O)CC*)COC(=O)CC* ; *CCC(=O)OCC(CO)(COCC(CO)(COC(=O)CC*)COC(=O)CC*)COC(=O)CC* ; *CCC(=O)OCC(CO)(CO)COCC(CO)(COC(=O)CC*)COC(=O)CC* ; *CC(=O)OCC(COC(=O)C*)(COC(=O)C*)COC(=O)C*]

P¹ of Formula (1) is a polymer chain which forms a polymeric arm portion of the star structure.

The polymer chain P¹ includes the above-described constitutional component (X) as a whole, preferably includes the above-described constitutional component (A), and may appropriately include the above-described other constitutional components, but it is preferable to not include the other constitutional components.

In the multibranched polymer represented by Formula (1) (hereinafter, may be simply referred to as “polymer (1)”), n polymer chains P¹'s each include the above-described constitutional component (X), preferably include the above-described constitutional component (A), and may appropriately include the above-described other constitutional components, and may include the constitutional component (X) or the constitutional component (A) and appropriately include the other constitutional components.

n polymer chains P¹ may be the same or different from each other, and from the viewpoint of shortening the dispersion time and the dispersibility, it is preferable that at least one polymer chain P¹ is a polymer chain including the above-described constitutional component (X) (hereinafter, also referred to as “polymer chain P^{1X}”) and at least one other polymer chain P¹ is a polymer chain including the above-described constitutional component (A) (hereinafter, also referred to as “polymer chain P^{1A}”). From the viewpoint of shortening the dispersion time and the dispersibility, the polymer chain P^{1X} preferably does not include the above-described constitutional component (A), may include the other constitutional components, but more preferably does not include the other constitutional components, that is, the polymer chain P^{1X} is more preferably a homopolymerized chain of the constitutional component (X), still more preferably a homopolymerized chain of a constitutional component having a polymerized chain consisting of polysiloxane, and particularly preferably a homopolymerized chain of the (meth)acrylic compound (M1A) having a polymerized chain consisting of polysiloxane. From the viewpoint of shortening the dispersion time and the dispersibility, the polymer chain p^{1A}preferably does not include the above-described constitutional component (X), may include the other constitutional components, but more preferably does not include the other constitutional components, that is, the polymer chain P^{1A} is more preferably a homopolymerized chain of the constitutional component (A), and particularly preferably a homopolymerized chain of a (meth)acrylamide compound.

In the polymer (1), the number of polymer chains P^{1X} and the number of polymer chains P^{1A} are appropriately determined within the range indicated by n of Formula (1), and can be, for example, the same as nA and mX of Formula (2) described later.

In a case where the polymer chain P¹ includes two or more kinds of constitutional components, a primary structure of the polymer chain P¹ is not particularly limited, and any bonding mode of a random structure, a block structure, an alternating structure, or the like may be adopted, but a random structure or a block structure is preferable.

The group bonded to the terminal of the polymer chain P¹ is not particularly limited, and an appropriate group can be adopted depending on the polymerization method or the like as described above.

A content of the constitutional component (X) in the polymer chain P iX is not particularly limited, but from the viewpoint of shortening the dispersion time and the dispersibility, it is preferably 50% by mass or more, preferably 75% by mass or more, more preferably 90% by mass or more, still more preferably 95% by mass or more, and a case in which the content is 100% by mass is one of preferred aspects.

A content of the constitutional component (A) in the polymer chain P^{1X} is not particularly limited, but from the viewpoint of shortening the dispersion time and the dispersibility, it is preferably 50% by mass or less, preferably 10% by mass or less, more preferably 5% by mass or less, and a case in which the content is 0% by mass is one of preferred aspects.

A content of the other constitutional components in the polymer chain P^{1X} is not particularly limited, but from the viewpoint of shortening the dispersion time and the dispersibility, it is preferably 50% by mass or less, preferably 30% by mass or less, more preferably 10% by mass or less, and a case in which the content is 0% by mass is one of preferred aspects.

A content of the constitutional component (A) in the polymer chain P^{1A} is not particularly limited, but from the viewpoint of shortening the dispersion time and the dispersibility, it is preferably 50% by mass or more, preferably 75% by mass or more, more preferably 90% by mass or more, still more preferably 95% by mass or more, and a case in which the content is 100% by mass is one of preferred aspects.

A content of the constitutional component (X) in the polymer chain P^{1A} is not particularly limited, but from the viewpoint of shortening the dispersion time and the dispersibility, it is preferably 50% by mass or less, preferably 10% by mass or less, more preferably 5% by mass or less, and a case in which the content is 0% by mass is one of preferred aspects.

A content of the other constitutional components in the polymer chain P^{1A} is not particularly limited, but from the viewpoint of shortening the dispersion time and the dispersibility, it is preferably 50% by mass or less, preferably 30% by mass or less, more preferably 10% by mass or less, and a case in which the content is 0% by mass is one of preferred aspects.

A weight-average molecular weight Mw^{P1} of the polymer chain P¹ (average value of weight-average molecular weights of n polymer chains P¹) is not particularly limited, and is appropriately set in consideration of the weight-average molecular weight of the polymer (1) which is an example of the polymer A according to the preferred second aspect, and is, for example, preferably 500 to 20,000 and more preferably 1,000 to 10,000. In addition, a polymerization degree of all constitutional components in the polymer chain P¹ (average value of polymerization degrees of n polymer chains P¹) is not particularly limited, and is preferably 5 to 300 and more preferably 8 to 150.

A weight-average molecular weight Mw^{P1X} of the polymer chain P^{1X} (average value of weight-average molecular weights of all polymer chains P^{1X}) is not particularly limited, and is appropriately set in consideration of the weight-average molecular weight of the polymer (1) which is an example of the polymer A according to the preferred second aspect, and is, for example, preferably 400 to 50,000 and more preferably 1,000 to 20,000. In addition, a polymerization degree of all constitutional components in the polymer chain P^{1X} (average value of polymerization degrees of all polymer chains P^{1X}) is not particularly limited, and is preferably 1 to 10 and more preferably 1 to 3.

A weight-average molecular weight Mw^{P1A} of the polymer chain P^{1A} (average value of weight-average molecular weights of all polymer chains P^{1A}) is not particularly limited, and is appropriately set in consideration of the weight-average molecular weight of the polymer (1) which is an example of the polymer A according to the preferred second aspect, and is, for example, preferably 100 to 10,000 and more preferably 200 to 3,000. In addition, a polymerization degree of all constitutional components in the polymer chain P^{1A} (average value of polymerization degrees of all polymer chains P^{1A}) is not particularly limited, and is preferably 1 to 100 and more preferably 2 to 30.

In the polymer represented by Formula (1), a combination of the polymer chain A^{1X} and the polymer chain A^{1A} is not particularly limited, and the constitutional component (X) constituting the polymer chain A^{1X} and the constitutional component (A) constituting the polymer chain A^{1X} can be appropriately combined. The combination of the polymer chain A^{1X} and the polymer chain A^{1A} is preferably a combination of the suitable constitutional component which can be adopted as the constitutional component (X) and the suitable constitutional component which can be adopted as the constitutional component (A), and examples thereof include a combination in the polymer A shown in specific examples and Examples described later.

### (n of Formula (1))

In Formula (1), n is an integer of 3 or more, and is preferably an integer of 3 to 10, more preferably an integer of 3 to 8, still more preferably an integer of 3 to 6, and particularly preferably an integer of 4 to 6.

A content of the core portion L in the polymer (1) is not particularly limited, but can be set to 1% to 40% by mass in total with “S” in the polymer (1), and is preferably 2% to 30% by mass, more preferably 2% to 20% by mass, and still more preferably 3% to 10% by mass, from the viewpoint of shortening the dispersion time and improving the dispersibility.

The total content of the polymer chain P¹ in the polymer (1) is not particularly limited, but can be set to 60% to 99% by mass, and is preferably 70% to 98% by mass, more preferably 80% to 98% by mass, and still more preferably 90% to 97% by mass, from the viewpoint of shortening the dispersion time and improving the dispersibility.

The total content of the polymer chain P^{1X} in the polymer (1) can be appropriately determined in consideration of the above-described total content of the polymer chain P¹, and for example, it is preferably the same as the above-described total content of the constitutional component (X) in the polymer A according to the preferred second aspect, as the total content in the total content of the polymer chain P¹.

The total content of the polymer chain P^{1A} in the polymer (1) can be appropriately determined in consideration of the above-described total content of the polymer chain P¹, and for example, it is preferably the same as the above-described total content of the constitutional component (A) in the polymer A according to the preferred second aspect, as the total content in the total content of the polymer chain P¹. In the polymer (1), a ratio [total content of polymer chain P^{1X}/total content of polymer chain P^{1A}] of the total content of the polymer chain P^{1X} to the total content of the polymer chain P^{1A} is not particularly limited, and is preferably the same as the ratio [Total content of constitutional component (X)/Total content of constitutional component (A)] of the total contents in the polymer A according to the preferred second aspect.

The multibranched polymer represented by Formula (1) is preferably represented by Formula (2).

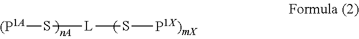

In Formula (2), L represents an (nA+mX)-valent linking group, and is the same as L in Formula (1) described above.

P^{1A} represents the above-described polymer chain P^{1A} including the above-described constitutional component (A), and nA pieces of P^{1A}'s may be the same or different from each other.

P^{1X} represents the above-described polymer chain P^{1X} including the above-described constitutional component (X), and nX pieces of PX's may be the same or different from each other.

In Formula (2), nA is an integer of 1 to 8, preferably an integer of 1 to 4, more preferably an integer of 1 to 3, and still more preferably 1 or 2.

mX represents an integer of 2 to 9, preferably an integer of 2 to 5 and more preferably an integer of 3 to 5.

Here, nA+mX represents an integer of 3 to 10, preferably an integer of 3 to 8, more preferably an integer of 3 to 6, and still more preferably an integer of 4 to 6.

The contents of L, P^{1A}, and P^{1X} in the polymer (1) are the same as the contents of L, P^{1A} and P^{1X} in Formula (1) described above.

Specific examples of the polymer A represented by Formula (1) or Formula (2) include polymers synthesized in specific examples and Examples described later, but the present invention is not limited thereto.

As the polymer A according to the preferred second aspect, a commercially available product can be used, and a synthesized product can also be used. The polymer (1) can be synthesized by selecting a raw material compound by a known method. For example, the polymer (1) can be synthesized by condensation, homopolymerization, or copolymerization by a normal synthesis method using a surfactant, an emulsifier or a dispersant, a polycondensable compound from which the constitutional component (X) is derived, a polycondensable compound from which the constitutional component (A) is derived, a polycondensable compound from which the other constitutional components are derived, and the like. In addition, the multibranched polymer represented by Formula (1) or Formula (2) can be synthesized, for example, by an addition reaction of a polyvalent thiol compound corresponding to the core portion L with the above-described raw material compounds. Specifically, the multibranched polymer represented by Formula (1) or Formula (2) can be synthesized by a method described in Examples later.

A method of incorporating the polar functional group into the polymer A according to the preferred second aspect is not particularly limited, and examples thereof include a method of copolymerizing with a compound having the functional group, a method of using a polymerization initiator or a chain transfer agent, having (generating) the above-described functional group, a method of using a polymeric reaction, an ene reaction or thiol-ene reaction with a double bond, and an atom transfer radical polymerization (ATRP) method using a copper catalyst. In addition, the functional group can be introduced by using a functional group which is present in the main chain, the side chain, or the terminal of the polymer, as a reaction point. For example, the functional group can be introduced by various reactions with a dicarboxylic acid anhydride group in a polymerized chain using a compound having the functional group.

Specific examples of the polymer A include the following compounds, but the present invention is not limited thereto.

In specific examples A-1 to A-14, all alkyl groups in the (meth)acrylic acid alkyl ester are linear alkyl groups, and a number attached to the lower right of the constitutional component indicates the content in the polymer, in which the unit thereof is % by mass.

In A-15 to A-32, a polymerized chain M-1 consisting of polysiloxane is a polymerized chain derived from X-22-174ASX (product number, molecular weight: 900, manufactured by Shin-Etsu Chemical Co., Ltd.), a polymerized chain M-2 is a polymerized chain derived from X-22-174BX: (product number, molecular weight: 2,300, manufactured by Shin-Etsu Chemical Co., Ltd.), and a polymerized chain M-3 is a polymerized chain derived from KF-2012 (product number, molecular weight: 4,600, manufactured by Shin-Etsu Chemical Co., Ltd.). A degree of polymerization of the siloxane structure in the polymerized chains M-1 to M-3 is not described. In addition, R^{Y} bonded to the polymerized chain consisting of polysiloxane represents a linking group, and R^{Z} represents a substituent. In specific examples A-15 to A-24, a number attached to the lower right of the constitutional component indicates the content in the polymer, in which the unit thereof is % by mass.

In the following structural formulae, “Me” represents a methyl group and “Ph” represents a phenyl group.

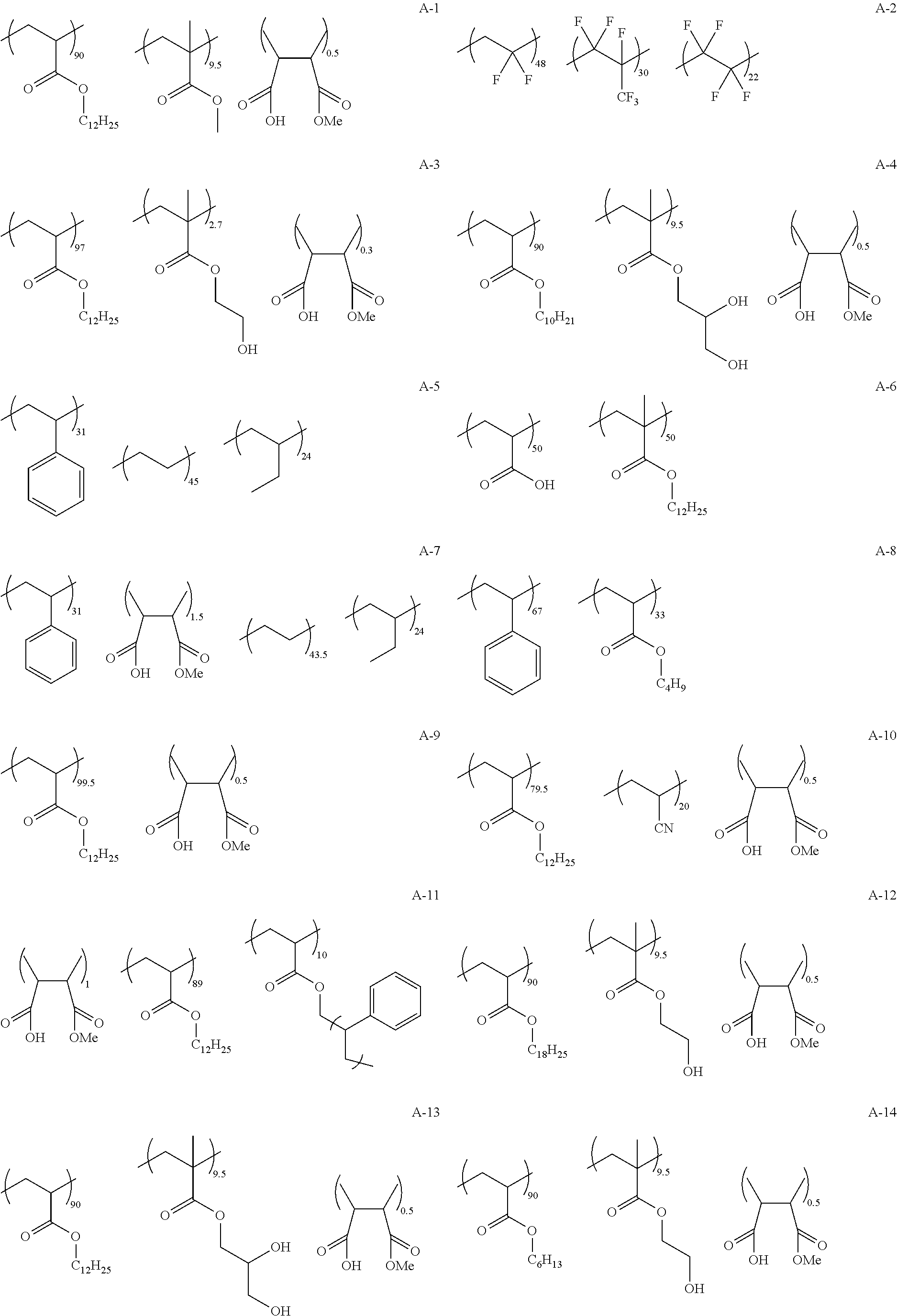

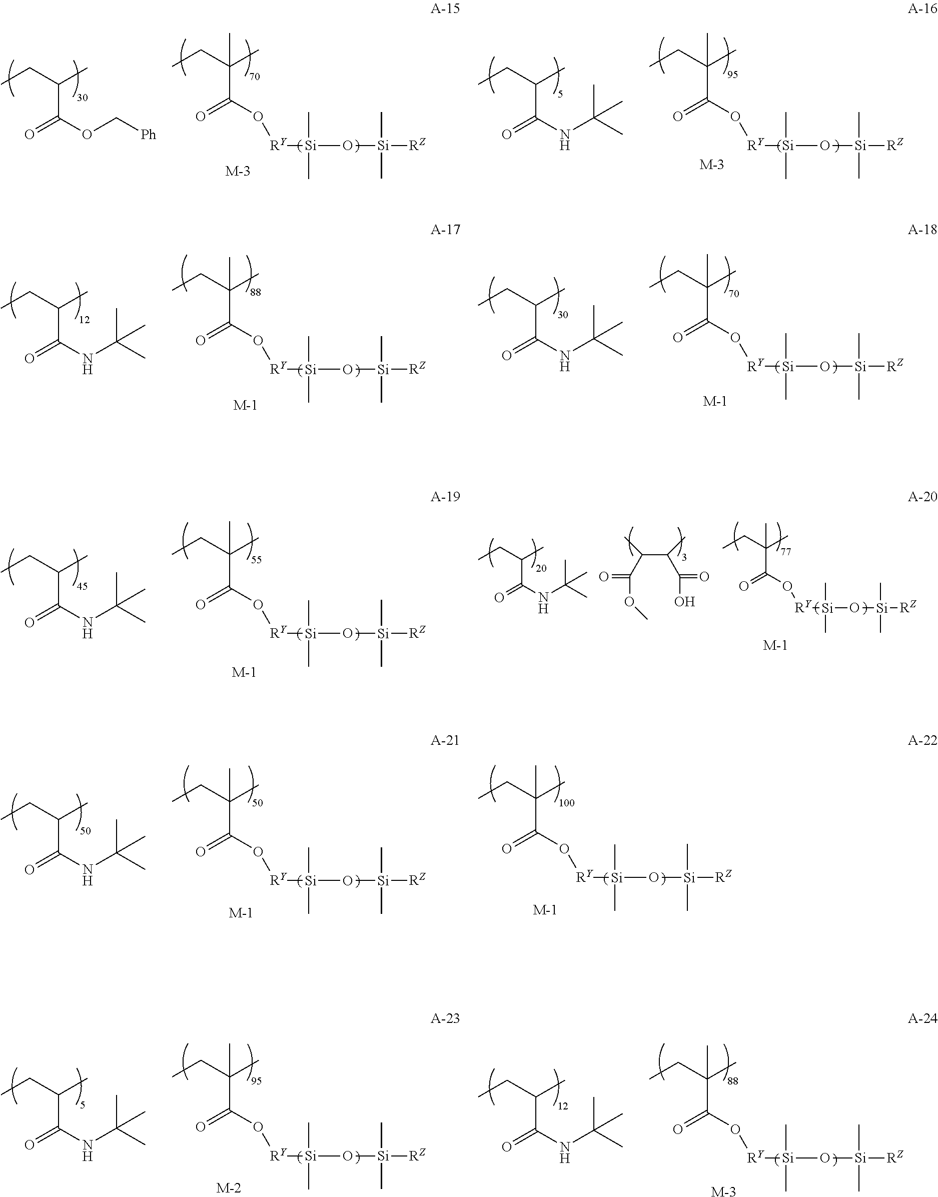

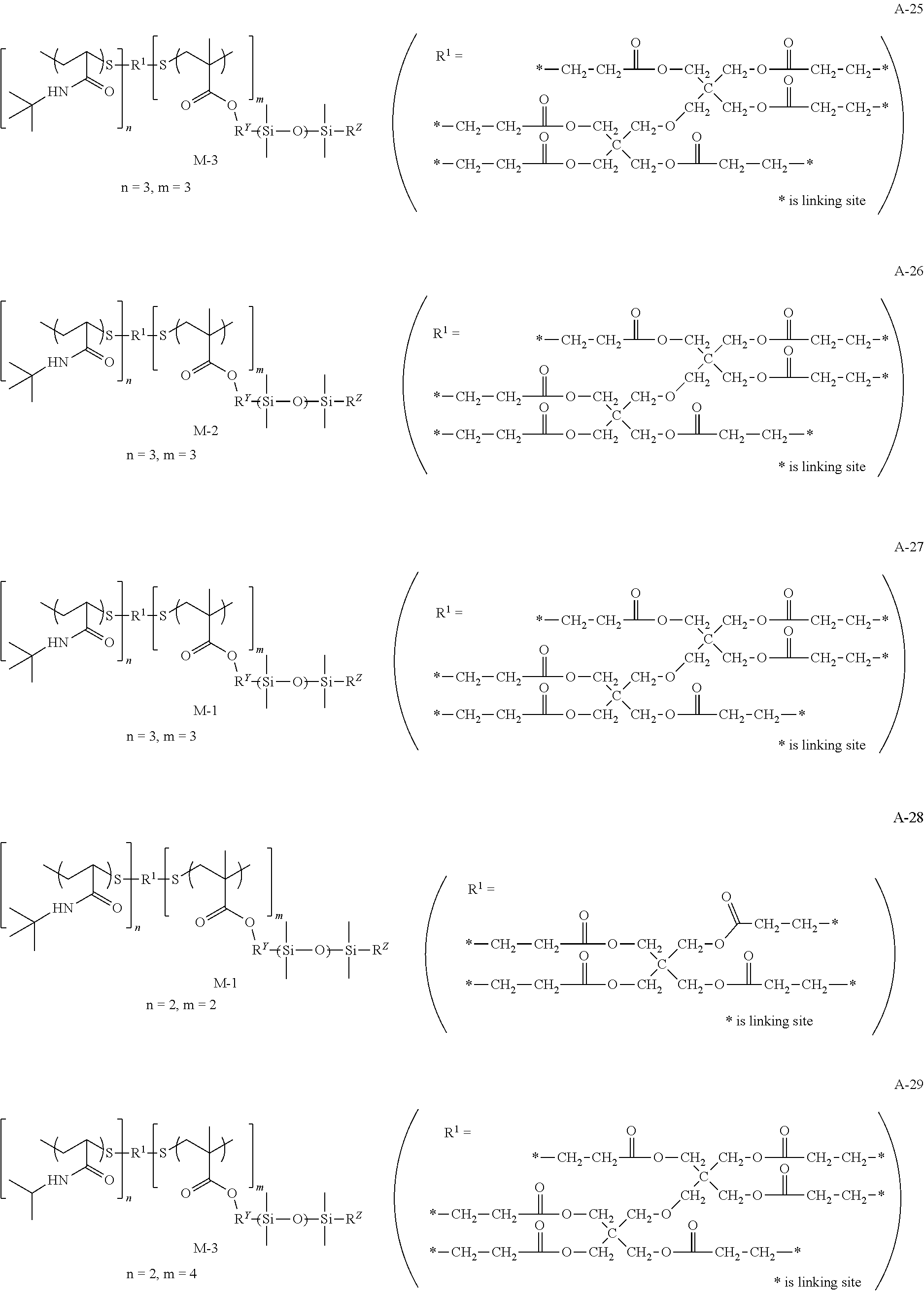

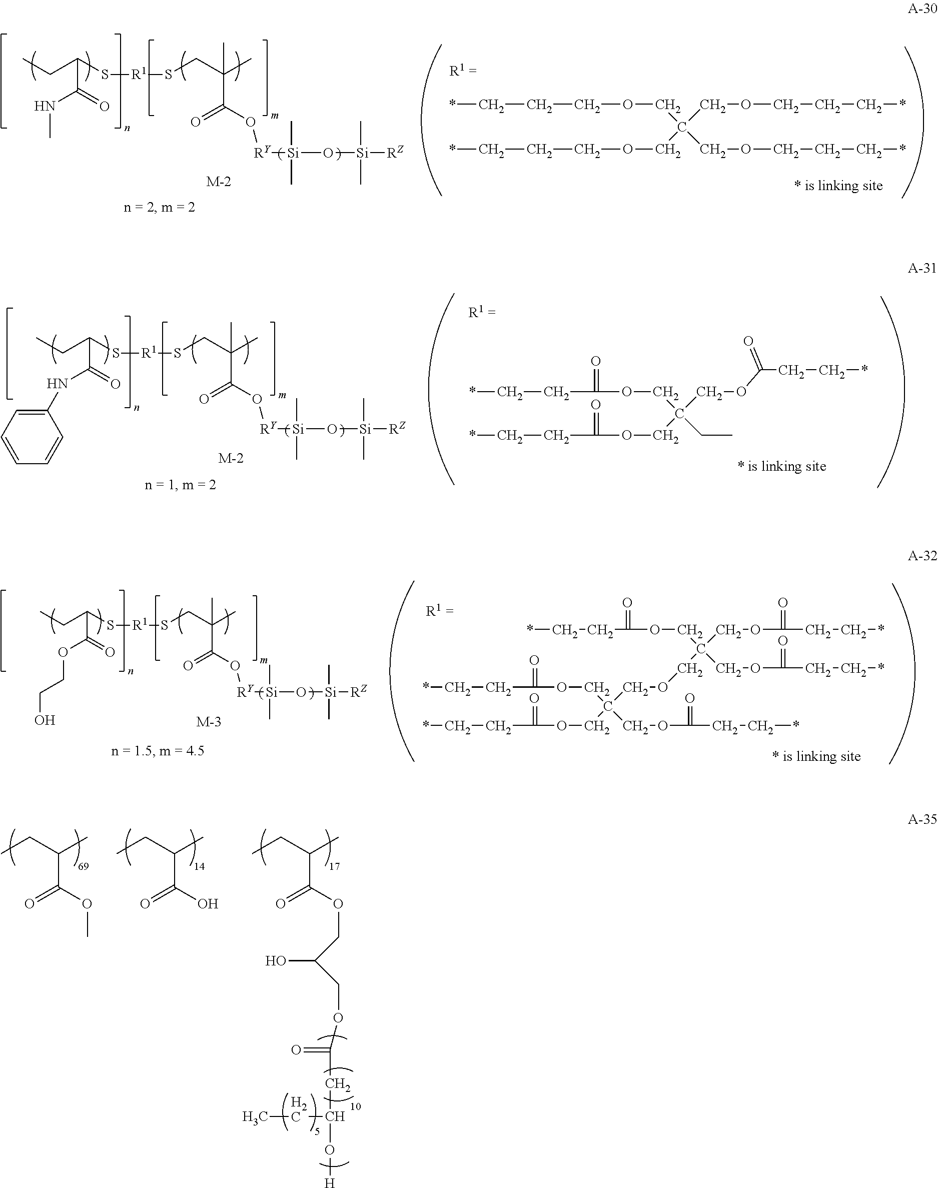

The composition for an all-solid-state secondary battery according to the embodiment of the present invention may contain one kind or two or more kinds of the polymers A. In a case where two or more kinds of the polymers A are contained, it is preferable that at least one of the polymers A is a polymer satisfying at least one of the above-described preferred range of the adsorption rate A_{AC} or the above-described preferred range of the adsorption rate A_{SE}, for example, a polymer selected from the above-described polymer A according to the preferred first aspect or the polymer A according to the preferred second aspect; and it is more preferable that all of the polymers A is a polymer satisfying at least one of the above-described preferred range of the adsorption rate A_{AC} or the above-described preferred range of the adsorption rate A_{SE}. As the polymer not satisfy one of the above-described preferred range of the adsorption rate A_{AC} or the above-described preferred range of the adsorption rate A_{SE}, for example, various polymers used as a binder or the like in the all-solid-state secondary battery can be used without particular limitation.

### (Physical Properties, Characteristics, or the Like of Polymer A)

The polymer A preferably has the following physical properties, characteristics, or the like.

A watery moisture concentration of the polymer A is preferably 100 ppm (in terms of mass) or less. In addition, the polymer A may be obtained by crystallizing the polymer A and drying the polymer A, or a solution of the polymer A may be used as it is.

The polymer A is preferably amorphous. In the present invention, the description that a polymer is “amorphous” typically refers to that no endothermic peak due to crystal melting is observed in a case where the measurement is carried out at the glass transition temperature.

The polymer A may be a non-crosslinked polymer or a crosslinked polymer, and is preferably a non-crosslinked polymer. In addition, in a case where crosslinking of the polymer progresses due to heating or voltage application, the molecular weight may be higher than the above-described molecular weight.

A content of the polymer A in the composition for an all-solid-state secondary battery is not particularly limited, and is appropriately set in consideration of Aa or Ab calculated by the expression 1 or the expression 2 and Ac calculated by the expression 3, and for example, can be set to 0.1% to 20% by mass in 100% by mass of the solid contents.

From the viewpoint of suppressing the deterioration of the battery performance of the all-solid-state secondary battery, for example, the decrease in battery output and the increase in resistance, it is preferable that the content of the polymer A is low. On the other hand, in a case where the content of the polymer A is reduced, the number of molecules of the polymer A which functions as a dispersant is reduced. Therefore, in the present invention, in order to increase the number of molecules of the polymer A present in the composition for an all-solid-state secondary battery while reducing the content of the polymer A in consideration of the battery performance, it is preferable to set Aa or Ab calculated by the expression 1 or the expression 2 within the above-described range, which is determined in consideration of the weight-average molecular weight, from the viewpoint that the dispersibility of the solid particles can be improved while suppressing the deterioration of the battery performance. The content of the polymer A is preferably 0.1% to 5% by mass, and in particular, more preferably 0.2% to 3% by mass and still more preferably 0.3% to 2% by mass in the above-described range in a case where the weight-average molecular weight of the polymer A is 2.0×10³ to 2.0×10⁴.

In the present invention, in 100% by mass of the solid contents, a mass ratio [(mass of SE+mass of AC)/(mass of polymer A)] of the total mass of the inorganic solid electrolyte SE and the active material AC to the mass of the polymer A is preferably in a range of 1,000 to 1. The ratio is more preferably 500 to 2 and still more preferably 100 to 10.

In a case where the composition for an all-solid-state secondary battery contains two or more kinds of the polymers A, the content of the polymer A is a total content thereof.

### <Dispersion Medium D>

The composition for an all-solid-state secondary battery according to the embodiment of the present invention contains the dispersion medium D which disperses or dissolves each of the above-described components.

It is sufficient that the dispersion medium D is an organic compound which is in a liquid state in the use environment, examples thereof include various organic solvents, and specific examples thereof include an alcohol compound, an ether compound, an amide compound, an amine compound, a ketone compound, an aromatic hydrocarbon compound, an aliphatic hydrocarbon compound, a nitrile compound, and an ester compound.

The dispersion medium D may be a non-polar dispersion medium (a hydrophobic dispersion medium) or a polar dispersion medium (a hydrophilic dispersion medium), and a non-polar dispersion medium is preferable from the viewpoint that excellent dispersibility can be exhibited. The non-polar dispersion medium generally refers to a dispersion medium having a property of low affinity to water, and in the present invention, examples thereof include an ester compound, a ketone compound, an ether compound, an aromatic hydrocarbon compound, and an aliphatic hydrocarbon compound.

Examples of the alcohol compound include methyl alcohol, ethyl alcohol, 1-propyl alcohol, 2-propyl alcohol, 2-butanol, ethylene glycol, propylene glycol, glycerol, 1,6-hexanediol, cyclohexanediol, sorbitol, xylitol, 2-methyl-2,4-pentanediol, 1,3-butanediol, and 1,4-butanediol.

Examples of the ether compound include alkylene glycols (diethylene glycol, triethylene glycol, polyethylene glycol, dipropylene glycol, and the like), alkylene glycol monoalkyl ethers (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, and the like), alkylene glycol dialkyl ethers (ethylene glycol dimethyl ether and the like), dialkyl ethers (dimethyl ether, diethyl ether, diisopropyl ether, dibutyl ether, and the like), and cyclic ethers (tetrahydrofuran, dioxane (including 1,2-, 1,3- or 1,4-isomer), and the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic hydrocarbon compound include benzene, toluene, xylene, and perfluorotoluene.

Examples of the aliphatic hydrocarbon compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among the above, an ether compound, a ketone compound, an aromatic hydrocarbon compound, an aliphatic hydrocarbon compound, or an ester compound is preferable; and an ester compound, a ketone compound, or an ether compound is more preferable.

The number of carbon atoms in the compound constituting the dispersion medium is not particularly limited, and it is preferably 2 to 30, more preferably 4 to 20, still more preferably 6 to 15, and particularly preferably 7 to 12.

A boiling point of the dispersion medium at normal pressure (1 atm; 101,325 Pa)) is not particularly limited, and is preferably 50° C. or higher, and more preferably 70° C. or higher. The upper limit thereof is preferably 250° C. or lower and more preferably 220° C. or lower.

The composition for an all-solid-state secondary battery according to the embodiment of the present invention may contain one kind or two or more kinds of the dispersion media D. Examples of two or more kinds of the dispersion media include xylene (a mixture of xylene isomers in which a mixing molar ratio between isomers is ortho-isomer:para-isomer:meta-isomer=1:5:2) and mixed xylene (a mixture of o-xylene, p-xylene, m-xylene, and ethylbenzene).

In the present invention, a content of the dispersion medium D in the composition for an all-solid-state secondary battery is not particularly limited and can be appropriately set. In the present invention, the concentration of solid contents can be increased to a high concentration, that is, the content of the dispersion medium D can be reduced by utilizing the excellent dispersibility of the composition for an all-solid-state secondary battery. For example, the content of the dispersion medium D in the composition for an all-solid-state secondary battery is preferably 10% to 60% by mass, more preferably 20% to 50% by mass, and particularly preferably 20% to 40% by mass.

### <Conductive Auxiliary Agent>

The composition for an all-solid-state secondary battery according to the embodiment of the present invention, particularly the electrode composition, preferably contains a conductive auxiliary agent.

The conductive auxiliary agent is not particularly limited, a conductive auxiliary agent which is known as a general conductive auxiliary agent can be used. For example, the conductive auxiliary agent may be graphite such as natural graphite and artificial graphite; carbon black such as acetylene black, ketjen black, and furnace black; irregular carbon such as needle cokes; a carbon fiber such as vapor-grown carbon fiber and carbon nanotube; a carbonaceous material such as graphene and fullerene which are electron-conductive materials; metal powder or a metal fiber of copper, nickel, or the like; and a conductive polymer such as polyaniline, polypyrrole, polythiophene, polyacetylene, and a polyphenylene derivative.

In the present invention, in a case where the active material is used in combination with the conductive auxiliary agent, among the above-described conductive auxiliary agents, a conductive auxiliary agent which does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent which can function as the active material in the active material layer at the time of charging and discharging of the battery is classified as the active material, not as the conductive auxiliary agent. Whether or not the conductive auxiliary agent functions as the active material at the time of charging and discharging of the battery is not unambiguously determined, and determined by a combination with the active material.

The conductive auxiliary agent contained in the composition for an all-solid-state secondary battery according to the embodiment of the present invention preferably has a particle shape in the composition for an all-solid-state secondary battery. A shape of the particles is not particularly limited, and may be a flat shape, an amorphous shape, or the like; and a spherical shape or a granular shape is preferable. In a case where the conductive auxiliary agent is in a particulate form, a particle diameter (volume average particle size) of the conductive auxiliary agent is not particularly limited, but is, for example, preferably 0.02 to 1.0 μm and more preferably 0.03 to 0.5 μm. The particle diameter of the conductive auxiliary agent can be adjusted in the same manner as in the adjustment of the particle diameter of the inorganic solid electrolyte described above, and it can be measured by the same measuring method as the method of measuring the particle diameter of the inorganic solid electrolyte.

A specific surface area of the conductive auxiliary agent is not particularly limited, and can be appropriately set. For example, the specific surface area of the conductive auxiliary agent is usually in a range of 1.0 to 1,500 m²/g, preferably in a range of 5 to 100 m²/g.

The composition for an all-solid-state secondary battery according to the embodiment of the present invention may contain one kind or two or more kinds of the conductive auxiliary agents.

A content of the conductive auxiliary agent in the composition for an all-solid-state secondary battery is not particularly limited and is appropriately determined. For example, in 100% by mass of the solid content, the content thereof is preferably 10% by mass or less and more preferably 1.0% to 5.0% by mass.

### <Lithium Salt>

The composition for an all-solid-state secondary battery according to the embodiment of the present invention can contain a lithium salt (supporting electrolyte). Generally, the lithium salt is preferably a lithium salt which is used for this kind of product and is not particularly limited. For example, lithium salts described in paragraphs 0082 to 0085 of JP2015-088486A are preferable. In a case where the composition for an all-solid-state secondary battery according to the embodiment of the present invention contains a lithium salt, a content of the lithium salt is preferably 0.1 part by mass or more and more preferably 5 parts by mass or more with respect to 100 parts by mass of the inorganic solid electrolyte. The upper limit thereof is preferably 50 parts by mass or less, and more preferably 20 parts by mass or less.

### <Other Additives>

As components other than the respective components described above, the composition for an all-solid-state secondary battery according to the embodiment of the present invention may appropriately contain an ionic liquid, a thickener, a crosslinking agent (agent causing a crosslinking reaction by radical polymerization, condensation polymerization, or ring-opening polymerization), a polymerization initiator (agent which generates an acid or a radical by heat or light), a defoamer, a leveling agent, a dehydrating agent, or an antioxidant. The ionic liquid is contained in order to further improve the ion conductivity, and the known ionic liquid can be used without being particularly limited.

(Preparation of Composition for all-Solid-State Secondary Battery)

The composition for an all-solid-state secondary battery according to the embodiment of the present invention can be prepared by a conventional method using the inorganic solid electrolyte SE, the polymer A, the active material AC as necessary, and the conductive auxiliary agent. The composition for an all-solid-state secondary battery according to the embodiment of the present invention can be prepared, as a mixture and preferably as a slurry, by mixing the inorganic solid electrolyte SE, the polymer A, the dispersion medium D, the active material AC, and as necessary, the conductive auxiliary agent, the lithium salt, and any other components, by various mixing machines usually used.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. The environment in which the mixing is carried out is not particularly limited, and examples thereof include a dry air atmosphere (dew point of −20° C. or lower) or an inert gas atmosphere (for example, an argon gas atmosphere, a helium gas atmosphere, or a nitrogen gas atmosphere). In addition, the mixing conditions are not particularly limited and are appropriately set, and for example, the mixing temperature can be set to 15° C. to 40° C. In addition, a rotation speed of a rotating and revolving mixer or the like can be set to 200 to 3,000 rotation per minute (rpm).

A mixing time is not particularly limited, and can be appropriately determined according to the dispersibility of the solid particles; and for example, the mixing time can be usually set to 1 to 180 minutes. The composition for an all-solid-state secondary battery according to the embodiment of the present invention has excellent dispersibility of the solid particles, and the solid particles can be highly dispersed in the dispersion medium D without aggregation even in a short mixing time. Therefore, the mixing time (dispersion time) can be set to be short, for example, can be set to 10 minutes or less, and is preferably set to 1 to 8 minutes. In the present invention, the mixing time refers to a mixing time in a case of mixing the solid particles (the inorganic solid electrolyte SE, the polymer A, the active material AC as necessary, and the conductive auxiliary agent), the polymer A, and the dispersion medium.

In the method of preparing the composition for an all-solid-state secondary battery, the components to be used are selected to satisfy the value calculated by the expression 1 and/or the expression 2, preferably further the value calculated by the expression 3.

Specifically, as is clear from the expression 1, Aa calculated by the expression 1 increases as the adsorption rate A_{AC} of the polymer A to the active material AC increases, the content of the polymer A in the total solid content amount increases, the molecular weight of the polymer A decreases, and the specific surface area of the active material AC decreases. Specifically, in a case where the adsorption rate A_{AC}, the content of the polymer A, the molecular weight of the polymer A, and the specific surface area of the active material AC are set within the above-described ranges, preferably within the above-described preferred ranges, it is easy to adjust Aa calculated by the expression 1 to be within the range of 1 to 100. Preferably, (1) the specific surface area of the active material AC to be used is measured, and the content of the active material/total solid content amount is set (setting of the total specific surface area of the active material AC). Next, (2-1) for example, in a case where the content of the polymer A/total solid content amount is determined to be 0.005, the polymer A showing the adsorption rate to the active material AC, at which Aa is 1 to 100, and the weight-average molecular weight is selected. On the other hand, (2-2) in a case where the polymer A is determined (the adsorption rate to the active material AC and the weight-average molecular weight are selected), the content of the polymer A/total solid content amount at which Aa is 1 to 100 is set.

The adsorption rate A_{AC} of the polymer A to the active material AC can be adjusted by incorporating the group included in the above-described group (a) of functional groups or group (a1) of functional groups into the polymer A, and the adsorption rate A_{AC} in the preferred range can be obtained by setting the type of the functional group included in the group (a) of functional groups or group (a1) of functional groups to the above-described preferred group, setting the content of the constitutional component having the functional group to the above-described preferred range, or combining these methods.

In addition, it is preferable that the content of each component is determined while considering the total solid content amount such that the Aa or Ab calculated by the expression 1 or the expression 2 is satisfied. In particular, each of the contents of the active material AC, the inorganic solid electrolyte SE, and the polymer A is appropriately determined from the above-described range of the content for each component while considering the characteristics of each component; but in a case where the contents are set within the above-described preferred ranges, it is easy to adjust Aa calculated by the expression 1 to be within the range of 1 to 100. For example, it is preferable that the content of the polymer A is set to be low, and in this case, the values Aa and Ab calculated by the expression 1 and the expression 2 can be reduced.

The value Ab calculated by the expression 2 can also be adjusted to be within the range of 2 to 500 in the same manner as Aa calculated by the expression 1. Preferably, for example, (1) the specific surface area of the inorganic solid electrolyte SE to be used is measured, and the content of the inorganic solid electrolyte SE/total solid content amount is set (setting of the total specific surface area of the inorganic solid electrolyte SE). Next, (2-1) for example, in a case where the content of the polymer A/total solid content amount is determined to be 0.005, the polymer A showing the adsorption rate to the inorganic solid electrolyte SE, at which Ab is b to 50, and the weight-average molecular weight is selected. On the other hand, (2-2) in a case where the polymer A is determined (the adsorption rate to the inorganic solid electrolyte SE and the weight-average molecular weight are selected), the content of the polymer A/total solid content amount at which Ab is 2 to 50 may be set.

[Sheet for all-Solid-State Secondary Battery]

The sheet for an all-solid-state secondary battery according to the embodiment of the present invention is a sheet-shaped molded body with which a constituent layer of an all-solid-state secondary battery can be formed, and it includes various aspects depending on use applications thereof. Examples of thereof include a sheet which is preferably used in a solid electrolyte layer (also referred to as a solid electrolyte sheet for an all-solid-state secondary battery) and a sheet which is preferably used in an electrode or a laminate of an electrode and a solid electrolyte layer (also referred to as an electrode sheet for an all-solid-state secondary battery). In the present invention, the variety of sheets described above will be collectively referred to as a sheet for an all-solid-state secondary battery.

In the present invention, each layer constituting the sheet for an all-solid-state secondary battery may have a monolayer structure or a multilayer structure.

In the sheet for an all-solid-state secondary battery, the solid electrolyte layer or the active material layer on a substrate is formed of the composition for an all-solid-state secondary battery according to the embodiment of the present invention. Therefore, the layer formed of the composition for an all-solid-state secondary battery according to the embodiment of the present invention is formed of components derived from the composition for an all-solid-state secondary battery (excluding the dispersion medium), and the solid particles are adhered or bonded. It is presumed that the layer formed of the composition for an all-solid-state secondary battery according to the embodiment of the present invention has an improved dispersion state of the solid particles (the inorganic solid electrolyte SE, the active material AC as necessary, and the conductive auxiliary agent as appropriate) and the polymer A, and is dispersed or present in a state in which the solid particles and the polymer A are substantially uniformly mixed.

In the sheet for an all-solid-state secondary battery according to the embodiment of the present invention, at least one layer of the solid electrolyte layer or the active material layer is formed of the composition for an all-solid-state secondary battery according to the embodiment of the present invention. Therefore, the sheet for an all-solid-state secondary battery according to the embodiment of the present invention includes a constituent layer in which the dispersion state of the solid particles is improved. By using the constituent layer as the constituent layer of the all-solid-state secondary battery, excellent battery performance of the all-solid-state secondary battery, for example, rate characteristics and battery service life can be realized.

As described above, the sheet for an all-solid-state secondary battery according to the embodiment of the present invention is suitably used as a sheet-shaped member which forms the constituent layer of the all-solid-state secondary battery. The sheet for an all-solid-state secondary battery is appropriately peeled off the substrate to be used as a constituent layer or is incorporated into the all-solid-state secondary battery as an electrode (laminate of a collector and an active material layer) in a state of including the substrate.

(Solid Electrolyte Sheet for all-Solid-State Secondary Battery)

It is sufficient that the solid electrolyte sheet for an all-solid-state secondary battery (simply referred to as “solid electrolyte sheet”) according to the embodiment of the present invention is a sheet including the solid electrolyte layer, and it may be a sheet in which a solid electrolyte layer is formed on a substrate or may be a sheet (sheet from which the substrate has been peeled off) which is formed of the solid electrolyte layer without including a substrate. The solid electrolyte sheet for an all-solid-state secondary battery may include other layers in addition to the solid electrolyte layer. Examples of the other layers include a protective layer (peeling sheet), a collector, and a coating layer. The solid electrolyte layer included in the solid electrolyte sheet for an all-solid-state secondary battery is preferably formed of the composition for an all-solid-state secondary battery (inorganic solid electrolyte-containing composition) according to the embodiment of the present invention. A content of each component in the solid electrolyte layer is not particularly limited, but it preferably has the same meaning as the content of each component in the solid content of the composition for an all-solid-state secondary battery according to the embodiment of the present invention. A layer thickness of each layer constituting the solid electrolyte sheet for an all-solid-state secondary battery is the same as a layer thickness of each layer in the all-solid-state secondary battery, which will be described later.

Examples of the solid electrolyte sheet for an all-solid-state secondary battery according to the embodiment of the present invention include a sheet including a layer formed of the composition for an all-solid-state secondary battery according to the embodiment of the present invention, a typical solid electrolyte layer, and a protective layer on a substrate in this order.

The substrate is not particularly limited as long as it can support the solid electrolyte layer, and examples thereof include a sheet body (plate-shaped body) formed of materials described later regarding a collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

(Electrode Sheet for all-Solid-State Secondary Battery)

It is sufficient that the electrode sheet for an all-solid-state secondary battery according to the embodiment of the present invention (simply also referred to as “electrode sheet”) is an electrode sheet including the active material layer, and it may be a sheet in which the active material layer is formed on a substrate (collector) or may be a sheet (sheet from which the substrate has been peeled off) which is formed of the active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. At least one layer of the solid electrolyte layer and the active material layer, which are included in the electrode sheet, is formed of the composition for an all-solid-state secondary battery according to the embodiment of the present invention (the inorganic solid electrolyte-containing composition or the electrode composition). A content of each component in the layer formed of the composition for an all-solid-state secondary battery according to the embodiment of the present invention is not particularly limited, but it preferably has the same meaning as the content of each component in the solid content of the composition for an all-solid-state secondary battery according to the embodiment of the present invention. A layer thickness of each layer constituting the electrode sheet according to the embodiment of the present invention is the same as the layer thickness of each layer in the all-solid-state secondary battery, which will be described later. The electrode sheet may include the above-described other layers.

In a case where the solid electrolyte layer or the active material layer is not formed of the composition for an all-solid-state secondary battery according to the embodiment of the present invention, it is formed of a general constituent layer-forming material.

[Manufacturing Method of Sheet for all-Solid-State Secondary Battery]

A manufacturing method of the sheet for an all-solid-state secondary battery according to the embodiment of the present invention is not particularly limited, and the sheet can be manufactured by forming an inorganic solid electrolyte layer or an active material layer using the composition for an all-solid-state secondary battery according to the embodiment of the present invention. Examples thereof include a method in which film formation (coating and drying) is carried out preferably on a substrate or a collector (another layer may be interposed) to form a layer (coated and dried layer) consisting of the composition for an all-solid-state secondary battery. As a result, it is possible to produce a sheet for an all-solid-state secondary battery, having the substrate or the collector and having the coated and dried layer. Here, the coated and dried layer refers to a layer formed by carrying out coating with the composition for an all-solid-state secondary battery according to the embodiment of the present invention and drying the dispersion medium D (that is, a layer formed of the composition for an all-solid-state secondary battery according to the embodiment of the present invention and consisting of a composition obtained by removing the dispersion medium D from the composition for an all-solid-state secondary battery according to the embodiment of the present invention). In the coated and dried layer and the constituent layer, the dispersion medium may remain within a range in which the effect of the present invention is not impaired, and a residual amount thereof in each of the layers may be, for example, 3% by mass or less.

In the manufacturing method of the sheet for an all-solid-state secondary battery according to the embodiment of the present invention, each of the steps such as coating and drying will be described in the manufacturing method of the all-solid-state secondary battery.

In this way, the sheet for an all-solid-state secondary battery, having a constituent layer produced by appropriately pressurizing and processing the coated and dried layer, can be manufactured. The pressurizing condition and the like will be described later in the section of the manufacturing method of the all-solid-state secondary battery.

In addition, in the manufacturing method of the sheet for an all-solid-state secondary battery according to the embodiment of the present invention, the substrate, the protective layer (particularly the peeling sheet), or the like can also be peeled off.

[all-Solid-State Secondary Battery]

The all-solid-state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid-state secondary battery according to the embodiment of the present invention is not particularly limited in the configuration as long as it includes the solid electrolyte layer between the positive electrode active material layer and the negative electrode active material layer, and for example, a known configuration which relates to the all-solid-state secondary battery can be employed. A positive electrode collector is preferably laminated on a surface of the positive electrode active material layer opposite to the solid electrolyte layer to constitute a positive electrode; and a negative electrode collector is preferably laminated on a surface of the negative electrode active material layer opposite to the solid electrolyte layer to constitute a negative electrode. In the present invention, each constituent layer (including the collector layer and the like) constituting the all-solid-state secondary battery may have a monolayer structure or a multilayer structure.

In the all-solid-state secondary battery according to the embodiment of the present invention, at least one layer of the negative electrode active material layer, the positive electrode active material layer, or the solid electrolyte layer is formed of the composition for an all-solid-state secondary battery according to the embodiment of the present invention. In addition, it is also one of the preferred aspects that at least one of the negative electrode active material layer or the positive electrode active material layer is formed of the composition for an all-solid-state secondary battery according to the embodiment of the present invention, and in this aspect, it is more preferable that at least the negative electrode active material layer is formed of the composition for an all-solid-state secondary battery according to the embodiment of the present invention. In the present invention, an aspect in which all of the layers are formed of the composition for an all-solid-state secondary battery according to the embodiment of the present invention is also one of preferred aspects. In the present invention, forming the constituent layer of the all-solid-state secondary battery using the composition for an all-solid-state secondary battery according to the embodiment of the present invention includes an aspect in which the constituent layer is formed using the sheet for an all-solid-state secondary battery according to the embodiment of the present invention (however, in a case where a layer other than the layer formed of the composition for an all-solid-state secondary battery according to the embodiment of the present invention is provided, a sheet from which the layer is removed). The all-solid-state secondary battery according to the present invention, in which at least one constituent layer is formed of the composition for an all-solid-state secondary battery according to the embodiment of the present invention, exhibits excellent battery performance.

In a case where the active material layer is not formed of the electrode composition according to the embodiment of the present invention, the active material layer and the solid electrolyte layer can be manufactured using known materials.

In the present invention, each constituent layer (including the collector layer and the like) constituting the all-solid-state secondary battery may have a monolayer structure or a multilayer structure.

### <Positive Electrode Active Material Layer, Solid Electrolyte Layer, and Negative Electrode Active Material Layer>

In the active material layer or the solid electrolyte layer formed of the composition for an all-solid-state secondary battery according to the embodiment of the present invention, the kinds of components to be contained and the contents thereof are preferably the same as those for the composition for an all-solid-state secondary battery according to the embodiment of the present invention with respect to the solid content.

A thickness of each of the negative electrode active material layer, the solid electrolyte layer, and the positive electrode active material layer is not particularly limited. The thickness of each of the layers is preferably 10 to 1,000 μm, and in a case of taking a dimension of a general all-solid-state secondary battery into account, it is more preferably 20 μm or more and less than 500 μm. In the all-solid-state secondary battery according to the embodiment of the present invention, the thickness of at least one layer of the positive electrode active material layer or the negative electrode active material layer is still more preferably 50 μm or more and less than 500 μm.

### <Collector>

Each of the positive electrode active material layer and the negative electrode active material layer may include a collector on a side opposite to the solid electrolyte layer. The positive electrode collector and the negative electrode collector are preferably an electron conductor.

In the present invention, any one of the positive electrode collector or the negative electrode collector, or collectively both of them may be simply referred to as a collector.

As a material which forms the positive electrode collector, aluminum, an aluminum alloy, stainless steel, nickel, titanium, or a material (material on which a thin film has been formed) obtained by treating the surface of aluminum or stainless steel with carbon, nickel, titanium, or silver is preferable, and among these, aluminum or an aluminum alloy is more preferable.

As a material which forms the negative electrode collector, aluminum, copper, a copper alloy, stainless steel, nickel, titanium, or a material obtained by treating the surface of aluminum, copper, a copper alloy, or stainless steel with carbon, nickel, titanium, or silver is preferable, and aluminum, copper, a copper alloy, or stainless steel is more preferable.

Regarding a shape of the collector, a film sheet shape is typically used, but it is also possible to use a collector having a shape a net shape or a punched shape, or a collector of a lath body, a porous body, a foaming body, a molded body of a fiber group, or the like.

A thickness of the collector is not particularly limited, but it is preferably 1 to 500 μm. In addition, protrusions and recesses are preferably provided on a surface of the collector by performing a surface treatment.

### <Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### <Housing>

Depending on the use application, the all-solid-state secondary battery according to the embodiment of the present invention may be used as the all-solid-state secondary battery having the above-described structure as it is, but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

### Preferred Embodiment of All-Solid-State Secondary Battery

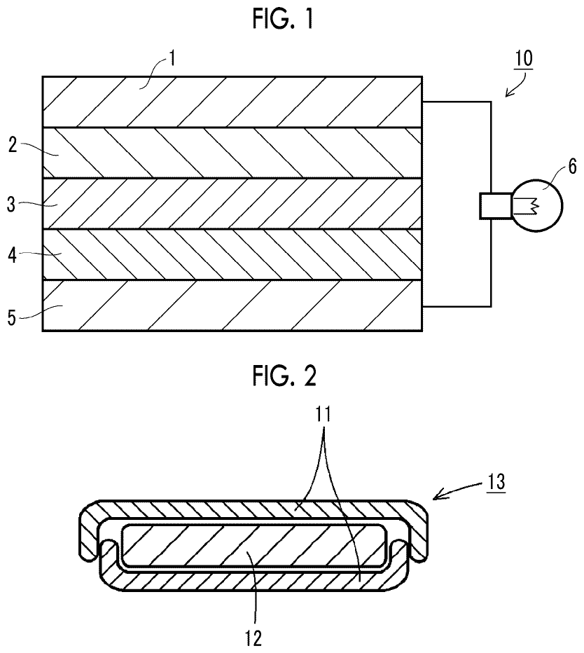

Hereinafter, the all-solid-state secondary battery according to the preferred embodiment of the present invention will be described with reference to FIG. 1, but the present invention is not limited thereto.

FIG. 1 is a cross-sectional view schematically showing the all-solid-state secondary battery (lithium ion secondary battery) according to the preferred embodiment of the present invention. In a case of being viewed from the negative electrode side, an all-solid-state secondary battery 10 according to the present embodiment includes a negative electrode collector 1, a negative electrode active material layer 2, a solid electrolyte layer 3, a positive electrode active material layer 4, and a positive electrode collector 5 in this order. The respective layers are in contact with each other to form an adjacent structure. By adopting such a structure, during charging, electrons (e⁻) are supplied to the negative electrode side, and lithium ions (Li⁺) are accumulated in the negative electrode. On the other hand, during discharging, lithium ions (Li⁺) accumulated in the negative electrode are returned to the positive electrode side, and electrons are supplied to an operation portion 6. In the illustrated example, an electric bulb is employed as a model of the operation portion 6, and is lit by the discharging.

In a case where the all-solid-state secondary battery having the layer configuration shown in FIG. 1 is put into a 2032-type coin case 11 (for example, see FIG. 2), the all-solid-state secondary battery will be referred to as a laminate 12 for an all-solid-state secondary battery, and a battery produced by putting the laminate 12 for an all-solid-state secondary battery into a 2032-type coin case 11 will be referred to as a (coin-type) all-solid-state secondary battery 13, thereby referring to both batteries distinctively in some cases.

### (Positive Electrode Active Material Layer, Solid Electrolyte Layer, and Negative Electrode Active Material Layer)

In the all-solid-state secondary battery 10, all of the positive electrode active material layer 4, the solid electrolyte layer 3, and the negative electrode active material layer 2 are formed of the composition for an all-solid-state secondary battery according to the embodiment of the present invention. The kinds of the inorganic solid electrolyte SE and the polymer A, which are contained in the positive electrode active material layer 4, the solid electrolyte layer 3, and the negative electrode active material layer 2, may be the same or different from each other. In addition, the kinds of the conductive auxiliary agents contained in the positive electrode active material layer 4 and the negative electrode active material layer 2 may be the same or different from each other.

The solid electrolyte layer contains an inorganic solid electrolyte SE having conductivity of an ion of a metal belonging to Group 1 or Group 2 in the periodic table, the polymer A, any component described above, and the like within a range not impairing the effect of the present invention, and it generally does not contain a positive electrode active material and/or a negative electrode active material.

The positive electrode active material layer contains the inorganic solid electrolyte SE having ionic conductivity of a metal belonging to Group 1 or Group 2 in the periodic table, a positive electrode active material, the polymer A, preferably the conductive auxiliary agent, any component described above, and the like within a range not impairing the effect of the present invention.

The negative electrode active material layer contains the inorganic solid electrolyte SE having ionic conductivity of a metal belonging to Group 1 or Group 2 in the periodic table, a negative electrode active material, the polymer A, preferably the conductive auxiliary agent, any component described above, and the like within a range not impairing the effect of the present invention. In the all-solid-state secondary battery 10, the negative electrode active material layer may be a lithium metal layer. Examples of the lithium metal layer include a layer formed by depositing or molding a lithium metal powder, a lithium foil, and a lithium vapor-deposited film. A thickness of the lithium metal layer can be, for example, 1 to 500 μm regardless of the thickness of the negative electrode active material layer described above.

In the present invention, in a case where the constituent layer is formed of the composition for an all-solid-state secondary battery according to the embodiment of the present invention, an all-solid-state secondary battery having excellent battery performance such as life characteristics, output, and rate characteristics can be realized.

### (Collector)

The positive electrode collector 5 and the negative electrode collector 1 are as described above.

In a case where the all-solid-state secondary battery 10 has a constituent layer other than the constituent layer formed of the composition for an all-solid-state secondary battery according to the embodiment of the present invention, a layer formed of a known constituent layer-forming material can also be applied.

In addition, each layer may be composed of a single layer or may be composed of multiple layers.

[Manufacturing of all-Solid-State Secondary Battery]

The all-solid-state secondary battery according to the embodiment of the present invention can be manufactured according to a conventional method using the composition for an all-solid-state secondary battery according to the embodiment of the present invention. For example, the all-solid-state secondary battery can be manufactured by forming at least one constituent layer using the composition for an all-solid-state secondary battery according to the embodiment of the present invention, or the like. Specifically, the all-solid-state secondary battery according to the embodiment of the present invention can be manufactured by performing a method (manufacturing method of the sheet for a non-aqueous secondary battery according to the embodiment of the present invention) which includes (is carried out through) a step of coating an appropriate substrate (for example, a metal foil which serves as a collector) with the composition for an all-solid-state secondary battery according to the embodiment of the present invention and forming a coating film (forming a film).

More specifically, a composition for an all-solid-state secondary battery containing a positive electrode active material is applied and dried as a material for a positive electrode (positive electrode composition) onto a metal foil which is a positive electrode collector to form a positive electrode active material layer, thereby producing a positive electrode sheet for a non-aqueous secondary battery. Next, the composition for an all-solid-state secondary battery (inorganic solid electrolyte-containing composition), which is used for forming a solid electrolyte layer, is applied and dried onto the positive electrode active material layer to form the solid electrolyte layer. Furthermore, a composition for an all-solid-state secondary battery containing a negative electrode active material is applied and dried as a negative electrode material (negative electrode composition) onto the solid electrolyte layer to form a negative electrode active material layer. A negative electrode collector (a metal foil) is superposed on the negative electrode active material layer, whereby it is possible to obtain an all-solid-state secondary battery having a structure in which the solid electrolyte layer is sandwiched between the positive electrode active material layer and the negative electrode active material layer. A desired all-solid-state secondary battery can also be manufactured by sealing the all-solid-state secondary battery in a housing.

In addition, it is also possible to manufacture an all-solid-state secondary battery by performing the forming method of each layer in reverse order to form the negative electrode active material layer, the solid electrolyte layer, and the positive electrode active material layer on the negative electrode collector, and then superposing the positive electrode collector thereon.

As another method, the following method can be exemplified. That is, a positive electrode sheet for an all-solid-state secondary battery is produced as described above. In addition, a composition for an all-solid-state secondary battery containing a negative electrode active material is applied and dried as a negative electrode material (negative electrode composition) onto a metal foil which is a negative electrode collector to form a negative electrode active material layer, thereby producing a negative electrode sheet for a non-aqueous secondary battery. Next, a solid electrolyte layer is formed on the active material layer in any one of these sheets as described above. Furthermore, the other of the positive electrode sheet for an all-solid-state secondary battery and the negative electrode sheet for an all-solid-state secondary battery is laminated on the solid electrolyte layer such that the solid electrolyte layer and the active material layer come into contact with each other. In this manner, an all-solid-state secondary battery can be manufactured.

In addition, as still another method, the following method can be exemplified. That is, the positive electrode sheet for an all-solid-state secondary battery and the negative electrode sheet for an all-solid-state secondary battery are produced as described above. In addition, separately from the positive electrode sheet for an all-solid-state secondary battery and the negative electrode sheet for an all-solid-state secondary battery, the composition for an all-solid-state secondary battery is applied and dried onto a substrate, thereby producing a solid electrolyte sheet for an all-solid-state secondary battery consisting of the solid electrolyte layer. Furthermore, the positive electrode sheet for an all-solid-state secondary battery and the negative electrode sheet for an all-solid-state secondary battery are laminated such that the solid electrolyte layer removed from the substrate is sandwiched therebetween. In this manner, an all-solid-state secondary battery can be manufactured.

Furthermore, the positive electrode sheet for an all-solid-state secondary battery, the negative electrode sheet for an all-solid-state secondary battery, and the solid electrolyte sheet for an all-solid-state secondary battery are produced as described above. Next, the positive electrode sheet for an all-solid-state secondary battery or the negative electrode sheet for an all-solid-state secondary battery, and the solid electrolyte sheet for an all-solid-state secondary battery are superimposed and pressurized into a state in which the positive electrode active material layer or the negative electrode active material layer is brought into contact with the solid electrolyte layer. In this manner, the solid electrolyte layer is transferred to the positive electrode sheet for an all-solid-state secondary battery or the negative electrode sheet for an all-solid-state secondary battery. Thereafter, the solid electrolyte layer from which the substrate of the solid electrolyte sheet for an all-solid-state secondary battery has been peeled off and the negative electrode sheet for an all-solid-state secondary battery or the positive electrode sheet for an all-solid-state secondary battery are superimposed and pressurized (into a state in which the negative electrode active material layer or the positive electrode active material layer is brought into contact with the solid electrolyte layer). In this manner, an all-solid-state secondary battery can be manufactured. The pressurizing method and the pressurizing conditions in the method are not particularly limited, and a method and pressurizing conditions described in the pressurization step, which will be described later, can be adopted.

The solid electrolyte layer and the like can also be formed by, for example, pressurizing and molding the composition for an all-solid-state secondary battery or the like on a substrate or an active material layer under pressurizing conditions described later.

In the above-described manufacturing method, it is sufficient that the composition for an all-solid-state secondary battery according to the embodiment of the present invention is used in any one of the positive electrode composition, the inorganic solid electrolyte-containing composition, or the negative electrode composition. The composition for an all-solid-state secondary battery according to the embodiment of the present invention is preferably used in at least one of the positive electrode composition or the negative electrode composition, and the composition for an all-solid-state secondary battery according to the embodiment of the present invention can be used in any of the compositions.

In a case where the solid electrolyte layer or the active material layer is formed of a composition other than the composition for an all-solid-state secondary battery according to the embodiment of the present invention, examples thereof include a typically used composition. In addition, the negative electrode active material layer can also be formed by bonding ions of a metal belonging to Group 1 or Group 2 in the periodic table, which are accumulated on a negative electrode collector during initialization described later or during charging for use, without forming the negative electrode active material layer during the manufacturing of the all-solid-state secondary battery to electrons and precipitating the ions on the negative electrode collector and the like as a metal.

### <Formation (Film Formation) of Each Layer>

A coating method of the composition for an all-solid-state secondary battery is not particularly limited and can be appropriately selected. Examples thereof include coating methods (preferably wet-type coating methods) such as spray coating, spin coating, dip coating, slit coating, stripe coating, and bar coating. A coating temperature is not particularly limited, and examples thereof include a temperature range of usually room temperature (for example, 15° C. to 30° C.) under non-heating.

The applied composition for an all-solid-state secondary battery is subjected to a drying treatment (heating treatment). The drying treatment may be performed after applying each composition, or may be performed after multilayer coating with a plurality of compositions. A drying temperature is not particularly limited. The lower limit thereof is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the composition is heated in the above-described temperature range, the dispersion medium D can be removed and the layer can be made into a solid state (coated and dried layer). The temperature range is preferable since the temperature is not excessively increased and each member of the all-solid-state secondary battery is not impaired. As a result, excellent overall performance is exhibited in the all-solid-state secondary battery, and it is possible to obtain favorable bonding property and favorable ion conductivity. A drying time of the applied composition for an all-solid-state secondary battery is appropriately determined according to the application amount, the application area, and the like, but can be shortened with the composition for an all-solid-state secondary battery having a high concentration, and can be, for example, 10 minutes or less.

### <Formation (Film Formation) of Each Layer>

After applying and drying the composition for an all-solid-state secondary battery, it is preferable to pressurize each layer or the all-solid-state secondary battery after superimposing the constituent layers or producing the all-solid-state secondary battery. In addition, it is also preferable that each of the layers is pressurized together in a state of being laminated. Examples of the pressurizing method include a method using a hydraulic cylinder press machine. A pressurizing force is not particularly limited, but it is generally preferably in a range of 5 to 1,500 MPa.

In addition, the pressurization and the heating of the applied composition for an all-solid-state secondary battery may be performed at the same time. A heating temperature is not particularly limited, but is generally in a range of 30° C. to 300° C. The pressing can also be applied at a temperature higher than a glass transition temperature of the inorganic solid electrolyte. The pressing can also be applied at a temperature higher than a glass transition temperature of the polymer A. However, the temperature is generally a temperature not exceeding a melting point of the polymer A.

The pressurization may be carried out in a state in which the coating solvent or the dispersion medium has been dried in advance or in a state in which the solvent or the dispersion medium remains.

The respective compositions may be applied at the same time, and the application, the drying, and the pressing may be carried out simultaneously and/or sequentially. Each of the compositions may be applied onto each of the separate substrates, and then laminated by carrying out the transfer.

The atmosphere in the film forming method (coating, drying, and pressurization (under heating) is not particularly limited, and may be any atmosphere such as atmospheric air, dry air (dew point of −20° C. or lower), or inert gas (for example, an argon gas, a helium gas, or a nitrogen gas).

A pressurization time may be a short time (for example, within several hours) under the application of a high pressure, or a long time (one day or longer) under the application of an intermediate pressure. In a case of members other than the sheet for an all-solid-state secondary battery, for example, the all-solid-state secondary battery, it is also possible to use a restraining tool (screw fastening pressure or the like) of the all-solid-state secondary battery in order to continuously apply an intermediate pressure. A pressing pressure may be a pressure that is uniform or varies with respect to a portion under pressure such as a sheet surface. The pressing pressure may be changed according to the area or the film thickness of the portion under pressure. In addition, the pressure may also be variable stepwise for the same portion. A pressing surface may be flat or roughened.

In the manufacturing of the sheet for an all-solid-state secondary battery and the all-solid-state secondary battery, in a case where the composition for an all-solid-state secondary battery according to the embodiment of the present invention, particularly the composition for an all-solid-state secondary battery having a high concentration, is used, the drying time after coating can be set to be short, and the volatilization amount of the dispersion medium can be reduced; and as a result, the productivity can be improved, the environmental load can be reduced, and the manufacturing cost can be reduced. Therefore, the composition for an all-solid-state secondary battery according to the embodiment of the present invention is also useful from the viewpoint of industrial manufacturing of the sheet for an all-solid-state secondary battery and the all-solid-state secondary battery.

### <Initialization>

The all-solid-state secondary battery manufactured as described above is preferably initialized after the manufacturing or before use. The initialization is not particularly limited, and it is possible to initialize the all-solid-state secondary battery by, for example, carrying out initial charging and discharging in a state in which the pressing pressure is increased and then releasing the pressure until it reaches a general working pressure of the all-solid-state secondary battery.

[Use Application of all-Solid-State Secondary Battery]

The all-solid-state secondary battery according to the embodiment of the present invention can be applied to a variety of use applications. The application aspect is not particularly limited, and in a case of being mounted in an electronic apparatus, examples thereof include a notebook computer, a pen input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. In addition, in a case of being used for consumer applications, examples thereof include an automobile (electric vehicle and the like), an electric vehicle, a motor, a lighting instrument, a toy, a game device, a road conditioner, a watch, a strobe, a camera, and a medical device (a pacemaker, a hearing aid, a shoulder massage device, and the like). Furthermore, the non-aqueous electrolytic solution secondary can be used for various military usages and universe usages. In addition, the secondary battery according to the embodiment of the present invention can also be combined with a solar cell.

### EXAMPLES

Hereinafter, the present invention will be described in more detail based on Examples, but the present invention is not limited thereto be interpreted. “Part” and “%” that represent compositions in the following Examples are based on the mass unless particularly otherwise described. In the present invention, “room temperature” means 25° C.

In Examples, Table 1-1 and Table 1-2 are collectively referred to as “Table 1”, and Table 2-1 and Table 2-2 are collectively referred to as “Table 2”.

1. Synthesis of polymer A

The following polymer was synthesized as the polymer A shown in the chemical formula described above.

### Synthesis Example A-1: Synthesis of Polymer A-1

9.5 g of methyl methacrylate (manufactured by Tokyo Chemical Industry Co., Ltd.), 90.0 g of dodecyl acrylate (manufactured by Tokyo Chemical Industry Co., Ltd.), 0.5 g of maleic acid anhydride, and 3.6 g of a polymerization initiator V-601 (product name, manufactured by FUJIFILM Wako Pure Chemical Corporation) were charged into a 200 mL volumetric flask, and the mixture was dissolved in 70 g of diisobutyl ketone (DIBK) to prepare a monomer solution. 40 g of DIBK was added to a 500 mL three-neck flask and then stirred at 80° C., and the above-described monomer solution was added dropwise thereto over 2 hours. After the completion of the dropwise addition, the mixture was heated to 90° C. and stirred for 2 hours. The obtained solution was dried to synthesize a polymer A-1 (acrylic polymer) having a weight-average molecular weight of 1.6×10⁴ by the above-described measurement method.

In addition, the amount of the polymerization initiator V-601 (product name, manufactured by FUJIFILM Wako Pure Chemical Corporation) was appropriately changed to synthesize a polymer A-1 having a weight-average molecular weight of 6.0×10³, 1.2×10⁵, 2.0 ×105, or 4.0×10⁵ by the above-described measurement method.

### Synthesis Example A-2: Synthesis of Polymer A-2

100 g of ion exchange water, 48 g of vinylidene fluoride, 30 g of hexafluoropropene, and 22 g of tetrafluoroethylene were added to an autoclave, 1 g of a polymerization initiator PEROYL IPP (product name, chemical name: diisopropyl peroxydicarbonate, manufactured by NOF CORPORATION) was further added thereto, and the mixture was stirred at 40° C. for 24 hours. After the stirring, the precipitate was filtered and dried at 100° C. for 10 hours.

In this way, a polymer A-2 (a random copolymer of fluoropolymer) having a weight-average molecular weight of 8.0×10⁵ by the above-described measurement method was synthesized.

In addition, the amounts of the polymerization initiator and the ion exchange water were changed to synthesize a polymer A-2 having a weight-average molecular weight of 6.0×10⁴ or 4.0×10⁵ by the above-described measurement method.

### Synthesis Example A-3: Synthesis of Polymer A-3

A polymer A-3 (acrylic polymer) having a weight-average molecular weight of 1.6×10⁴ by the above-described measurement method was synthesized in the same manner as in Synthesis Example A-1, except that, in Synthesis Example A-1, a compound which derives each constitutional component to have the structure shown in the above chemical formula was used instead of the methyl methacrylate, and the amount of the polymerization initiator V-601 (product name, manufactured by FUJIFILM Wako Pure Chemical Corporation) was appropriately changed to adjust the molecular weight.

In addition, in Synthesis Example A-3, the amounts of the polymerization initiator and the ion exchange water were changed to synthesize a polymer A-3 having a weight-average molecular weight of 8.0×10³ or 4.0×10⁵ by the above-described measurement method.

### Synthesis Example A-5: Synthesis of Polymer A-5

300 g of cyclohexane as a solvent and 2.0 mL of sec-butyl lithium (1.3 M, manufactured by FUJIFILM Wako Pure Chemical Corporation) as a polymerization initiator were charged into a pressure-resistant container which had been subjected to nitrogen replacement and drying; after heating to 50° C., 31 g of styrene was added thereto to carry out polymerization for 2 hours; 48 g of 1,3-butadiene and 90 g of ethylene were subsequently added thereto to carry out polymerization for 3 hours; and then 31 g of styrene was added thereto to carry out polymerization for 2 hours. 3 parts by mass of 2,6-di-t-butyl-p-cresol was added to 100 parts by mass of a polymer obtained by reprecipitating the obtained solution in methanol and drying the obtained solid, and the mixture was reacted at 180° C. for 5 hours. The obtained solution was reprecipitated in acetonitrile, and the obtained solid was dried at 80° C. to obtain a polymer (dry solid). Thereafter, in a pressure-resistant container, the entire amount of the polymer obtained as described above was dissolved in 400 parts by mass of cyclohexane, 5% by mass of palladium carbon (palladium carrying amount: 5% by mass) with respect to the polymer was added thereto as a hydrogenation catalyst, and the mixture was reacted under conditions of a hydrogen pressure of 2 MPa and 150° C. for 10 hours. After cooling and depressurization, the palladium carbon was removed by filtration, and the filtrate was concentrated and further vacuum-dried to synthesize a polymer A-5 (hydrocarbon polymer) having a weight-average molecular weight of 1.0×10⁵ by the above-described measurement method.

### Synthesis Example A-6: Synthesis of Polymer A-6

A polymer A-6 (acrylic polymer) having a weight-average molecular weight of 1.2×10⁴ by the above-described measurement method was synthesized in the same manner as in Synthesis Example A-1, except that, in Synthesis Example A-1, a compound which derives each constitutional component to have the structure and formulation (content of the constitutional component) shown in the above chemical formula was used, and the amount of the polymerization initiator V-601 (product name, manufactured by FUJIFILM Wako Pure Chemical Corporation) was appropriately changed to adjust the molecular weight.

### Synthesis Example A-8: Synthesis of Polymer A-8

A polymer A-8 (vinyl polymer) having a weight-average molecular weight of 1.0×10⁵ by the above-described measurement method was synthesized in the same manner as in Synthesis Example A-1, except that, in Synthesis Example A-1, 33 g of butyl acrylate and 67 g of styrene were used instead of the methyl methacrylate, the dodecyl acrylate, and the maleic acid anhydride, and the amount of the polymerization initiator V-601 (product name, manufactured by FUJIFILM Wako Pure Chemical Corporation) was appropriately changed to adjust the molecular weight.

### Synthesis Example A-9: Synthesis of Polymer A-9

A polymer A-9 (acrylic polymer) having a weight-average molecular weight of 1.5×10⁵ by the above-described measurement method was synthesized in the same manner as in Synthesis Example A-1, except that, in Synthesis Example A-1, a compound which derives each constitutional component to have the structure and formulation (content of the constitutional component) shown in the above chemical formula was used, and the amount of the polymerization initiator V-601 (product name, manufactured by FUJIFILM Wako Pure Chemical Corporation) was appropriately changed to adjust the molecular weight.

In addition, the amount of the polymerization initiator V-601 was changed to synthesize a polymer A-9 having a weight-average molecular weight of 8.0×10⁵ by the above-described measurement method.

### Synthesis Example A-10: Synthesis of Polymer A-10

A polymer A-10 (acrylic polymer) having a weight-average molecular weight of 4.0×10⁵ by the above-described measurement method was synthesized in the same manner as in Synthesis Example A-1, except that, in Synthesis Example A-1, a compound which derives each constitutional component to have the structure and formulation (content of the constitutional component) shown in the above chemical formula was used, and the amount of the polymerization initiator V-601 (product name, manufactured by FUJIFILM Wako Pure Chemical Corporation) was appropriately changed to adjust the molecular weight.

### Synthesis Example A-13: Synthesis of Polymer A-13

A polymer A-13 (acrylic polymer) having a weight-average molecular weight of 1.2×10⁴ by the above-described measurement method was synthesized in the same manner as in Synthesis Example A-1, except that, in Synthesis Example A-1, a compound which derives each constitutional component to have the structure and formulation (content of the constitutional component) shown in the above chemical formula was used, and the amount of the polymerization initiator V-601 (product name, manufactured by FUJIFILM Wako Pure Chemical Corporation) was appropriately changed to adjust the molecular weight.

### Synthesis Example A-14: Synthesis of Polymer A-14

A polymer A-14 (acrylic polymer) having a weight-average molecular weight of 4.0×10⁵ by the above-described measurement method was synthesized in the same manner as in Synthesis Example A-1, except that, in Synthesis Example A-1, a compound which derives each constitutional component to have the structure and formulation (content of the constitutional component) shown in the above chemical formula was used, and the amount of the polymerization initiator V-601 (product name, manufactured by FUJIFILM Wako Pure Chemical Corporation) was appropriately changed to adjust the molecular weight.

### Synthesis Example A-15: Synthesis of Polymer A-15

First, 14 g of KF-2012 (product name, manufactured by Shin-Etsu Chemical Co., Ltd.), 6 g of benzyl methacrylate, and 2.7 g of a polymerization initiator V-601 (product name, manufactured by FUJIFILM Wako Pure Chemical Corporation) were charged into a 200 mL graduated cylinder, and the mixture was dissolved in 100 g of butyl butyrate to prepare a monomer solution.

Next, 300 g of butyl butyrate was charged into a 1000 mL three-neck flask, and stirred at 85° C. under a nitrogen stream. Next, the above-described monomer solution was added dropwise thereto over 2 hours, and after the dropwise addition was completed, the temperature was raised to 90° C. and the mixture was stirred for 2 hours. The obtained polymerization solution was poured into 800 g of methanol, stirred for 10 minutes, and allowed to stand for 10 minutes. The precipitate obtained after removing the supernatant was dissolved in 60 g of butyl butyrate and heated at 30 hPa and 80° C. for 1 hour to distill off methanol.

In this way, a polymer A-15 (a random copolymer of acrylic polymer) having a weight-average molecular weight of 1.1×10⁴ by the above-described measurement method was synthesized.

In addition, the amount of the polymerization initiator V-601 was changed to synthesize a polymer A-15 having a weight-average molecular weight of 1.4×10⁴ by the above-described measurement method.

### Synthesis Example A-16: Synthesis of Polymer A-16

A polymer A-16 (a random copolymer of acrylic polymer) having a weight-average molecular weight of 1.0×10⁴ by the above-described measurement method was obtained in the same manner as in Synthesis Example A-15, except that, in Synthesis Example A-15, a compound which derives each constitutional component to have the formulation (type and content of the constitutional component) shown in the above chemical formula was used in the polymer A-16, and the amount of the polymerization initiator was adjusted to have a weight-average molecular weight shown below.

In addition, the amount of the polymerization initiator V-601 was changed to synthesize a polymer A-16 having a weight-average molecular weight of 1.5×10⁴, 2.0×10⁴, or 1.0×10⁵ by the above-described measurement method.

### Synthesis Example A-17: Synthesis of Polymer A-17

A polymer A-17 (a random copolymer of acrylic polymer) having a weight-average molecular weight of 5.0×10³ by the above-described measurement method was obtained in the same manner as in Synthesis Example A-15, except that, in Synthesis Example A-15, a compound which derives each constitutional component to have the formulation (type and content of the constitutional component) shown in the above chemical formula was used in the polymer A-17, and the amount of the polymerization initiator was adjusted to have a weight-average molecular weight shown below.

In addition, the amount of the polymerization initiator V-601 was changed to synthesize a polymer A-17 having a weight-average molecular weight of 1.0×10⁴ or 2.0×10⁴ by the above-described measurement method.

### Synthesis Example A-18: Synthesis of Polymer A-18

A polymer A-18 (a random copolymer of acrylic polymer) having a weight-average molecular weight of 1.38×10⁴ by the above-described measurement method was obtained in the same manner as in Synthesis Example A-15, except that, in Synthesis Example A-15, a compound which derives each constitutional component to have the formulation (type and content of the constitutional component) shown in the above chemical formula was used in the polymer A-18, and the amount of the polymerization initiator was adjusted to have a weight-average molecular weight shown below.

In addition, the amount of the polymerization initiator V-601 was changed to synthesize a polymer A-18 having a weight-average molecular weight of 7.0×10³ by the above-described measurement method.

### Synthesis Example A-20: Synthesis of Polymer A-20

A polymer A-20 (a random copolymer of acrylic polymer) having a weight-average molecular weight of 1.2×10⁴ by the above-described measurement method was obtained in the same manner as in Synthesis Example A-15, except that, in Synthesis Example A-15, a compound which derives each constitutional component to have the formulation (type and content of the constitutional component) shown in the above chemical formula was used in the polymer A-20, and the amount of the polymerization initiator was adjusted to have a weight-average molecular weight shown below.

In addition, the amount of the polymerization initiator V-601 was changed to synthesize a polymer A-20 having a weight-average molecular weight of 1.0×10⁴ by the above-described measurement method.

### Synthesis Example A-25: Synthesis of Polymer A-25

First, 80.6 g (89.4 mmol) of KF-2012 (product name, molecular weight: 4,600, manufactured by Shin-Etsu Chemical Co., Ltd.) and 0.4 g of a polymerization initiator V-601 (product name, manufactured by FUJIFILM Wako Pure Chemical Corporation) were charged into a 500 mL graduated cylinder, and the mixture was dissolved in 81 g of butyl butyrate to prepare a monomer solution (X).

Next, 152 g of butyl butyrate and 20.0 g (product name: DPMP, manufactured by SAKAI CHEMICAL INDUSTRY CO., LTD., 25.5 mmol) of dipentaerythritol hexakis(3-mercaptopropionate) were charged into a 500 mL three-neck flask, the mixture was stirred at 80° C. under a nitrogen stream, and an initiator solution obtained by mixing and dissolving 0.3 g of a polymerization initiator V-601 and 2 g of butyl butyrate in advance was added thereto. After 10 minutes, the above-described monomer solution (X) was added dropwise thereto over 2 hours. After the dropwise addition was completed, the mixture was stirred at 80° C. for 1 hour, and then the temperature was raised to 90° C. and the mixture was stirred for 2 hours to obtain a polymer solution.

Next, 81.1 g (solid content: 24.3 g) of the polymer solution obtained as described above, 3.5 g (27.5 mmol) of tert-butyl acrylamide (tBuAAm), and 0.1 g of a polymerization initiator V-601 (product name, manufactured by FUJIFILM Wako Pure Chemical Corporation) were charged into a 200 mL graduated cylinder, and the mixture was dissolved in 20 g of N-methyl-2-pyrrolidone to prepare a monomer solution (A). Next, 33 g of butyl butyrate was charged into a 300 mL three-neck flask, the mixture was stirred at 80° C. under a nitrogen stream, and an initiator solution obtained by mixing and dissolving 0.05 g of a polymerization initiator V-601 and 2 g of butyl butyrate in advance was added thereto. Next, the above-described monomer solution (A) was added dropwise thereto over 2 hours after 10 minutes. After the dropwise addition was completed, the mixture was stirred at 80° C. for 2 hours, and then the temperature was raised to 90° C. and the mixture was stirred for 1 hour. The obtained polymerization solution was poured into 800 g of methanol, stirred for 10 minutes, and allowed to stand for 10 minutes. The precipitate obtained after removing the supernatant was dissolved in 60 g of butyl butyrate and heated at 30 hPa and 80° C. for 1 hour to distill off methanol.

In this way, a polymer A-25 of a multibranched polymer having a polymerized chain P^{1X} consisting of a homopolymer of KF-2012 and a polymerized chain p^{1A} consisting of a homopolymer of tBuAAM as a polymeric arm portion was obtained. A weight-average molecular weight of the polymer A-25 by the above-described measurement method was 2.0×10⁴.

In addition, the amount of the polymerization initiator during the polymerization of tBuAAM was changed to synthesize a polymer A-25 having a weight-average molecular weight of 1.8×10⁴ or 2.2×10⁴ by the above-described measurement method.

### Synthesis Example A-26: Synthesis of Polymer A-26

A polymer A-26 of a multibranched polymer was obtained in the same manner as in Synthesis Example A-25, except that, in Synthesis Example A-25, a compound which derives each constitutional component to have the formulation (type and content of the constitutional component and each component of the core portion) shown in the above chemical formula was used in the polymer A-26, and the amount of the polymerization initiator during the polymerization of tBuAAM was adjusted to have a weight-average molecular weight shown below. A weight-average molecular weight of the polymer A-26 by the above-described measurement method was 2.0×10⁴.

Polymers shown in the following chemical formulae were synthesized as follows.

In the following chemical formulae, a number described in the lower right of each constitutional component indicates a content (% by mass).

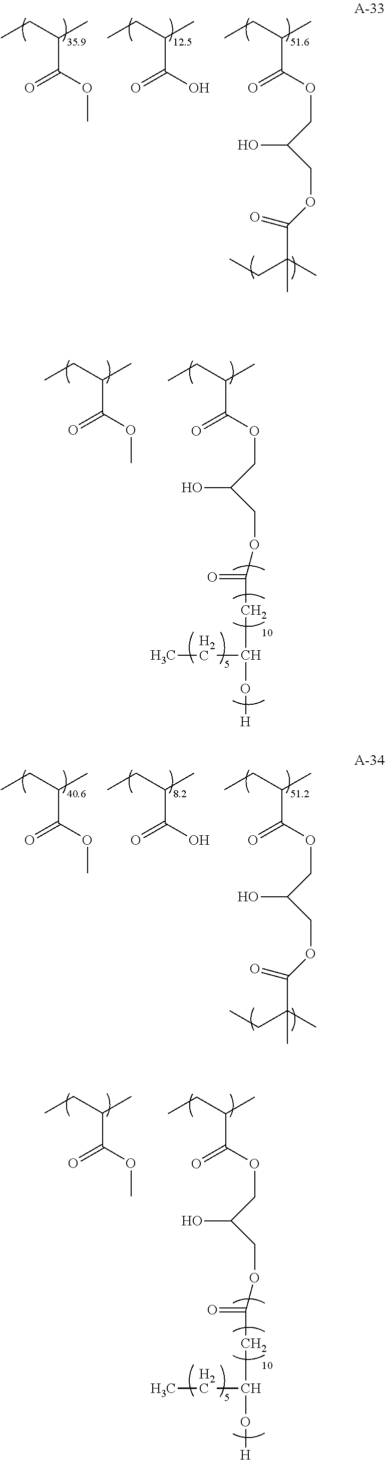

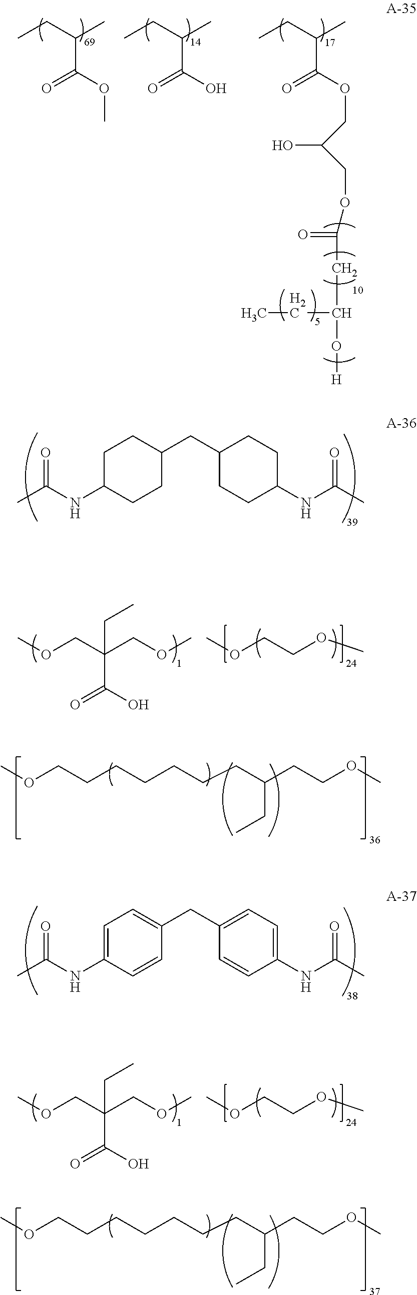

### Synthesis Example A-33: Synthesis of Polymer A-33 and Preparation of Polymer Dispersion Liquid A-33

A polymer A-33 was synthesized according to a method described in JP2015-088486A.

That is, 7.2 g of a heptane solution with 40% by mass of the following macromonomer MC-1, 12.4 g of methyl acrylate, and 6.7 g of acrylic acid, 207 g of heptane (manufactured by Wako Pure Chemical Industries, Ltd.), and 1.4 g of azoisobutyronitrile were charged into a 3 L three-neck flask equipped with a reflux condenser and a gas introduction cock, nitrogen gas was introduced at a flow rate of 200 mL/min for 10 minutes, and then the temperature was raised to 100° C. A liquid (liquid obtained by mixing 846 g of the heptane solution with 40% by mass of the macromonomer MC-1, 222.8 g of methyl acrylate, 75.0 g of acrylic acid, 300.0 g of heptane, and 2.1 g of azoisobutyronitrile) prepared in a separate container was dropwise added thereto over 4 hours. After the dropwise addition was completed, 0.5 g of azoisobutyronitrile was added thereto. Thereafter, the mixture was stirred at 100° C. for 2 hours, and cooled to room temperature. 1000 g of xylene was added thereto, the mixture was heated at 100° C., 1.5 L of the solvent was distilled off, and then the mixture was cooled to room temperature. 1000 g of xylene was added thereto again, the mixture was heated at 100° C., and 1.0 L of the solvent was distilled off to obtain a polymer dispersed xylene liquid A-33 of a polymer A-33 having a weight-average molecular weight of 1.9×10⁴ by the above-described measurement method. An average particle diameter of the polymer A-33 in the dispersion liquid was 160 nm.

### Synthesis Example of macro-monomer MC-1

A self-condensate of 12-hydroxystearic acid (manufactured by Wako Pure Chemical Industries, Ltd.) (number-average molecular weight in GPC polystyrene standard: 2.0×10³) was reacted with glycidyl methacrylate (manufactured by Tokyo Chemical Industry Co., Ltd.) to form a macromonomer, the macromonomer was subsequently polymerized with methyl methacrylate and glycidyl methacrylate (manufactured by Tokyo Chemical Industry Co., Ltd.) at a ratio of 1:0.99:0.01 (molar ratio) to obtain a polymer, and the polymer was subsequently reacted with acrylic acid (manufactured by FUJIFILM Wako Pure Chemical Corporation) to obtain a macromonomer M-1. A number-average molecular weight of the macro-monomer MC-1 was 1.1×10⁴.

### Synthesis Example A-34: Synthesis of Polymer A-34

A polymer dispersed xylene liquid A-34 of a polymer A-34 having a weight-average molecular weight of 3.2×10⁴ by the above-described measurement method was obtained in the same manner as in Synthesis Example A-33, except that, in Synthesis Example A-33, the amount of the methyl acrylate was changed from 12.4 g to 12.6 g, the amount of the methyl acrylate in the separate container was changed from 222.8 g to 256.2 g, the amount of the acrylic acid was changed from 6.7 g to 6.8 g, and the amount of the acrylic acid in the separate container was changed from 75.0 g to 47.0 g. An average particle diameter of the polymer A-34 in the dispersion liquid was 180 nm.

### Synthesis Example A-35: Synthesis of Polymer A-35

A polymer A-35 was synthesized according to a method described in JP2015-088486A.

That is, 1.5 g of a heptane solution with 40% by mass of the following macromonomer MC-2, 12.6 g of methyl acrylate, and 6.8 g of acrylic acid, 207 g of heptane (manufactured by Wako Pure Chemical Industries, Ltd.), and 1.4 g of azoisobutyronitrile were charged into a 3 L three-neck flask equipped with a reflux condenser and a gas introduction cock, nitrogen gas was introduced at a flow rate of 200 mL/min for 10 minutes, and then the temperature was raised to 100° C. A liquid (liquid obtained by mixing 161.4 g of the heptane solution with 40% by mass of the macromonomer MC-2, 256.2 g of methyl acrylate, 47.0 g of acrylic acid, 300.0 g of heptane, and 2.1 g of azoisobutyronitrile) prepared in a separate container was dropwise added thereto over 4 hours. After the dropwise addition was completed, 0.5 g of azoisobutyronitrile was added thereto. Thereafter, the mixture was stirred at 100° C. for 2 hours, and cooled to room temperature. 1000 g of DIBK was added thereto, the mixture was heated at 110° C., heptane was distilled off, and the mixture was cooled to room temperature to obtain a polymer liquid A-35 of a polymer A-35 having a weight-average molecular weight of 1.0×10⁴ by the above-described measurement method.

### Synthesis Example of macro-monomer MC-2

A self-condensate of 12-hydroxystearic acid (manufactured by Wako Pure Chemical Industries, Ltd.) (number-average molecular weight in GPC polystyrene standard: 2.0×10³) was reacted with glycidyl acrylate (manufactured by Tokyo Chemical Industry Co., Ltd.) at a ratio of 1:1.01 (molar ratio) to obtain a macromonomer MC-2. A number-average molecular weight of the macro-monomer MC-2 was 2.1×10³.

### Synthesis Example A-36: Synthesis of Polymer A-36

4.46 g of polyethylene glycol (product name: Polyethylene glycol 200, manufactured by FUJIFILM Wako Pure Chemical Corporation), 0.17 g of 2,2-bis(hydroxymethyl)butyric acid (manufactured by Tokyo Chemical Industry Co., Ltd.), and 6.69 g of NISSO—PB GI-1000 (product name, manufactured by NIPPON SODA Co., Ltd.) were charged into a 200 mL three-neck flask, and the mixture was dissolved in 74 g of tetrahydrofuran (THF). 7.32 g of dicyclohexylmethane-4,4′-diisocyanate (manufactured by Tokyo Chemical Industry Co., Ltd.) was added to the solution, and stirred at 60° C. to be homogeneously dissolved. 560 mg of Neostan U-600 (product name, manufactured by Nitto Kasei Co., Ltd.) was added to the obtained solution, and the mixture was stirred at 60° C. for 5 hours to obtain a THF solution with 20% by mass of a polymer A-36. Next, 222 g of xylene was added to a solution obtained by adding 74 g of THF to the polymer solution obtained as described above, and the mixture was heated at 85° C. for 120 minutes. 50 g of xylene was added to the obtained residue, and the mixture was further heated at 85° C. for 60 minutes. This operation was repeated four times to remove THF. A polymer liquid A-36 of a polymer A-36 having a weight-average molecular weight of 4.5×10⁴ by the above-described measurement method was obtained.

### Synthesis Example A-37: Synthesis of Polymer A-37

4.46 g of polyethylene glycol (product name: Polyethylene glycol 200, manufactured by FUJIFILM Wako Pure Chemical Corporation), 0.17 g of 2,2-bis(hydroxymethyl)butyric acid (manufactured by Tokyo Chemical Industry Co., Ltd.), and 6.69 g of NISSO—PB GI-1000 (product name, manufactured by NIPPON SODA Co., Ltd.) were charged into a 200 mL three-neck flask, and the mixture was dissolved in 74 g of tetrahydrofuran (THF). 6.98 g of diphenylmethane-4,4′-diisocyanate (manufactured by Tokyo Chemical Industry Co., Ltd.) was added to the solution, and stirred at 60° C. to be homogeneously dissolved. 560 mg of Neostan U-600 (product name, manufactured by Nitto Kasei Co., Ltd.) was added to the obtained solution, and the mixture was stirred at 60° C. for 5 hours to obtain a THF solution with 20% by mass of a polymer A-37. Next, 222 g of butyl butyrate was added dropwise to a solution obtained by adding 74 g of THF to the polymer solution obtained as described above over 10 minutes while stirring at 150 rpm, thereby obtaining an emulsified liquid of a polymer A-37. The emulsified liquid was heated at 85° C. for 120 minutes while flowing nitrogen gas. 50 g of butyl butyrate was added to the obtained residue, and the mixture was further heated at 85° C. for 60 minutes. This operation was repeated four times to remove THF. A polymer A-37 having a weight-average molecular weight of 7.0×10⁴ by the above-described measurement method was synthesized.

### 2. Preparation of Polymer

### [SEBS]

As a styrene-ethylene-butylene-styrene block copolymer, a commercially available SEBS (product name, weight-average molecular weight: 1.0×10⁵, Sigma-Aldrich Co., LLC) was prepared.

### 3. Synthesis of Sulfide-Based Inorganic Solid Electrolyte

(Synthesis of Li—P—S-Based Glass LPS-1 Having Specific Surface Area of 5.0 m²/g)

A sulfide-based inorganic solid electrolyte was synthesized with reference to non-patent documents of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box in an argon atmosphere (dew point: −70° C.), lithium sulfide (Li₂S, manufactured by Sigma-Aldrich Co., LLC, purity: >99.98%) (2.42 g) and diphosphorus pentasulfide (P₂S₅, manufactured by Sigma-Aldrich Co., LLC, purity: >99%) (3.90 g) each were weighed, put into an agate mortar, and mixed using an agate pestle for 5 minutes. A mixing ratio between Li₂S and P₂S₅(Li₂S:P₂S₅) was set to 75:25 in terms of molar ratio.

Next, 66 g of zirconia beads having a diameter of 2 mm were put into a 45 mL container made of zirconia (manufactured by FRITSCH), the entire amount of the mixture of the above-described lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 500 rpm for 20 hours, thereby obtaining Li—P—S-based glass LPS-1 having a specific surface area of 5.0 m²/g.

(Synthesis of Li—P—S-Based Glass LPS-2 Having Specific Surface Area of 10 m²/g)

Li—P—S-based glass LPS-2 having a specific surface area of 10 m²/g was obtained in the same manner as in the synthesis of LPS-1, except that, in the synthesis of LPS-1, the rotation speed in the mechanical milling was changed from 500 rpm to 750 rpm.

(Synthesis of Li—P—S-Based Glass LPS-3 Having Specific Surface Area of 1.5 m²/g)

Li—P—S-based glass LPS-3 having a specific surface area of 1.5 m²/g was obtained in the same manner as in the synthesis of LPS-1, except that, in the synthesis of LPS-1, zirconia beads having a diameter of 5 mm were used instead of the zirconia beads having a diameter of 2 mm, and the rotation speed was changed from 500 rpm to 380 rpm to carry out the mechanical milling.

(Synthesis of Li—P—S-Based Glass LPS-4 Having Specific Surface Area of 3.0 m²/g)

Li—P—S-based glass LPS-4 having a specific surface area of 3.0 m²/g was obtained in the same manner as in the production of LPS-1, except that, in the synthesis of LPS-1, zirconia beads having a diameter of 5 mm were used instead of the zirconia beads having a diameter of 2 mm.

4. An active material was prepared as follows.

(Preparation of Negative Electrode Active Material Si-1 Having Specific Surface Area of 30 m²/g)

Silicon (manufactured by Sigma-Aldrich Co., LLC, nonopowder) was classified by a classifier to obtain Si-1 having a specific surface area of 30 m²/g.

(Preparation of Negative Electrode Active Material Si-2 Having Specific Surface Area of 25 m²/g)

Silicon (manufactured by Sigma-Aldrich Co., LLC, nonopowder) was classified by a classifier to obtain Si-2 having a specific surface area of 25 m²/g.

(Preparation of Negative Electrode Active Material Si-3 Having Specific Surface Area of 2.8 m²/g)

Silicon (manufactured by Thermo Fisher Scientific Inc., APS 1-5 micron) was classified by a classifier to obtain Si-3 having a specific surface area of 2.8 m²/g.

(Preparation of Positive Electrode Active Material NCM-1 Having Specific Surface Area of 0.5 m²/g)

60 g of NMC (LiNi_{1/3}Co_{1/3}Mn_{1/3}O₂, manufactured by TOSHIMA Manufacturing Co., Ltd.), 200 mL of ethanol, and 25 mL of a 5% w/v ethanolic solution of lithium niobium ethoxide (manufactured by Thermo Fisher Scientific Inc.) were charged into a 500 mL eggplant flask, ethanol was slowly distilled off using a rotary evaporator at a rotation speed of 5 rpm, a reduced pressure of 500 mmHg, and a water bath temperature of 60° C., and the resulting powder, after being dried using a gas-replacement furnace, was heated at 450° C. for 2 hours under an oxygen atmosphere. Thereafter, the mixture was classified by a classifier to obtain NCM-1 having a specific surface area of 0.5 m²/g.

(Preparation of Positive Electrode Active Material NCM-2 Having Specific Surface Area of 1.0 m²/g)

In the preparation of NCM-1, the mixture was classified by a classifier to obtain NCM-2 having a specific surface area of 1.0 m²/g.

(Preparation of Positive Electrode Active Material NCM-3 Having Specific Surface Area of 5.0 m²/g)

In the preparation of NCM-1, the NMC was changed to NMC (<0.5 μm) manufactured by Sigma-Aldrich Co., LLC, and the mixture was classified by a classifier in the same manner as in the preparation of NCM-1 to obtain NCM-3 having a specific surface area of 5.0 m²/g.

(Preparation of Positive Electrode Active Material LMO-1 Having Specific Surface Area of 1.5 m²/g)

LMO (LiMn₂O₄, manufactured by TOSHIMA Manufacturing Co., Ltd.) was classified by a classifier to obtain LMO-1 having a specific surface area of 1.5 m²/g.

<Measurement of Adsorption Rate A_{AC} and Adsorption Rate A_{SE}>

For each of the prepared polymers, the adsorption rate A_{AC} to the active material AC used for preparing a composition for an all-solid-state secondary battery described later and the adsorption rate A_{SE} to the inorganic solid electrolyte SE used for preparing the composition for an all-solid-state secondary battery described later were measured as follows.

### (Measurement of Adsorption Rate A_{AC})

The adsorption rate A_{AC} (%) of the polymer to the active material AC was measured as follows using the active material AC, the polymer, and the dispersion medium D used for preparing the composition for an all-solid-state secondary battery in each of Examples and each of Comparative Examples.

That is, the polymer in a mass used for preparing each composition for an all-solid-state secondary battery, the active material AC, and the dispersion medium D were charged into a 30 mL cylindrical container such that a solid content was 53% by mass, and the mixture was stirred with a mixing roller at a rotation speed of 40 rpm for 1 hour. Thereafter, the dispersion liquid after the stirring was filtered using a membrane filter having a hole diameter of 0.2 μm, and the entire amount of the obtained filtrate was dried to measure the mass W_{A} of the polymer remaining in the filtrate (mass of polymer not adsorbed to the active material). The adsorption rate of the polymer to the active material was calculated from the mass W_{A} and the mass WB of the polymer used for the measurement by the following expression. An average value of the adsorption rates obtained by performing the above-described measurement twice was defined as the adsorption rate A_{AC} of the polymer A to the active material AC in each of Examples and each of Comparative Examples. The results are shown in Tables 1 to 3.

$$Adsorption rate ( \% ) = [ ( {W}_{B} - {W}_{A} ) / {W}_{B} ] \times 100$$

As described above, in the measurement of the adsorption rate A_{AC}, the inorganic solid electrolyte SE was not in coexistence. In addition, in the measurement of the adsorption rate A_{AC} of Example 1-9, a mixture (mass ratio [A-25:SEBS]=50:50) of the polymer A-25 having a weight-average molecular weight of 2.0×10⁴ and the above-described commercially available SEBS was used as the polymer; and in the measurement of the adsorption rate A_{AC} of Comparative Example 1-3, a mixture (mass ratio [A-8:A-10]=50:50) of the polymer A-8 and the polymer A-10 was used as the polymer.

### (Measurement of Adsorption Rate AS_{E})

The adsorption rate A_{SE} (%) of the polymer to the inorganic solid electrolyte SE was measured as follows using the inorganic solid electrolyte SE, the polymer, and the dispersion medium D used for preparing the composition for an all-solid-state secondary battery in each of Examples and each of Comparative Examples.

That is, the polymer in a mass used for preparing each composition for an all-solid-state secondary battery, the inorganic solid electrolyte SE, and the dispersion medium D were charged into a 30 mL cylindrical container such that a solid content was 25% by mass, and the mixture was stirred with a mixing roller at a rotation speed of 40 rpm for 1 hour. Thereafter, the dispersion liquid after the stirring was filtered using a membrane filter having a hole diameter of 0.2 μm, and the entire amount of the obtained filtrate was dried to measure the mass W_{C} of the polymer remaining in the filtrate (mass of polymer not adsorbed to the inorganic solid electrolyte SE). The adsorption rate of the polymer to the inorganic solid electrolyte SE was calculated from the mass W_{C} and the mass W_{D} of the polymer used for the measurement by the following expression. An average value of the adsorption rates obtained by performing the above-described measurement twice was defined as the adsorption rate A_{SE} of the polymer A to the inorganic solid electrolyte SE in each of Examples and each of Comparative Examples. The results are shown in Tables 1 to 3.

$$Adsorption rate ( \% ) = [ ( {W}_{D} - {W}_{C} ) / {W}_{D} ] \times 100$$

As described above, in the measurement of the adsorption rate A_{SE}, the active material AC was not in coexistence. In addition, in Example 1-9 and Comparative Example 1-3, a mixture of the above-described two polymers was used.

A solubility of the polymer A in each of the compositions (Examples 1 to 10 and Comparative Examples 1 to 10) described later in the dispersion medium was measured by the above-described method. As a result, a case where the solubility was 80% or more is indicated as “Dissolved” in the column of “Form” in Tables 1 to 3, assuming that the polymer A was dissolved in the dispersion medium; and a case where the solubility was less than 80% is indicated as “Particles” in the column of “Form” in Table 1, assuming that the polymer A was not dissolved in the dispersion medium and was dispersed in a particle shape.

### Examples 1 to 5 and Comparative Examples 1 to 5

1. Each composition for an all-solid-state secondary battery (negative electrode composition) was prepared as follows.

### Examples 1 and Comparative Example 1

7.5 g of Si-1 as the negative electrode active material AC, 2.05 g of LPS-1 as the inorganic solid electrolyte SE, 0.4 g of VGCF-H (manufactured by Resonac Holdings Corporation) as a conductive auxiliary agent, 0.05 g (solid content amount) of A-20 having a weight-average molecular weight shown in Table 1 as the polymer A, and 6.67 g of diisobutyl ketone (DIBK) as the dispersion medium D were charged into a container, and the mixture was mixed at a rotation speed of 2,000 rpm and a revolution speed of 800 rpm for 10 minutes using a rotating and revolving mixer to obtain a negative electrode composition of Example 1-1 (concentration of solid contents: 60% by mass).

Negative electrode compositions of Examples 1-2 to 1-9 and Comparative Examples 1-1 to 1-3 were each prepared in the same manner as in Example 1-1, except that, in Example 1-1, the type or content of the polymer and the content of the inorganic solid electrolyte SE were changed as shown in Table 1.

In Example 1-9, a mixture (mixing mass ratio [A-25:SEBS]=50:50) of the above-described polymer A-25 having a weight-average molecular weight of 2.0×10⁴ and SEBS was used as the polymer; and in Comparative Example 1-3, a mixture (mixing mass ratio [A-8:A-10]=50:50) of the above-described polymer A-8 and the above-described polymer A-10 was used as the polymer.

### Example 2 and Comparative Example 2

Negative electrode compositions of Examples 2-1 to 2-4 and Comparative Examples 2-1 and 2-2 were each prepared in the same manner as in Example 1-1, except that, in Example 1-1, the type or content of the polymer, the type or content of the negative electrode active material AC, the content of the inorganic solid electrolyte SE, and the type of the dispersion medium D were changed as shown in Table 1.

### Example 3 and Comparative Example 3

Negative electrode compositions of Examples 3-1 to 3-5 and Comparative Examples 3-1 to 3-3 were each prepared in the same manner as in Example 1-1, except that, in Example 1-1, the type or content of the polymer, the type or content of the active material AC, and the content of the inorganic solid electrolyte SE were changed as shown in Table 1.

### Example 4 and Comparative Example 4

Negative electrode compositions of Examples 4-1 to 4-4 and Comparative Examples 4-1 to 4-4 were each prepared in the same manner as in Example 1-1, except that, in Example 1-1, the type or content of the polymer, the type or content of the active material AC, the content of the inorganic solid electrolyte SE, and the type of the dispersion medium D were changed as shown in Table 1.

### Example 5 and Comparative Example 5

Negative electrode compositions of Examples 5-1 to 5-3 and Comparative Examples 5-1 and 5-2 were each prepared in the same manner as in Example 1-1, except that, in Example 1-1, the type or content of the polymer, the type or content of the active material AC, the type or content of the inorganic solid electrolyte SE, and the type of the dispersion medium D were changed as shown in Table 1.

2. A negative electrode sheet for an all-solid-state secondary battery was produced as follows.

### Examples 1 and Comparative Example 1

Each negative electrode composition obtained in Examples 1-1 to 1-9 and Comparative Examples 1-1 to 1-3 as described above was applied onto a copper foil having a thickness of 20 μm using a baker type applicator (product name: SA-201, manufactured by TESTER SANGYO CO., LTD.), heated at 110° C. for 1 hour, and dried (the dispersion medium was removed) by heating at 110° C. for 2 hours with a vacuum dryer AVO-200NS (product name, manufactured by AS ONE Corporation). In this way, a negative electrode sheet for an all-solid-state secondary battery of Examples 1-1 to 1-9 and Comparative Examples 1-1 to 1-3, having a negative electrode active material layer with a total amount of 1.8 mg/cm², was produced.

Here, the total amount means the total mass of the inorganic solid electrolyte SE, the active material AC, and the conductive auxiliary agent per unit area.

### Examples 2 to 5 and Comparative Examples 2 to 5

Each negative electrode sheet for an all-solid-state secondary battery of Examples 2-1 to 2-4 and Comparative Examples 2-1 and 2-2, Examples 3-1 to 3-5 and Comparative Examples 3-1 to 3-3, Examples 4-1 to 4-4 and Comparative Examples 4-1 to 4-4, and Examples 5-1 to 5-3 and Comparative Examples 5-1 and 5-2 was produced in the same manner as in the production of the negative electrode sheet for an all-solid-state secondary battery of Example 1-1 described above, except that, in the production of the negative electrode sheet for an all-solid-state secondary battery of Example 1-1, each negative electrode composition obtained in Examples 2 to 5 and Comparative Examples 2 to 5 was used instead of the negative electrode composition obtained in Example 1-1. The total amount of the negative electrode active material layer in each negative electrode sheet for an all-solid-state secondary battery was 1.8 mg/cm².

3. An all-solid-state secondary battery was produced as follows using each produced negative electrode sheet for an all-solid-state secondary battery.

### Examples 1 and Comparative Example 1

Each negative electrode sheet for an all-solid-state secondary battery produced in Example 1 and Comparative Example 1 was punched into a disk shape having a diameter of 10 mmφ, and put into a cylinder made of polyethylene terephthalate (PET) having a diameter of 10 mmφ. 60 mg of LPS-3 obtained in the above-described synthesis of LPS-3 was put on a surface of the negative electrode active material layer in the cylinder, and a 10 mmφ SUS-made rod was inserted from both open ends of the cylinder. The negative electrode collector side of each negative electrode sheet for an all-solid-state secondary battery and the LPS-3 were pressurized and formed into a solid electrolyte layer at a pressure of 350 MPa by a stainless steel (SUS) rod. Next, the SUS bar disposed on the solid electrolyte layer side was temporarily removed, and a disk-shaped indium (In) sheet (thickness: 20 μm) having a diameter of 9 mmφ and a disk-shaped lithium (Li) sheet (thickness: 20 μm) having a diameter of 9 mmφ were inserted into the solid electrolyte layer in the cylinder in this order. The removed SUS bar was inserted into the cylinder again, and was fixed in a state in which a pressure of 50 MPa was applied. In this way, an all-solid-state secondary battery (half cell) of Examples 1-1 to 1-9 and Comparative Examples 1-1 to 1-3, having a configuration of copper foil (thickness: 20 μm)-negative electrode active material layer (thickness: 25 μm)-solid electrolyte layer (thickness: 200 μm)-positive electrode active material layer (In/Li sheet, thickness: 30 μm), was produced.

### Examples 2 to 5 and Comparative Examples 2 to 5

Each all-solid-state secondary battery of Examples 2-1 to 2-4 and Comparative Examples 2-1 and 2-2, Examples 3-1 to 3-5 and Comparative Examples 3-1 to 3-3, Examples 4-1 to 4-4 and Comparative Examples 4-1 to 4-4, and Examples 5-1 to 5-3 and Comparative Examples 5-1 and 5-2 was produced in the same manner as in the production of the all-solid-state secondary battery of Example 1-1 described above, except that, in the production of the all-solid-state secondary battery of Example 1-1, each negative electrode sheet for an all-solid-state secondary battery obtained in Examples 2 to 5 and Comparative Examples 2 to 5 was used instead of the negative electrode sheet for an all-solid-state secondary battery obtained in Example 1-1.

4. The negative electrode composition for an all-solid-state secondary battery and the all-solid-state secondary battery, prepared as described above, were evaluated for the following characteristics.

<Evaluation 1: High Concentration Test of Negative Electrode Composition for all-Solid-State Secondary Battery>

The inorganic solid electrolyte SE, the negative electrode active material AC, the polymer, and the conductive auxiliary agent were put into a container at the same mass ratio as in each of Examples and each of Comparative Examples, a predetermined amount of the dispersion medium D was further added thereto, and the mixture was mixed at a rotation speed of 2,000 rpm and a revolution speed of 800 rpm for 5 minutes using a rotating and revolving mixer (ARE310 (product name), manufactured by THINKY CORPORATION) to prepare a test negative electrode composition having a concentration of solid contents of 40% by mass. Regarding the test negative electrode composition, generation (the presence or absence) of aggregates of solid particles was confirmed using a grind gauge (manufactured by ERICHSEN Co., Ltd.). As a result, in a case where aggregates were confirmed in a region of 10 μm or more, the maximum concentration of solid contents of the negative electrode composition for an all-solid-state secondary battery was set to 40% by mass because the dispersibility of the solid particles was insufficient. On the other hand, in a case where aggregates were not confirmed in a region of 10 μm or more with the grind gauge, the generation (the presence or absence) of the aggregates of the solid particles was confirmed for the test negative electrode composition prepared by reducing only the used amount of the dispersion medium D and mixing at a rotation speed of 2,000 rpm and a revolution speed of 800 rpm for 5 minutes using a rotating and revolving mixer (ARE310 (product name), manufactured by THINKY CORPORATION) using a grind gauge (manufactured by ERICHSEN Co., Ltd.). The used amount of the dispersion medium D was sequentially reduced to increase the concentration of solid contents by 5% by mass to be high concentration up to 80% by mass. As a result, the maximum concentration of solid contents in a case where aggregates were not confirmed in a region of 10 μm or more was defined as the maximum concentration of solid contents of the negative electrode composition for an all-solid-state secondary battery.

In Example 1 and Comparative Example 1, the maximum concentration of solid contents of the negative electrode composition for an all-solid-state secondary battery of Comparative Example 1-1 was 50% by mass, and the high concentration test was evaluated based on the following evaluation standard with the maximum concentration of solid contents as a reference. In Examples 2 to 5, the evaluation was based on Comparative Example 2-1 (maximum concentration of solid contents: 45% by mass), Comparative Example 3-1 (maximum concentration of solid contents: 45% by mass), Comparative Example 4-1 (maximum concentration of solid contents: 50% by mass), and Comparative Example 5-1 (maximum concentration of solid contents: 45% by mass). The results are shown in Table 1.

### —Evaluation Standard—

A: above-described reference+15% by mass≤maximum concentration of solid contents
B: above-described reference+10% by mass≤maximum concentration of solid contents<above-described reference+15% by mass
C: above-described reference+5% by mass≤maximum concentration of solid contents<above-described reference+10% by mass
D: above-described reference−5% by mass≤maximum concentration of solid contents<above-described reference+5% by mass
E: maximum concentration of solid contents<above-described reference−5% by mass
   <Evaluation 2: Preparation Time Test of Negative Electrode Composition for all-Solid-State Secondary Battery>

The inorganic solid electrolyte SE, the negative electrode active material AC, the polymer, and the conductive auxiliary agent were put into a container at the same mass ratio as in each of Examples and each of Comparative Examples, a predetermined amount of the dispersion medium D was further added thereto, and the mixture was continuously mixed at a rotation speed of 2,000 rpm and a revolution speed of 800 rpm for 2 minutes using a rotating and revolving mixer (ARE310 (product name), manufactured by THINKY CORPORATION) to prepare a test negative electrode composition having a concentration of solid contents of 55% by mass. Regarding the test negative electrode composition, generation (the presence or absence) of aggregates of solid particles was confirmed using a grind gauge (manufactured by ERICHSEN Co., Ltd.). As a result, in a case where aggregates were not confirmed in a region of m or more with the grind gauge, the mixing time of the negative electrode composition for an all-solid-state secondary battery was set to 2 minutes as the shortest mixing time, on the grounds that the dispersibility of the solid particles at that mixing time was favorable. On the other hand, in a case where aggregates were confirmed in a region of 10 μm or more, the mixing time of the negative electrode composition for an all-solid-state secondary battery was changed to a long time because the dispersibility of the solid particles was insufficient at the mixing time. Specifically, the inorganic solid electrolyte SE, the negative electrode active material AC, the polymer, and the conductive auxiliary agent were put into a container at the same mass ratio as in each of Examples and each of Comparative Examples, a predetermined amount of the dispersion medium D was further added thereto, and the mixture was continuously mixed at a rotation speed of 2,000 rpm and a revolution speed of 800 rpm for 5 minutes using a rotating and revolving mixer (ARE310 (product name), manufactured by THINKY CORPORATION) to confirm the presence or absence of aggregates as described above. In a case where the aggregates were confirmed, the continuous mixing time was sequentially extended to 8 minutes, 10 minutes, 15 minutes, 20 minutes, 25 minutes, 30 minutes, and 35 minutes, and the above-described operation was repeated until the aggregates were not confirmed. The mixing time at which the aggregates were not confirmed was defined as the shortest mixing time. In Example 1 and Comparative Example 1, the shortest mixing time of the negative electrode composition for an all-solid-state secondary battery of Comparative Example 1-1 was 15 minutes, and the mixing time test was evaluated based on the following evaluation standard with the shortest mixing time as a reference. In Examples 2 to 5, the evaluation was based on Comparative Example 2-1 (shortest mixing time: 30 minutes), Comparative Example 3-1 (shortest mixing time: 20 minutes), Comparative Example 4-1 (shortest mixing time: 25 minutes), and Comparative Example 5-1 (shortest mixing time: 25 minutes). The results are shown in Table 1.

### —Evaluation Standard—

A: shortest mixing time≤above-described reference−13 minutes
B: above-described reference−13 minutes<shortest mixing time≤above-described reference−10 minutes
C: above-described reference−10 minutes<shortest mixing time≤above-described reference−5 minutes
D: above-described reference−5 minutes<shortest mixing time≤above-described reference+5 minutes
E: above-described reference+5 minutes<shortest mixing time
   <Evaluation 3: Rate Characteristic Test of all-Solid-State Secondary Battery>

A rate characteristic test of each all-solid-state secondary battery produced in each of Examples and each of Comparative Examples was performed using a charging and discharging evaluation device TOSCAT-3000 (product name, manufactured by Toyo System Corporation).

Specifically, each all-solid-state secondary battery was charged at a current density of 0.1 mAcm⁻² until the battery voltage reached −0.62 V in an environment of 25° C., and then discharged at a current density of 0.5 mAcm⁻² until the battery voltage reached 0.88 V. Thereafter, the battery was charged at a current density of 0.1 mAcm⁻² until the battery voltage reached −0.62 V, and then discharged at a current density of 2 mAcm⁻² until the battery voltage reached 0.88 V

Rate characteristics were determined according to the following expression, and applied to the following evaluation standard to evaluate the rate characteristics of the all-solid-state secondary battery.

In Example 1 and Comparative Example 1, the rate characteristics of the all-solid-state secondary battery were evaluated based on the following evaluation standard with the rate characteristics (50%) of the all-solid-state secondary battery of Comparative Example 1-1 as a reference, by obtaining the rate characteristics by the following expression. In Examples 2 to 5, the evaluation was based on the rate characteristics of Comparative Example 2-1 (45%), the rate characteristics of Comparative Example 3-1 (55%), the rate characteristics of Comparative Example 4-1 (40%), and the rate characteristics of Comparative Example 5-1 (50%). The results are shown in Table 1.

A 5% difference in the rate characteristics in the above-described main test represents sufficiently large superiority, and it can be said that an all-solid-state secondary battery having a rate characteristic at least 5% higher than that of each of Comparative Examples (evaluation standard C or higher) exhibits sufficiently superior rate characteristics.

$$Rate characteristics ( \% ) = ( Discharge capacity at current density of 2 mA {cm}^{- 2} / Discharge capacity at current density of 0.5 mA {cm}^{- 2} ) \times 100$$

### —Evaluation Standard—

A: above-described reference+15%≤rate characteristics
B: above-described reference+10%≤rate characteristics<above-described reference+15%
C: above-described reference+5%≤rate characteristics<above-described reference+10%
D: above-described reference−5%≤rate characteristics<above-described reference+5%
E: rate characteristics<above-described reference−5%

TABLE 1-1

| | Polymer A | | | | | | Active material AC | | |
|---|---|---|---|---|---|---|---|---|---|
| | | Weight-average | | | Adsorption | Adsorption | | Specific | |
| | Type | molecular weight | Form | Content | rate A_{AC} | rate A_{SE} | Type | surface area | Content |
| Example 1-1 | A-20 | 12000 | Dissolved | 0.05 | 20% | 6% | Si-1 | 30 | 7.50 |
| Example 1-2 | A-20 | 12000 | Dissolved | 0.04 | 20% | 6% | Si-1 | 30 | 7.50 |
| Example 1-3 | A-15 | 11000 | Dissolved | 0.05 | 26% | 12% | Si-1 | 30 | 7.50 |
| Example 1-4 | A-15 | 11000 | Dissolved | 0.04 | 26% | 12% | Si-1 | 30 | 7.50 |
| Example 1-5 | A-18 | 13800 | Dissolved | 0.05 | 31% | 22% | Si-1 | 30 | 7.50 |
| Example 1-6 | A-25 | 20000 | Dissolved | 0.05 | 35% | 38% | Si-1 | 30 | 7.50 |
| Example 1-7 | A-25 | 20000 | Dissolved | 0.04 | 32% | 38% | Si-1 | 30 | 7.50 |
| Example 1-8 | A-8 | 100000 | Dissolved | 0.05 | 10% | 10% | Si-1 | 30 | 7.50 |
| Example 1-9 | A-25 + | 61000 | Dissolved | 0.10 | 40% | 42% | Si-1 | 30 | 7.50 |
| | SEBS | | | | | | | | |
| Comparative | A-13 | 12000 | Dissolved | 0.05 | 5% | 50% | Si-1 | 30 | 7.50 |
| Example 1-1 | | | | | | | | | |
| Comparative | A-10 | 400000 | Dissolved | 0.05 | 20% | 6% | Si-1 | 30 | 7.50 |
| Example 1-2 | | | | | | | | | |
| Comparative | A-8 + | 260000 | Dissolved | 0.10 | 24% | 7% | Si-1 | 30 | 7.50 |
| Example 1-3 | A-10 | | | | | | | | |
| Example 2-1 | A-17 | 5000 | Dissolved | 0.05 | 10% | 6% | Si-2 | 25 | 7.50 |
| Example 2-2 | A-17 | 5000 | Dissolved | 0.10 | 12% | 9% | Si-2 | 25 | 7.50 |
| Example 2-3 | A-17 | 5000 | Dissolved | 0.15 | 12% | 12% | Si-2 | 25 | 7.50 |
| Example 2-4 | A-17 | 20000 | Dissolved | 0.10 | 9% | 10% | Si-2 | 25 | 7.50 |
| Comparative | A-13 | 12000 | Dissolved | 0.15 | 3% | 45% | Si-2 | 25 | 7.50 |
| Example 2-1 | | | | | | | | | |
| Comparative | A-10 | 400000 | Dissolved | 0.15 | 21% | 7% | Si-2 | 25 | 7.50 |
| Example 2-2 | | | | | | | | | |
| Example 3-1 | A-13 | 12000 | Dissolved | 0.05 | 5% | 50% | Si-3 | 2.8 | 5.00 |
| Example 3-2 | A-13 | 12000 | Dissolved | 0.10 | 7% | 53% | Si-3 | 2.8 | 5.00 |
| Example 3-3 | A-1 | 16000 | Dissolved | 0.05 | 5% | 2% | Si-3 | 2.8 | 5.00 |
| Example 3-4 | A-1 | 16000 | Dissolved | 0.10 | 6% | 2% | Si-3 | 2.8 | 5.00 |
| Example 3-5 | A-5 | 100000 | Dissolved | 0.10 | 3% | 35% | Si-3 | 2.8 | 5.00 |
| Comparative | A-1 | 400000 | Dissolved | 0.10 | 4% | 2% | Si-3 | 2.8 | 5.00 |
| Example 3-1 | | | | | | | | | |
| Comparative | A-14 | 400000 | Dissolved | 0.10 | 6% | 18% | Si-3 | 2.8 | 5.00 |
| Example 3-2 | | | | | | | | | |
| Comparative | A-35 | 10000 | Dissolved | 0.10 | 32% | 4% | Si-3 | 2.8 | 5.00 |
| Example 3-3 | | | | | | | | | |
| Example 4-1 | A-18 | 7000 | Dissolved | 0.105 | 5% | 14% | Si-3 | 2.8 | 7.00 |
| Example 4-2 | A-16 | 10000 | Dissolved | 0.105 | 4% | 11% | Si-3 | 2.8 | 7.00 |
| Example 4-3 | A-16 | 15000 | Dissolved | 0.105 | 5% | 11% | Si-3 | 2.8 | 7.00 |
| Example 4-4 | A-20 | 10000 | Dissolved | 0.105 | 7% | 20% | Si-3 | 2.8 | 7.00 |
| Comparative | A-36 | 45000 | Dissolved | 0.105 | 76% | 60% | Si-3 | 2.8 | 7.00 |
| Example 4-1 | | | | | | | | | |
| Comparative | SEBS | 100000 | Dissolved | 0.052 | 5% | 7% | Si-3 | 2.8 | 7.00 |
| Example 4-2 | | | | | | | | | |
| Comparative | A-33 | 19000 | Particles | 0.105 | 31% | 16% | Si-3 | 2.8 | 7.00 |
| Example 4-3 | | | | | | | | | |
| Comparative | A-34 | 32000 | Particles | 0.052 | 10% | 4% | Si-3 | 2.8 | 7.00 |
| Example 4-4 | | | | | | | | | |
| Example 5-1 | A-3 | 16000 | Dissolved | 0.05 | 5% | 12% | Si-3 | 2.8 | 5.00 |
| Example 5-2 | A-3 | 16000 | Dissolved | 0.10 | 5% | 12% | Si-3 | 2.8 | 5.00 |
| Example 5-3 | A-17 | 5000 | Dissolved | 0.05 | 7% | 15% | Si-3 | 2.8 | 5.00 |
| Comparative | A-3 | 400000 | Dissolved | 0.10 | 6% | 15% | Si-3 | 2.8 | 5.00 |
| Example 5-1 | | | | | | | | | |
| Comparative | A-14 | 400000 | Dissolved | 0.10 | 7% | 20% | Si-3 | 2.8 | 5.00 |
| Example 5-2 | | | | | | | | | |

TABLE 1-2

| | | | | | | | | | Test result | | |
|---|---|---|---|---|---|---|---|---|---|---|---|
| | | | | | | | | | Test of | | |
| | Inorganic solid electrolyte SE | | | Conduc- | Disper- | | | | concen- | Test of | |
| | | Specific | | tive | sion | | | | tration | prep- | |
| | | surface | | auxiliary | medium | | | | of solid | aration | Test of |
| | Type | area | Content | agent | D | Aa | Ab | Ac | contents | time | rate |
| Example 1-1 | LPS-1 | 5.0 | 2.05 | 0.40 | DIBK | 1.6 | 14.5 | 4.1 | B | C | B |
| Example 1-2 | LPS-1 | 5.0 | 2.06 | 0.40 | DIBK | 1.2 | 11.5 | 3.3 | A | B | B |
| Example 1-3 | LPS-1 | 5.0 | 2.05 | 0.40 | DIBK | 2.9 | 63.1 | 15.1 | A | A | A |
| Example 1-4 | LPS-1 | 5.0 | 2.06 | 0.40 | DIBK | 2.3 | 50.1 | 12.0 | A | A | A |
| Example 1-5 | LPS-1 | 5.0 | 2.00 | 0.40 | DIBK | 3.3 | 174.9 | 37.6 | A | B | A |
| Example 1-6 | LPS-1 | 5.0 | 2.00 | 0.40 | DIBK | 2.9 | 360.1 | 74.5 | C | B | A |
| Example 1-7 | LPS-1 | 5.0 | 2.06 | 0.40 | DIBK | 1.9 | 276.3 | 58.4 | B | B | A |
| Example 1-8 | LPS-1 | 5.0 | 2.06 | 0.40 | DIBK | 0.0 | 4.8 | 1.0 | C | C | C |
| Example 1-9 | LPS-1 | 5.0 | 2.06 | 0.40 | DIBK | 2.5 | 277.5 | 58.7 | A | B | B |
| Comparative | LPS-1 | 5.0 | 2.05 | 0.40 | DIBK | 0.1 | 1003.8 | 205.9 | Reference | Reference | Reference |
| Example 1-1 | | | | | | | | | | | |
| Comparative | LPS-1 | 5.0 | 2.05 | 0.40 | DIBK | 0.0 | 0.4 | 0.1 | E | D | D |
| Example 1-2 | | | | | | | | | | | |
| Comparative | LPS-1 | 5.0 | 2.05 | 0.40 | DIBK | 0.2 | 1.8 | 0.5 | D | D | D |
| Example 1-3 | | | | | | | | | | | |
| Example 2-1 | LPS-1 | 5.0 | 2.05 | 0.40 | BB | 1.2 | 34.7 | 8.0 | B | B | A |
| Example 2-2 | LPS-1 | 5.0 | 2.00 | 0.40 | BB | 3.5 | 162.0 | 35.1 | B | A | A |
| Example 2-3 | LPS-1 | 5.0 | 1.95 | 0.40 | BB | 5.3 | 448.7 | 91.5 | A | B | C |
| Example 2-4 | LPS-1 | 5.0 | 2.00 | 0.40 | BB | 0.5 | 50.0 | 10.4 | C | B | C |
| Comparative | LPS-1 | 5.0 | 2.05 | 0.40 | BB | 0.1 | 2451.4 | 497.7 | Reference | Reference | Reference |
| Example 2-1 | | | | | | | | | | | |
| Comparative | LPS-1 | 5.0 | 2.05 | 0.40 | BB | 0.2 | 1.8 | 0.5 | E | D | D |
| Example 2-2 | | | | | | | | | | | |
| Example 3-1 | LPS-2 | 10 | 4.55 | 0.40 | DIBK | 6.3 | 107.3 | 52.0 | B | B | B |
| Example 3-2 | LPS-2 | 10 | 4.50 | 0.40 | DIBK | 24.7 | 245.2 | 122.7 | A | C | C |
| Example 3-3 | LPS-2 | 10 | 4.55 | 0.40 | DIBK | 4.7 | 0.1 | 2.4 | B | C | B |
| Example 3-4 | LPS-2 | 10 | 4.50 | 0.40 | DIBK | 13.6 | 0.3 | 6.9 | B | B | B |
| Example 3-5 | LPS-2 | 10 | 4.50 | 0.40 | DIBK | 0.5 | 12.8 | 6.0 | C | C | C |
| Comparative | LPS-2 | 10 | 4.50 | 0.40 | DIBK | 0.2 | 0.0 | 0.1 | Reference | Reference | Reference |
| Example 3-1 | | | | | | | | | | | |
| Comparative | LPS-2 | 10 | 4.50 | 0.40 | DIBK | 0.5 | 0.8 | 0.7 | E | D | E |
| Example 3-2 | | | | | | | | | | | |
| Comparative | LPS-2 | 10 | 4.50 | 0.40 | DIBK | 618.2 | 1.7 | 309.8 | D | D | D |
| Example 3-3 | | | | | | | | | | | |
| Example 4-1 | LPS-1 | 5.0 | 2.80 | 0.50 | Xylene | 13.9 | 181.0 | 58.1 | B | A | B |
| Example 4-2 | LPS-1 | 5.0 | 2.80 | 0.50 | Xylene | 6.2 | 78.2 | 25.3 | A | A | A |
| Example 4-3 | LPS-1 | 5.0 | 2.80 | 0.50 | Xylene | 6.5 | 52.2 | 18.4 | A | A | B |
| Example 4-4 | LPS-1 | 5.0 | 2.80 | 0.50 | Xylene | 19.1 | 258.6 | 82.5 | B | B | B |
| Comparative | LPS-1 | 5.0 | 2.80 | 0.50 | Xylene | 501.0 | 517.3 | 476.2 | Reference | Reference | Reference |
| Example 4-1 | | | | | | | | | | | |
| Comparative | LPS-1 | 5.0 | 2.80 | 0.50 | Xylene | 0.5 | 1.6 | 0.7 | D | E | D |
| Example 4-2 | | | | | | | | | | | |
| Comparative | LPS-1 | 5.0 | 2.80 | 0.50 | Xylene | 197.4 | 87.1 | 156.3 | E | E | E |
| Example 4-3 | | | | | | | | | | | |
| Comparative | LPS-1 | 5.0 | 2.80 | 0.50 | Xylene | 6.0 | 1.6 | 4.5 | E | E | E |
| Example 4-4 | | | | | | | | | | | |
| Example 5-1 | LPS-2 | 10 | 4.55 | 0.40 | BB | 4.7 | 4.6 | 4.5 | B | B | B |
| Example 5-2 | LPS-2 | 10 | 4.50 | 0.40 | BB | 9.4 | 9.4 | 9.0 | B | B | C |
| Example 5-3 | LPS-2 | 10 | 4.50 | 0.40 | BB | 29.5 | 23.5 | 25.5 | A | A | A |
| Comparative | LPS-2 | 10 | 4.50 | 0.40 | BB | 0.5 | 0.6 | 0.5 | Reference | Reference | Reference |
| Example 5-1 | | | | | | | | | | | |
| Comparative | LPS-2 | 10 | 4.50 | 0.40 | BB | 0.7 | 1.0 | 0.8 | E | E | E |
| Example 5-2 | | | | | | | | | | | |

<Description of reference numerals>
Si-1 to Si-3: Si produced as described above
LPS-1 to LPS-2: Li-P-S-based glass produced as described above
DIBK: diisobutyl ketone (CAS 108-83-8)
BB: butyl butyrate (CAS 109-21-7)
Xylene: xylene (CAS 1330-20-7)

In Table 1, the unit of the content of each component is “part by mass”, the unit of the adsorption rates A_{AC} and A_{SE} is “%”, and the unit of the specific surface area is “m²/g”, where all of these are omitted. In addition, the weight-average molecular weight of the polymer shown in Table 1 is two significant digits (three significant digits in the case of the polymer A-18), and the weight-average molecular weights of Examples 1-9 and Comparative Examples 1-3 are the results of the GPC measurement of the mixture.

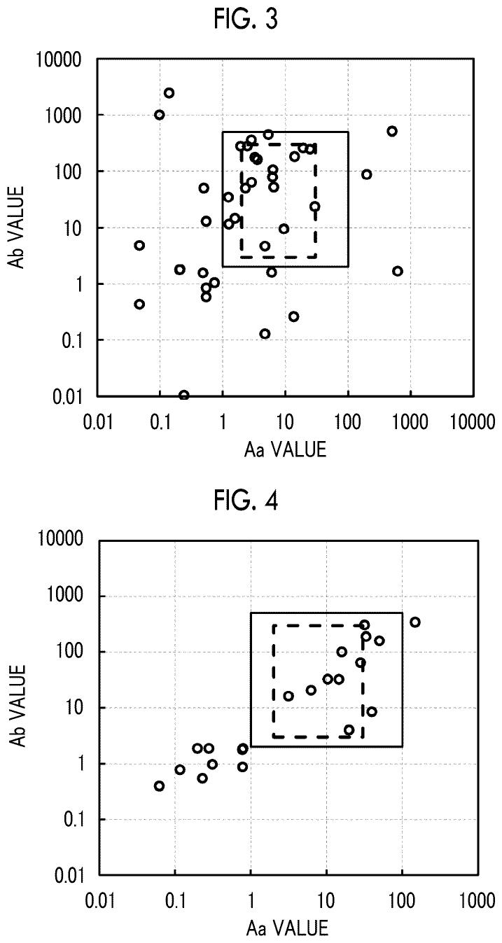

FIG. 3 is a graph in which Aa values and Ab values in compositions for an all-solid-state secondary battery according to Examples 1 to 5 are plotted in coordinates in which a horizontal axis is Aa calculated by the expression 1 and a vertical axis is Ab calculated by the expression 2. As is clear from Table 1 and FIG. 3, it was experimentally found that the composition for an all-solid-state secondary battery was excellent in all of the thickening test, the preparation time test, and the rate characteristic test, in a case where Aa calculated by the expression 1 was in a range of 1 to 100 or Ab calculated by the expression 2 was in a range of 2 to 500. In addition, it was experimentally found that the composition for an all-solid-state secondary battery could achieve a balanced and further high level in all of the thickening test, the preparation time test, and the rate characteristic test, in a case where both Aa calculated by the expression 1 and Ab calculated by the expression 2 were within a predetermined range, that is, in a case where the composition is included in a region indicated by a solid line in the graph of FIG. 3. Specifically, it was found that the composition for an all-solid-state secondary battery was excellent in all of the thickening test, the preparation time test, and the rate characteristic test, in a case where Aa calculated by the expression 1 was in a range of 1 to 100, preferably in a range of 2 to 30. On the other hand, it was found that the composition for an all-solid-state secondary battery was excellent in all of the thickening test, the preparation time test, and the rate characteristic test, in a case where Ab calculated by the expression 2 was in a range of 2 to 500, preferably in a range of 2 to 300.

### Examples 6 to 9 and Comparative Examples 6 to 9

1. Each composition for an all-solid-state secondary battery (positive electrode composition) was prepared as follows.

### Example 6 and Comparative Example 6

8.0 g of NCM-1 as the positive electrode active material, 1.5 g of LPS-3 as the inorganic solid electrolyte SE, 0.4 g of acetylene black (manufactured by Denka Company Limited) as a conductive auxiliary agent, 0.10 g (solid content amount) of A-16 having a weight-average molecular weight shown in Table 2 as the polymer A, and 6.67 g of xylene as the dispersion medium D were charged into a container, and the mixture was mixed at a rotation speed of 2,000 rpm and a revolution speed of 800 rpm for 10 minutes using a rotating and revolving mixer to obtain a positive electrode composition of Example 6-1 (concentration of solid contents: 60% by mass).

Positive electrode compositions of Example 6-2 and Comparative Examples 6-1 and 6-2 were each prepared in the same manner as in Example 6-1, except that, in Example 6-1, the type or content of the polymer and the content of the inorganic solid electrolyte SE were changed as shown in Table 2.

### Example 7 and Comparative Example 7

Positive electrode compositions of Examples 7-1 to 7-3 and Comparative Examples 7-1 and 7-2 were each prepared in the same manner as in Example 6-1, except that, in Example 6-1, the type or content of the polymer, the type of the active material AC, the content of the inorganic solid electrolyte SE, and the type of the dispersion medium D were changed as shown in Table 2.

### Example 8 and Comparative Example 8

Positive electrode compositions of Examples 8-1 to 8-5 and Comparative Examples 8-1 to 8-3 were each prepared in the same manner as in Example 6-1, except that, in Example 6-1, the type or content of the polymer, the type or content of the active material AC, the type or content of the inorganic solid electrolyte SE, the content of the conductive auxiliary agent, and the type of the dispersion medium D were changed as shown in Table 2.

### Example 9 and Comparative Example 9

Positive electrode compositions of Examples 9-1 and 9-2 and Comparative Examples 9-1 and 9-2 were each prepared in the same manner as in Example 6-1, except that, in Example 6-1, the type or content of the polymer, the type or content of the active material AC, the type or content of the inorganic solid electrolyte SE, the content of the conductive auxiliary agent, and the type of the dispersion medium D were changed as shown in Table 2.

2. A positive electrode sheet for an all-solid-state secondary battery was produced as follows.

### Example 6 and Comparative Example 6

That is, each positive electrode composition obtained in Examples 6-1 and 6-2 and Comparative Examples 6-1 and 6-2 as described above was applied onto an aluminum foil having a thickness of 20 μm using a baker type applicator (product name: SA-201, manufactured by TESTER SANGYO CO., LTD.), heated at 110° C. for 1 hour, and dried (the dispersion medium was removed) by heating at 110° C. for 2 hours with a vacuum dryer AVO-200NS (product name, manufactured by AS ONE Corporation). In this way, a positive electrode sheet for an all-solid-state secondary battery of Examples 6-1 and 6-2 and Comparative Examples 6-1 and 6-2, having a positive electrode active material layer with a total amount of 7.2 mg/cm², was produced.

Here, the total amount means the total mass of the inorganic solid electrolyte SE, the active material AC, and the conductive auxiliary agent per unit area.

### Examples 7 to 9 and Comparative Examples 7 to 9

Each negative electrode sheet for an all-solid-state secondary battery of Examples 7-1 to 7-3 and Comparative Examples 7-1 and 7-2, Examples 8-1 to 8-5 and Comparative Examples 8-1 to 8-3, and Examples 9-1 and 9-2 and Comparative Examples 9-1 and 9-2 was produced in the same manner as in the production of the positive electrode sheet for an all-solid-state secondary battery of Example 6-1 described above, except that, in the production of the positive electrode sheet for an all-solid-state secondary battery of Example 6-1, each positive electrode composition obtained in Examples 7 to 9 and Comparative Examples 7 to 9 was used instead of the positive electrode composition obtained in Example 6-1. The total amount of the positive electrode active material layer in each positive electrode sheet for an all-solid-state secondary battery was 7.2 mg/cm².

3. An all-solid-state secondary battery was produced as follows using each produced positive electrode sheet for an all-solid-state secondary battery.

### Example 6 and Comparative Example 6

Each positive electrode sheet for an all-solid-state secondary battery produced in Example 6 and Comparative Example 6 was punched into a disk shape having a diameter of 10 mmφ, and put into a cylinder made of PET having a diameter of 10 mmφ. 60 mg of LPS-3 synthesized in Synthesis Example SE and prepared with a specific surface area was put on a surface of the positive electrode active material layer in the cylinder, and a 10 mmφ SUS-made rod was inserted from both open ends of the cylinder. The positive electrode collector side of each positive electrode sheet for an all-solid-state secondary battery and the LPS-3 were pressurized and formed into a solid electrolyte layer at a pressure of 350 MPa by a SUS rod. Next, the SUS bar disposed on the solid electrolyte layer side was temporarily removed, and a disk-shaped indium (In) sheet (thickness: 20 μm) having a diameter of 9 mmφ and a disk-shaped lithium (Li) sheet (thickness: 20 μm) having a diameter of 9 mmφ were inserted into the solid electrolyte layer in the cylinder in this order. The removed SUS bar was inserted into the cylinder again, and was fixed in a state in which a pressure of 50 MPa was applied. In this way, an all-solid-state secondary battery (half cell) of Examples 6-1 and 6-2 and Comparative Examples 6-1 and 6-2, having a configuration of aluminum foil (thickness: 20 μm)-positive electrode active material layer (thickness: 100 μm)-solid electrolyte layer (thickness: 200 m)-negative electrode active material layer (In/Li sheet, thickness: 30 μm), was obtained.

### Examples 7 to 9 and Comparative Examples 7 to 9

Each all-solid-state secondary battery of Examples 7-1 to 7-3 and Comparative Examples 7-1 and 7-2, Examples 8-1 to 8-5 and Comparative Examples 8-1 to 8-3, and Examples 9-1 and 9-2 and Comparative Examples 9-1 and 9-2 was produced in the same manner as in the production of the all-solid-state secondary battery of Example 6-1 described above, except that, in the production of the all-solid-state secondary battery of Example 6-1, each positive electrode sheet for an all-solid-state secondary battery obtained in Examples 7 to 9 and Comparative Examples 7 to 9 was used instead of the positive electrode sheet for an all-solid-state secondary battery obtained in Example 6-1.

4. The positive electrode composition for an all-solid-state secondary battery and the all-solid-state secondary battery, prepared as described above, were evaluated for the following characteristics.

<Evaluation 4: High Concentration Test of Positive Electrode Composition for all-Solid-State Secondary Battery>

In the same manner as in the high concentration test of negative electrode composition for all-solid-state secondary battery (evaluation 1) described above, the maximum concentration of solid contents of each positive electrode composition for an all-solid-state secondary battery was determined using a test positive electrode composition prepared by mixing the inorganic solid electrolyte SE, the positive electrode active material, the polymer, and the conductive auxiliary agent at the same mass ratio as in each of Examples and each of Comparative Examples and a predetermined amount of the dispersion medium D, instead of the test negative electrode composition, and the high concentration test was evaluated.

In Examples 6 to 9, the evaluation was based on Comparative Example 6-1 (maximum concentration of solid contents: 60% by mass), Comparative Example 7-1 (maximum concentration of solid contents: 55% by mass), Comparative Example 8-1 (maximum concentration of solid contents: 50% by mass), and Comparative Example 9-1 (maximum concentration of solid contents: 55% by mass). The results are shown in Table 2.

<Evaluation 5: Preparation Time Test of Positive Electrode Composition for all-Solid-State Secondary Battery>

In the same manner as in the preparation time test of negative electrode composition for all-solid-state secondary battery (evaluation 2) described above, the shortest mixing time of each positive electrode composition for an all-solid-state secondary battery was determined using a test positive electrode composition having a concentration of solid contents of 70% by mass, which was prepared by mixing the inorganic solid electrolyte SE, the positive electrode active material, the polymer, and the conductive auxiliary agent at the same mass ratio as in each of Examples and each of Comparative Examples and a predetermined amount of the dispersion medium D, instead of the test negative electrode composition, and the preparation time was evaluated.

In Examples 6 to 9, the evaluation was based on Comparative Example 6-1 (shortest mixing time: 20 minutes), Comparative Example 7-1 (shortest mixing time: 25 minutes), Comparative Example 8-1 (shortest mixing time: 30 minutes), and Comparative Example 9-1 (shortest mixing time: 25 minutes). The results are shown in Table 2.

<Evaluation 6: Rate Characteristic Test of all-Solid-State Secondary Battery>

A rate characteristic test of each all-solid-state secondary battery produced in each of Examples and each of Comparative Examples was performed using a charging and discharging evaluation device TOSCAT-3000 (product name, manufactured by Toyo System Corporation).

Specifically, each all-solid-state secondary battery was charged at a current density of 0.1 mAcm⁻² until the battery voltage reached 3.58 V in an environment of 25° C., and then discharged at a current density of 0.5 mAcm⁻² until the battery voltage reached 1.88 V. Thereafter, the battery was charged at a current density of 0.1 mAcm⁻² until the battery voltage reached 3.58 V, and then discharged at a current density of 2 mAcm⁻² until the battery voltage reached 1.88 V.

Rate characteristics were determined according to the following expression, and applied to the following evaluation standard to evaluate the rate characteristics of the all-solid-state secondary battery.

In Example 6 and Comparative Example 6, the rate characteristics of the all-solid-state secondary battery were evaluated based on the following evaluation standard with the rate characteristics (60%) of the all-solid-state secondary battery of Comparative Example 6-1 as a reference, by obtaining the rate characteristics by the following expression. In Examples 7 to 9, the evaluation was based on the rate characteristics of Comparative Example 7-1 (65%), the rate characteristics of Comparative Example 8-1 (70%), and the rate characteristics of Comparative Example 9-1 (55%). The results are shown in Table 2.

A 5% difference in the rate characteristics in the above-described main test represents sufficiently large superiority, and it can be said that an all-solid-state secondary battery having a rate characteristic at least 5% higher than that of each of Comparative Examples (evaluation standard C or higher) exhibits sufficiently superior rate characteristics.

$$Rate characteristics ( \% ) = ( Discharge capacity at current density of 2 mA {cm}^{- 2} / Discharge capacity at current density of 0.5 mA {cm}^{- 2} ) \times 100$$

### —Evaluation Standard—

A: above-described reference+15%≤rate characteristics
B: above-described reference+10%≤rate characteristics<above-described reference+15%
C: above-described reference+5%≤rate characteristics<above-described reference+10%
D: above-described reference−5%≤rate characteristics<above-described reference+5%
E: rate characteristics<above-described reference−5%

TABLE 2-1

| | Polymer A | | | | | | Active material AC | | |
|---|---|---|---|---|---|---|---|---|---|
| | | Weight-average | | | Adsorption | Adsorption | | Specific | |
| | Type | molecular weight | Form | Content | rate A_{AC} | rate A_{SE} | Type | surface area | Content |
| Example 6-1 | A-16 | 100000 | Dissolved | 0.10 | 10% | 3% | NCM-1 | 0.5 | 8.00 |
| Example 6-2 | A-16 | 100000 | Dissolved | 0.05 | 10% | 3% | NCM-1 | 0.5 | 8.00 |
| Comparative | A-1 | 200000 | Dissolved | 0.10 | 1% | 2% | NCM-1 | 0.5 | 8.00 |
| Example 6-1 | | | | | | | | | |
| Comparative | A-2 | 800000 | Dissolved | 0.10 | 4% | 4% | NCM-1 | 0.5 | 8.00 |
| Example 6-2 | | | | | | | | | |
| Example 7-1 | A-15 | 11000 | Dissolved | 0.10 | 5% | 6% | NCM-2 | 1.0 | 8.00 |
| Example 7-2 | A-15 | 11000 | Dissolved | 0.05 | 5% | 5% | NCM-2 | 1.0 | 8.00 |
| Example 7-3 | A-3 | 8000 | Dissolved | 0.05 | 13% | 8% | NCM-2 | 1.0 | 8.00 |
| Comparative | A-1 | 120000 | Dissolved | 0.10 | 1% | 1% | NCM-2 | 1.0 | 8.00 |
| Example 7-1 | | | | | | | | | |
| Comparative | A-1 | 200000 | Dissolved | 0.10 | 2% | 2% | NCM-2 | 1.0 | 8.00 |
| Example 7-2 | | | | | | | | | |
| Example 8-1 | A-3 | 8000 | Dissolved | 0.05 | 13% | 13% | NCM-3 | 5.0 | 7.50 |
| Example 8-2 | A-3 | 8000 | Dissolved | 0.10 | 17% | 20% | NCM-3 | 5.0 | 7.50 |
| Example 8-3 | A-15 | 11000 | Dissolved | 0.05 | 10% | 12% | NCM-3 | 5.0 | 7.50 |
| Example 8-4 | A-15 | 14000 | Dissolved | 0.05 | 8% | 12% | NCM-3 | 5.0 | 7.50 |
| Example 8-5 | A-25 | 22000 | Dissolved | 0.05 | 30% | 30% | NCM-3 | 5.0 | 7.50 |
| Comparative | A-1 | 6000 | Dissolved | 0.10 | 1% | 1% | NCM-3 | 5.0 | 7.50 |
| Example 8-1 | | | | | | | | | |
| Comparative | A-1 | 200000 | Dissolved | 0.10 | 3% | 5% | NCM-3 | 5.0 | 7.50 |
| Example 8-2 | | | | | | | | | |
| Comparative | A-3 | 400000 | Dissolved | 0.10 | 15% | 15% | NCM-3 | 5.0 | 7.50 |
| Example 8-3 | | | | | | | | | |
| Example 9-1 | A-17 | 10000 | Dissolved | 0.05 | 8% | 18% | LMO-1 | 1.5 | 6.50 |
| Example 9-2 | A-25 | 18000 | Dissolved | 0.05 | 6% | 10% | LMO-1 | 1.5 | 6.50 |
| Comparative | A-9 | 150000 | Dissolved | 0.05 | 3% | 5% | LMO-1 | 1.5 | 6.50 |
| Example 9-1 | | | | | | | | | |
| Comparative | A-2 | 60000 | Dissolved | 0.05 | 3% | 3% | LMO-1 | 1.5 | 6.50 |
| Example 9-2 | | | | | | | | | |

TABLE 2-2

| | | | | | | | | | Test result | | |
|---|---|---|---|---|---|---|---|---|---|---|---|
| | | | | | | | | | Test of | | |
| | Inorganic solid electrolyte SE | | | Conduc- | Disper- | | | | concen- | Test of | |
| | | Specific | | tive | sion | | | | tration | prep- | |
| | | surface | | auxiliary | medium | | | | of solid | aration | Test of |
| | Type | area | Content | agent | D | Aa | Ab | Ac | contents | time | rate |
| Example 6-1 | LPS-3 | 1.5 | 1.50 | 0.40 | Xylene | 39.5 | 8.4 | 32.9 | A | A | B |
| Example 6-2 | LPS-3 | 1.5 | 1.55 | 0.40 | Xylene | 19.8 | 4.0 | 16.4 | A | B | A |
| Comparative | LPS-3 | 1.5 | 1.50 | 0.40 | Xylene | 0.2 | 1.9 | 0.4 | Reference | Reference | Reference |
| Example 6-1 | | | | | | | | | | | |
| Comparative | LPS-3 | 1.5 | 1.50 | 0.40 | Xylene | 0.8 | 1.9 | 0.9 | E | D | E |
| Example 6-2 | | | | | | | | | | | |
| Example 7-1 | LPS-3 | 1.5 | 1.50 | 0.40 | BB | 31.8 | 306.6 | 71.4 | C | B | C |
| Example 7-2 | LPS-3 | 1.5 | 1.55 | 0.40 | BB | 15.9 | 101.4 | 28.4 | B | A | A |
| Example 7-3 | LPS-3 | 1.5 | 1.59 | 0.40 | BB | 147.9 | 344.1 | 172.4 | C | C | A |
| Comparative | LPS-3 | 1.5 | 1.50 | 0.40 | BB | 0.1 | 0.8 | 0.2 | Reference | Reference | Reference |
| Example 7-1 | | | | | | | | | | | |
| Comparative | LPS-3 | 1.5 | 1.50 | 0.40 | BB | 0.3 | 1.9 | 0.5 | E | D | E |
| Example 7-2 | | | | | | | | | | | |
| Example 8-1 | LPS-2 | 10 | 2.20 | 0.25 | BB | 14.5 | 32.4 | 18.0 | A | A | A |
| Example 8-2 | LPS-2 | 10 | 2.15 | 0.25 | BB | 49.7 | 158.6 | 71.4 | C | B | C |
| Example 8-3 | LPS-2 | 10 | 2.15 | 0.25 | BB | 6.2 | 20.7 | 9.2 | A | B | B |
| Example 8-4 | LPS-2 | 10 | 2.15 | 0.25 | BB | 3.1 | 16.3 | 5.9 | B | A | B |
| Example 8-5 | LPS-2 | 10 | 2.15 | 0.25 | BB | 28.1 | 64.7 | 35.2 | A | A | A |
| Comparative | LPS-2 | 10 | 2.10 | 0.30 | BB | 0.2 | 0.5 | 0.3 | Reference | Reference | Reference |
| Example 8-1 | | | | | | | | | | | |
| Comparative | LPS-2 | 10 | 2.15 | 0.25 | BB | 0.1 | 0.4 | 0.1 | D | D | D |
| Example 8-2 | | | | | | | | | | | |
| Comparative | LPS-2 | 10 | 2.15 | 0.25 | BB | 0.8 | 1.8 | 1.0 | E | D | E |
| Example 8-3 | | | | | | | | | | | |
| Example 9-1 | LPS-4 | 3.0 | 3.00 | 0.45 | BB | 33.2 | 189.7 | 78.5 | B | B | A |
| Example 9-2 | LPS-4 | 3.0 | 3.00 | 0.45 | BB | 10.4 | 32.5 | 16.5 | A | A | A |
| Comparative | LPS-4 | 3.0 | 3.00 | 0.45 | BB | 0.3 | 1.0 | 0.5 | Reference | Reference | Reference |
| Example 9-1 | | | | | | | | | | | |
| Comparative | LPS-4 | 3.0 | 3.00 | 0.45 | BB | 0.8 | 0.9 | 0.8 | E | E | D |
| Example 9-2 | | | | | | | | | | | |

<Description of reference numerals>
NCM-1 to NCM-3: NCM produced as described above
LMO-1: LMO produced as described above
LPS-2 to LPS-4: Li-P-S-based glass produced as described above
BB: butyl butyrate
Xylene: xylene (CAS 1330-20-7)

In Table 2, the unit of the content of each component is “part by mass”, the unit of the adsorption rates A_{AC} and A_{SE} is “%”, and the unit of the specific surface area is “m²/g”, where all of these are omitted. In addition, the weight-average molecular weight of the polymer shown in Table 2 is two significant digits.

FIG. 4 is a graph in which Aa values and Ab values in compositions for an all-solid-state secondary battery according to Examples 6 to 9 are plotted in coordinates in which a horizontal axis is Aa calculated by the expression 1 and a vertical axis is Ab calculated by the expression 2. As is clear from Table 2 and FIG. 4, it was experimentally found that the composition for an all-solid-state secondary battery was excellent in all of the thickening test, the preparation time test, and the rate characteristic test, in a case where Aa calculated by the expression 1 was in a range of 1 to 100 or Ab calculated by the expression 2 was in a range of 2 to 500. In addition, it was experimentally found that the composition for an all-solid-state secondary battery could achieve a balanced and further high level in all of the thickening test, the preparation time test, and the rate characteristic test, in a case where both Aa calculated by the expression 1 and Ab calculated by the expression 2 were within a predetermined range, that is, in a case where the composition is included in a region indicated by a solid line in the graph of FIG. 4. Specifically, it was found that the composition for an all-solid-state secondary battery was excellent in all of the thickening test, the preparation time test, and the rate characteristic test, in a case where Aa calculated by the expression 1 was in a range of 1 to 100, preferably in a range of 2 to 30. On the other hand, it was found that the composition for an all-solid-state secondary battery was excellent in all of the thickening test, the preparation time test, and the rate characteristic test, in a case where Ab calculated by the expression 2 was in a range of 2 to 500, preferably in a range of 2 to 300.

As described above, it was found that the composition for an all-solid-state secondary battery was excellent in all of the thickening test, the preparation time test, and the rate characteristic test, in a case where Aa calculated by the expression 1 or Ab calculated by the expression 2 was within the above-described range regardless of whether the active material AC was a positive electrode active material or a negative electrode active material.

### Example 10 and Comparative Example 10

1. Each composition for an all-solid-state secondary battery (inorganic solid electrolyte-containing composition) was prepared as follows.

A test inorganic solid electrolyte-containing composition containing the inorganic solid electrolyte SE, the polymer A, and the dispersion medium D was prepared, and the following characteristics were evaluated.

### <Evaluation 7: High Concentration Test of Inorganic Solid Electrolyte-Containing Composition>

In the same manner as in the high concentration test of negative electrode composition for all-solid-state secondary battery (evaluation 1) described above, the maximum concentration of solid contents of each inorganic solid electrolyte-containing composition was determined using the test inorganic solid electrolyte-containing composition prepared by mixing the inorganic solid electrolyte SE and the polymer A at the mass ratio shown in each column of “Content” in Table 3 and a predetermined amount of the dispersion medium D, instead of the test negative electrode composition, and the high concentration test was evaluated.

In Example 10, the evaluation was based on Comparative Example 10-1 (maximum concentration of solid contents: 50% by mass). The results are shown in Table 3.

### <Evaluation 8: Preparation Time Test of Inorganic Solid Electrolyte-Containing Composition>

In the same manner as in the preparation time test of negative electrode composition for all-solid-state secondary battery (evaluation 2) described above, the shortest mixing time of each inorganic solid electrolyte-containing composition was determined using the test inorganic solid electrolyte-containing composition prepared by mixing the inorganic solid electrolyte SE and the polymer A at the mass ratio shown in each “Content” of Table 3 and a predetermined amount of the dispersion medium D, instead of the test negative electrode composition, and the preparation time was evaluated.

In Example 10, the evaluation was based on Comparative Example 10-1 (shortest mixing time: 25 minutes). The results are shown in Table 3.

TABLE 3-4

| | | | | | | | | | | | Test result | |
|---|---|---|---|---|---|---|---|---|---|---|---|---|
| | Polymer A | | | | | | | | | | Test of | |
| | | Weight- | | | | Inorganic solid electrolyte SE | | | Disper- | | concen- | Test of |
| | | average | | | Adsorp | | Specific | | sion | | tration | prep- |
| | | molecular | | | tion | | surface | | medium | | of solid | aration |
| | Type | weight | Form | Content | rate A_{SE} | Type | area | Content | D | Ab | contents | time |
| Example 10-1 | A-25 | 20000 | Dissolved | 0.05 | 38% | LPS-1 | 5.0 | 1.95 | BB | 167.7 | A | A |
| Example 10-2 | A-25 | 20000 | Dissolved | 0.03 | 38% | LPS-1 | 5.0 | 1.97 | BB | 99.1 | A | B |
| Example 10-3 | A-17 | 5000 | Dissolved | 0.05 | 10% | LPS-1 | 5.0 | 1.95 | BB | 46.5 | B | B |
| Example 10-4 | A-15 | 11000 | Dissolved | 0.05 | 10% | LPS-3 | 1.5 | 1.95 | BB | 128.5 | A | A |
| Example 10-5 | A-26 | 20000 | Dissolved | 0.05 | 20% | LPS-3 | 1.5 | 1.95 | DIBK | 282.7 | B | B |
| Example 10-6 | A-16 | 20000 | Dissolved | 0.05 | 10% | LPS-3 | 1.5 | 1.95 | DIBK | 70.7 | B | A |
| Comparative | A-6 | 12000 | Dissolved | 0.05 | 55% | LPS-1 | 5.0 | 1.95 | DIBK | 585.5 | Reference | Reference |
| Example 10-1 | | | | | | | | | | | | |
| Comparative | A-2 | 400000 | Dissolved | 0.05 | 6% | LPS-1 | 5.0 | 1.95 | BB | 0.2 | E | E |
| Example 10-2 | | | | | | | | | | | | |
| Comparative | A-9 | 800000 | Dissolved | 0.10 | 4% | LPS-3 | 1.5 | 1.90 | BB | 0.6 | E | E |
| Example 10-3 | | | | | | | | | | | | |
| Comparative | A-37 | 70000 | Particles | 0.05 | 57% | LPS-1 | 5.0 | 1.95 | BB | 107.8 | E | E |
| Example 10-4 | | | | | | | | | | | | |

<Description of reference numerals>
LPS-1 and LPS-3: Li-P-S-based glass produced as described above
BB: butyl butyrate
DIBK: diisobutyl ketone (CAS 108-83-8)

Since the inorganic solid electrolyte-containing compositions of Examples 10 and 10 did not contain the active material AC and the conductive auxiliary agent, the description related to the active material AC and the conductive auxiliary agent in Table 3 was omitted.

In Table 3, the unit of the content of each component is “part by mass”, the unit of the adsorption rate A_{SE} is “%”, and the unit of the specific surface area is “m²/g”, where all of these are omitted. In addition, the weight-average molecular weight of the polymer shown in Table 3 is two significant digits.

As is clear from Tables 1 and 2 and Table 3, it was found that the composition for an all-solid-state secondary battery was excellent in all of the thickening test, the preparation time test, and the rate characteristic test, in a case where Ab calculated by the expression 2 was in a range of 2 to 500, preferably in a range of 2 to 300.

The following facts could be found from the results of Table 1 to Table 3, and FIG. 3 and FIG. 4.

The composition for an all-solid-state secondary battery containing the polymer A dissolved in the dispersion medium D, in which both Aa calculated by the expression 1 and Ab calculated by the expression 2 were outside the predetermined range was inferior in any of the thickening test, the preparation time test, or the rate characteristic test. It was found that, in a case where a particulate polymer was used as the polymer, the composition for an all-solid-state secondary battery was inferior in all of the thickening test, the preparation time test, and the rate characteristic test, even in a case where Aa calculated by the expression 1 or Ab calculated by the expression 2 was within the predetermined range. It is considered that this is because the particulate polymer was present (dispersed) as particles in the composition for an all-solid-state secondary battery, and thus did not sufficiently function as a dispersant for the solid particles.

On the other hand, the composition for an all-solid-state secondary battery containing the polymer dissolved in the dispersion medium and having Aa calculated by the expression 1 or Ab calculated by the expression 2 within the predetermined range was excellent in all of the thickening test, the preparation time test, and the rate characteristic test. Moreover, it was found that, in a case where both Aa calculated by the expression 1 and Ab calculated by the expression 2 were within the predetermined range, any or all of the thickening test, the preparation time test, and the rate characteristic test were further improved to a higher level.

Therefore, the composition for an all-solid-state secondary battery according to the embodiment of the present invention could be prepared in a short time while suppressing the occurrence of aggregates even in a case where the concentration of solid contents was increased, and thus could be suitably used for industrial manufacturing with favorable manufacturing suitability. It was found that the composition for an all-solid-state secondary battery according to the embodiment of the present invention, which exhibited such excellent characteristics, contributed to the improvement of battery performance such as rate characteristics, by being used as a constituent layer-forming material of the all-solid-state secondary battery.

The present invention has been described with the embodiments thereof, any details of the description of the present invention are not limited unless otherwise specified, and it is obvious that the present invention is widely construed without departing from the gist and scope of the present invention described in the accompanying claims.

The present application claims the priority of JP2023-165475 filed in Japan on Sep. 27, 2023, the contents of which are incorporated herein by reference, as a part of the description of the present specification.

### EXPLANATION OF REFERENCES

1: negative electrode collector
2: negative electrode active material layer
3: solid electrolyte layer
4: positive electrode active material layer
5: positive electrode collector
6: operation portion
10: all-solid-state secondary battery
11: 2032-type coin case
12: laminate for all-solid-state secondary battery
13: coin-type all-solid-state secondary battery

What is claimed is:

1. A composition for an all-solid-state secondary battery, comprising:
an inorganic solid electrolyte SE having an ionic conductivity of a metal belonging to Group 1 or Group 2 in the periodic table;
an active material AC;
a dispersion medium D; and
a polymer A dissolved in the dispersion medium D,
wherein Aa calculated by the following expression 1 satisfies 1≤Aa≤100,
Aa=(an adsorption rate of the polymer A to the active material AC)²×[((a content of the polymer A/a total solid content amount)/(a molecular weight of the polymer A))/(a total specific surface area of the active material AC)^{3/2}]×10¹⁰, the expression 1:
in the expression 1, the total specific surface area of the active material AC is a value calculated from a specific surface area of the active material AC×a content of the active material AC/the total solid content amount.

2. The composition for an all-solid-state secondary battery according to claim 1,
wherein Aa calculated by the expression 1 satisfies 2≤Aa≤30.

3. The composition for an all-solid-state secondary battery according to claim 1,
wherein Ab calculated by the following expression 2 satisfies 2≤Ab≤500,
Ab=(an adsorption rate of the polymer A to the inorganic solid electrolyte SE)²×[((the content of the polymer A/the total solid content amount)/(the molecular weight of the polymer A))/(a total specific surface area of the inorganic solid electrolyte SE)^{3/2}]×10¹⁰, the expression 2:
in the expression 2, the total specific surface area of the inorganic solid electrolyte SE is a value calculated from a specific surface area of the inorganic solid electrolyte SE×a content of the inorganic solid electrolyte SE/the total solid content amount.

4. The composition for an all-solid-state secondary battery according to claim 3,
wherein Ab calculated by the expression 2 satisfies 2≤Ab≤300.

5. The composition for an all-solid-state secondary battery according to claim 3,
wherein Ac calculated by the following expression 3 satisfies 3≤Ac≤100,
Ac=[Aa×(the content of the active material AC/the total solid content amount)]+[Ab×(the content of the inorganic solid electrolyte SE/the total solid content amount)]. the expression 3:

6. The composition for an all-solid-state secondary battery according to claim 1,
wherein a weight-average molecular weight of the polymer A is 2.0×10⁴ or less.

7. The composition for an all-solid-state secondary battery according to claim 1,
wherein the active material AC contains Si, and
Aa calculated by the expression 1 satisfies 2≤Aa≤15.

8. A composition for an all-solid-state secondary battery, comprising:
an inorganic solid electrolyte SE having an ionic conductivity of a metal belonging to Group 1 or Group 2 in the periodic table;
a dispersion medium D; and
a polymer A dissolved in the dispersion medium D,
wherein Ab calculated by the following expression 2 satisfies 2≤Ab≤500,
Ab=(an adsorption rate of the polymer A to the inorganic solid electrolyte SE)²×[((the content of the polymer A/the total solid content amount)/(the molecular weight of the polymer A))/(a total specific surface area of the inorganic solid electrolyte SE)^{3/2}]×10¹⁰, the expression 2:
in the expression 2, the total specific surface area of the inorganic solid electrolyte SE is a value calculated from a specific surface area of the inorganic solid electrolyte SE×a content of the inorganic solid electrolyte SE/the total solid content amount.

9. The composition for an all-solid-state secondary battery according to claim 8,
wherein Ab calculated by the expression 2 satisfies 2≤Ab≤300.

10. The composition for an all-solid-state secondary battery according to claim 8,
wherein the composition for an all-solid-state secondary battery further contains an active material AC, and
Aa calculated by the following expression 1 satisfies 1≤Aa≤100,
Aa=(an adsorption rate of the polymer A to the active material AC)²×[((a content of the polymer A/a total solid content amount)/(a molecular weight of the polymer A))/(a total specific surface area of the active material AC)^{3/2}]×10¹⁰, the expression 1:
in the expression 1, the total specific surface area of the active material AC is a value calculated from a specific surface area of the active material AC×a content of the active material AC/the total solid content amount.

11. The composition for an all-solid-state secondary battery according to claim 10,
wherein Aa calculated by the expression 1 satisfies 2≤Aa≤30.

12. The composition for an all-solid-state secondary battery according to claim 10,
wherein Ac calculated by the following expression 3 satisfies 3≤Ac≤100,
Ac=[Aa×(the content of the active material AC/the total solid content amount)]+[Ab×(the content of the inorganic solid electrolyte SE/the total solid content amount)]. the expression 3:

13. The composition for an all-solid-state secondary battery according to claim 8,
wherein a weight-average molecular weight of the polymer A is 2.0×10⁴ or less.

14. The composition for an all-solid-state secondary battery according to claim 10,
wherein the active material AC contains Si, and
Aa calculated by the expression 1 satisfies 2≤Aa≤15.

15. A sheet for an all-solid-state secondary battery, comprising:
a layer formed of the composition for an all-solid-state secondary battery according to claim 1.

16. An all-solid-state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the composition for an all-solid-state secondary battery according to claim 1.
